(19) United States
(12) Patent Application Publication
(10) Pub. No.: US 2009/0278845 A1
(43) Pub. Date: Nov. 12, 2009

(54) IMAGE GENERATING DEVICE, TEXTURE MAPPING DEVICE, IMAGE PROCESSING DEVICE, AND TEXTURE STORING METHOD

(75) Inventors: Shuhei Kato, Shiga (JP); Koichi Sano, Shiga (JP); Koichi Usami, Shiga (JP)

Correspondence Address: JEROME D. JACKSON (JACKSON PATENT LAW OFFICE), 211 N. UNION STREET, SUITE 100, ALEXANDRIA, VA, 22314, US

(73) Assignee: SSD COMPANY LIMITED, Kusatsu-shi, Shiga (JP)

(21) Appl. No.: 12/088,935

(22) PCT Filed: Sep. 14, 2006
(86) PCT No.: PCT/JP2006/318681

§ 371 Date: Apr. 10, 2009

(30) Foreign Application Priority Data
Oct. 3, 2005 (JP) 2005-290090
Oct. 12, 2005 (JP) 2005-298238
Nov. 1, 2005 (JP) 2005-318087

(51) Int. Cl. G06T 17/00

(52) U.S. Cl. 345/420

(57) ABSTRACT

A vertex sorter 114 converts a polygon structure instance into a polygon/sprite shared data Cl, and a vertex expander 116 converts a sprite structure instance into a polygon/sprite shared data Cl in the same format. Subsequent circuits 118, 120, 122, 124, 126, 11, 130 and 132 generate an image to be displayed in a screen on the basis of the polygon/sprite shared data Cl with the same format. It is possible to generate an image which is formed from any combination of polygons and sprites, while suppressing the hardware scale, and furthermore it is possible to increase the number of the polygons and sprites capable of simultaneously drawing without incurring an increased memory capacity.

### TECHNICAL FIELD

The present invention relates to an image generating device for generating an image which is formed from any combination of polygonal graphics elements (polygons) to represent a shape of each surface of a three-dimensional solid projected to a two-dimensional space and rectangular graphics elements (sprites) each of which is parallel to a screen, and the related arts.

Further, the present invention relates to a texture mapping device for mapping textures on graphics elements (polygons) to represent a three-dimensional model on a screen and two-dimensional graphics elements (sprites), and the related arts.

Still further, the present invention relates to an image generating device for generating an image which is formed from a plurality of graphics elements and is displayed on a screen, and the related arts.

### BACKGROUND ART

There have been arts for combining polygons and sprites to display. In this case, as disclosed in the Patent document 1 (Japanese Patent Published Application No. Hei 7-85308), a 2D system and a 3D system are provided independently, and then sprites and polygons are added and combined when they are converted into a video signal for displaying.

However, this method requires independent dedicated circuits respectively provided for the 2D system and the 3D system and a frame memory, and furthermore it is not possible to combine fully and represent the sprites and the polygons.

The Patent document 1 discloses an image displaying method for solving this problem. This image displaying method draws an object to be displayed on an image display screen by a drawing instruction for drawing polygons constituting respective surfaces of the object, and decorate the polygons of the object with texture images stored in a texture storage area.

A rectangle drawing instruction is set. The rectangle drawing instruction assigns the rectangular texture image in the texture storage area to the rectangular polygon of a prescribed size, which is always plane parallel to the image display screen. The rectangular texture image has the same size as the rectangle. The position of the rectangle on the image display screen and the position of the rectangular texture image in the texture storage area are designated by the rectangle drawing instruction. The rectangular area can be drawn to an arbitrary position on the image display screen by the rectangle drawing instruction.

In this way, hardware can be reduced by using the 3D system to display the image (referred to herein as “pseudo sprite”) which is analogous to a sprite of the 2D system.

However, since the 3D system is used, it is necessary to store the entire pseudo sprite image, i.e., the entire rectangular texture image in the texture storage area. Ultimately, the entire texture image to be mapped on the one graphics element has to be stored in the texture storage area, regardless of whether the polygon or the pseudo sprite. Because, in the case of 3D system, when an aggregation of pixels included in a horizontal line to be drawn on a screen is mapped to a texel space where a texture image is arranged, the aggregation may be mapped to any line in the texel space. Contrary to this, in a case of the sprite, it is mapped to only a line parallel to the horizontal axis in the texel space.

If the entire texture image is stored for each graphics element such as the polygon or the pseudo sprite, the number of the polygons and the pseudo sprites capable of simultaneously drawing is decreased due to the limited capacity of the texture storage area. In case of wishing to increase the number of the polygons and the pseudo sprites capable of simultaneously drawing, large memory capacity is inevitably required. Therefore, it is difficult to simultaneously draw a large number of the polygons and the pseudo sprites.

Besides, the pseudo sprite having the same shape as the polygon of the 3D system is just displayed due to usage of the 3D system. Namely, if the polygon is n-polygonal (n is three or a larger integer), the pseudo sprite is also n-polygonal, and therefore it is not possible that both the shapes are made to differ mutually. Incidentally, the quadrangular pseudo sprite may be constituted of two triangular polygons. However, also in this case, it is necessary to storage the entire images of two triangular polygons in the texture storage area, and thus large memory capacity is required.

Accordingly, it is an object of the present invention to provide a image generating device and the related arts in which it is possible to generate an image which is formed from any combination of polygonal graphics elements to represent a shape of each surface of a three-dimensional solid projected to a two-dimensional space and rectangular graphics elements each of which is parallel to a frame of a screen, while suppressing the hardware scale, and furthermore it is possible to increase the number of the graphics elements capable of simultaneously drawing without incurring an increased memory capacity.

By the way, a texture mapping device, which the Patent document 2 (Japanese Patent Published Application No. Hei 8-110951) discloses, is provided with a texture mapping unit and an image memory. The image memory consists of a frame memory and a texture memory. The three-dimensional image data, which is an object of the texture mapping, is stored in the frame memory by a fill coordinate system corresponding to a display screen, and the texture data to be mapped is stored in the texture memory by a texture coordinate system.

In generally, a texture is stored in such texture memory so as to keep the state where it is mapped. Besides, in generally, the texture is stored as a two-dimensional array in the texture memory. Accordingly, when the texture is stored in the texture memory so as to keep the state where it is mapped, there may be useless texels which is not mapped.

Especially, in the case of the triangular texture mapped to the triangle, an approximately half of the texels of the two-dimensional array is wasted.

Accordingly, it is an another object of the present invention to provide a texture mapping device and the related arts in which it is possible to suppress necessary memory capacity by reducing useless texel data which is included in texture pattern data stored in a memory as much as possible.

By the way, although the Patent document 2 discloses the above texture mapping device, this Patent document 2 does not focus on area management of the texture memory. However, if the area management is not performed appropriately, useless access to the outside in order to fetch the texture data increases, and a texture memory having large capacity is required.

Accordingly, it is a further object of the present invention to provide an image generating device and the related arts in which it is possible to prevent useless access to an external memory in order to fetch texture data, and suppress an excessive increase of a hardware resource for storing texture data temporarily.

### DISCLOSURE OF INVENTION

In accordance with a first aspect of the present invention, an image generating device operable to generate an image, which is constituted by a plurality of graphics elements, to be displayed on a screen, wherein: the plurality of the graphic elements is constituted by any combination of polygonal graphics elements to represent a shape of each surface of a three-dimensional solid projected to a two-dimensional space and rectangular graphics elements each of which is parallel to a frame of the screen, said image generating device comprising: A first data converting unit (corresponding to the vertex sorter 114) operable to convert first display information for generating the polygonal graphics element into data of a predetermined format; A second data converting unit (corresponding to the vertex expander 116) operable to convert second display information for generating the rectangular graphics element into data of said predetermined format; and An image generating unit (corresponding to the circuit of the subsequent stage of the vertex sorter 114 and the vertex expander 116) operable to generate the image to be displayed on the screen on the basis of the data of said predetermined format received from said first data converting unit and said second data converting unit.

In accordance with this configuration, since the first display information for generating the polygonal graphics element (e.g., a polygon) and the second display information for generating the rectangular graphics element (e.g., a sprite) are converted into the data in the same format, internal function blocks of the image generating unit can be shared with the polygonal graphics element and the rectangular graphics element as much as possible. Because of this, it is possible to suppress the hardware scale.

Also, since there is not only the 3D system as in the conventional one but also the 2D system which performs the drawing of the rectangular graphics element parallel to the frame of the screen, when the rectangular graphics element is drawn, it is not necessary to acquire the entirety of the texture image of the graphics element at a time. For example, it is possible to acquire the image data in line units in the screen. Accordingly, it is possible to increase the number of the graphics elements capable of simultaneously drawing without incurring an increased memory capacity

As a result, it is possible to generate an image which is formed from any combination of polygonal graphics elements to represent a shape of each surface of a three-dimensional solid projected to a two-dimensional space and rectangular graphics elements each of which is parallel to a frame of a screen, while suppressing the hardware scale, and furthermore it is possible to increase the number of the graphics elements capable of simultaneously drawing without incurring an increased memory capacity.

In the above image generating device, a first two-dimensional orthogonal coordinate system is a two-dimensional coordinate system which is used for displaying the graphics element on the screen, wherein a second two-dimensional orthogonal coordinate system is a two-dimensional coordinate system where image data to be mapped to the graphics element is arranged, wherein the data of said predetermined format includes a plurality of vertex fields, wherein the each vertex field includes a first field and a second field, wherein said first data converting unit stores coordinates in the first two-dimensional orthogonal coordinate system of a vertex of the polygonal graphics element in the first field and stores a parameter of the vertex of the polygonal graphics element in a format according to a drawing mode in the second field, and wherein said second data converting unit stores coordinates in the first two-dimensional orthogonal coordinate system of a vertex of the rectangular graphics element in the first field and stores coordinates obtained by mapping the coordinates in the first two-dimensional orthogonal coordinate system of the vertex of the rectangular graphics element to the second two-dimensional orthogonal coordinate system in the second field.

In accordance with this configuration, since the first data converting unit stores the parameter of the vertex in the format according to the drawing mode into the second field of the data of the predetermined format, it is possible to draw in the different drawing modes in the 3D system while maintaining the identity of the format of the data of the predetermined format.

In the above image generating device, said second data converting unit performs calculation based on coordinates in the first two-dimensional orthogonal coordinate system of one vertex of the rectangular graphics element and size information of the graphics element, which are included in the second display information, to obtain coordinates in the first two-dimensional orthogonal coordinate system of a part or all of the other three vertices, and stores the coordinates of the vertex included in the second display information in advance and the coordinates of the vertex as obtained in the first field, and maps the coordinates of the vertex included in the second display information in advance and the coordinates of the vertex as obtained to the second two-dimensional orthogonal coordinate system to obtain coordinates, and stores the coordinates in the second two-dimensional orthogonal coordinate system as obtained in the second field.

In accordance with this configuration, since the coordinates of the part or all of the other three vertices are obtained by calculation, it is not necessary to include all coordinates of the four vertices in the second display information, and thereby it is possible to reduce memory capacity necessary for storing the second display information.

In the above image generating device, said second data converting unit performs calculation based on coordinates in the first two-dimensional orthogonal coordinate system of one vertex of the rectangular graphics element, an enlargement/reduction ratio of the graphics element, and size information of the graphics element, which are included in the second display information, to obtain coordinates of a part or all of the other three vertices, and stores the coordinates of the vertex included in the second display information in advance and the coordinates of the vertex as obtained in the first field, and maps the coordinates of the vertex included in the second display information in advance and the coordinates of the vertex as obtained to the second two-dimensional orthogonal coordinate system to obtain coordinates, and stores the coordinates in the second two-dimensional orthogonal coordinate system as obtained in the second field.

In accordance with this configuration, since the coordinates of the part or all of the other three vertices are obtained by calculation, it is not necessary to include all coordinates of the four vertices in the second display information, and thereby it is possible to reduce memory capacity necessary for storing the second display information. Also, since the enlargement/reduction ratio of the graphics element is reflected to the coordinates mapped to the second two-dimensional orthogonal coordinate system, it is not necessary to store the image after enlarging or reducing in the memory in advance even if an enlarged or reduced image of an original image is displayed in a screen, and thereby it is possible to reduce memory capacity necessary for storing image data.

In the above image generating device, said first data converting unit acquires coordinates in the first two-dimensional orthogonal coordinate system of a vertex of the polygonal graphics element, which are included in the first display information, to store them in the first field, wherein in a case where the drawing mode indicates drawing by texture mapping, said first data converting unit acquires information for calculating coordinates in the second two-dimensional orthogonal coordinate system of a vertex of the polygonal graphics element and a perspective correction parameter, which are included in the first display information, to calculate the coordinates of the vertex in the second two-dimensional orthogonal coordinate system, performs perspective correction, and stores coordinates of the vertex after the perspective correction and the perspective correction parameter in the second field, and wherein in a case where the drawing mode indicates drawing by gouraud shading, said first data converting unit acquires color data of a vertex of the polygonal graphics element, which is included in the first display information, and stores the color data as acquired in the second field.

In accordance with this configuration, it is possible to draw by two types of the drawing modes such as the texture mapping and the gouraud shading in the 3D system while maintaining the identity of the format of the data of the predetermined format.

In the above image generating device, the data of said predetermined format further includes a flag field which indicates whether said data is for use in the polygonal graphics element or for use in the rectangular graphics element, wherein said first data converting unit stores information which indicates that said data is for use in the polygonal graphics element in the flag field, and wherein said second data converting unit stores information which indicates that said data is for use in the rectangular graphics element in the flag field.

In accordance with this configuration, the image generating unit which receives the data of the predetermined format can easily determine the type of the graphic element to be drawn by referring to the flag field to execute a process for each type of graphic elements while maintaining the identity of the format of the data of the predetermined format.

In this image generating device, said image generating unit comprising: an intersection calculating unit (corresponding to the slicer 118) operable to calculate coordinates of two intersections of a line to be drawn on the screen and sides of the graphics element on the basis of the coordinates of the vertices stored in the first fields, and calculates a difference between the coordinates of the two intersections as first data, wherein in a case where the flag field included in the data of said predetermined format as received designates the polygonal graphics element, said intersection calculating unit calculates parameters of the two intersections on the basis of the parameters of the vertices stored in the second fields in accordance with the drawing mode, and calculates a difference between the parameters of the two intersections as second data, wherein in a case where the flag field included in the data of said predetermined format as received designates the rectangular graphics element, said intersection calculating unit calculates coordinates in the second two-dimensional orthogonal coordinate system of the two intersections, as parameters of the two intersections, on the basis of the coordinates of the vertices in the second two-dimensional orthogonal coordinate system included in the second fields, and calculates a difference between the coordinates in the second two-dimensional orthogonal coordinate system of the two intersections, and said intersection calculating unit divides the second data by the first data to obtain a variation quantity of the parameter per unit coordinate in the first two-dimensional coordinate system.

In accordance with this configuration, it is possible to easily determine the type of the graphic element by referring to the flag field to calculate the second data in accordance with the type. Also, since the variation quantity of the parameter per unit coordinate in the first two-dimensional coordinate system is sent to a subsequent stage, the subsequent stage can easily calculate each parameter within the two intersection points by performing the linear interpolation.

In this image generating device, in a case where the flag field included in the data of said predetermined format as received designates the polygonal graphics element and furthermore the drawing mode designates drawing by texture mapping, said intersection calculating unit calculates coordinates after perspective correction and perspective correction parameters of the two intersections on the basis of coordinates of the vertices after the perspective correction and perspective correction parameters stored in the second fields, and calculates respective differences as the second data, and in a case where the flag field included in the data of said predetermined format as received designates the polygonal graphics element and furthermore the drawing mode designates drawing by gouraud shading, said intersection calculating unit calculates color data of the two intersections on the basis of color data stored in the second fields, and calculates a difference between the color data of the two intersections as the second data.

In accordance with this configuration, when the drawing mode designates the drawing by the texture mapping, the subsequent stage can easily calculate each coordinate in the second two-dimensional orthogonal coordinate system within the two intersection points by performing the linear interpolation with regard to the coordinates after the perspective correction and the perspective correction parameters. On the other hand, when the drawing mode designates the drawing by the gouraud shading, the subsequent stage can easily calculate each color data within the two intersection points by performing the linear interpolation.

In this image generating device, said image generating unit further comprising: an adder unit (corresponding to the pixel stepper 120) operable to sequentially add the variation quantity of the coordinate in the second two-dimensional coordinate system per unit coordinate in the first two-dimensional coordinate system, which is calculated by said intersection calculating unit with regard to the rectangular graphics element, to the coordinate of any one of the two intersections in the second two-dimensional coordinate system to obtain coordinates in the second two-dimensional coordinate system for respective coordinates between the two intersections in the first two-dimensional coordinate system, wherein with regard to the polygonal graphics element in a case where the drawing mode designates drawing by texture mapping, said adder unit adds sequentially the variation quantity of the coordinate in the second two-dimensional coordinate system after the perspective correction and the variation quantity of the perspective correction parameter per unit coordinate in the first two-dimensional coordinate system to the coordinate in the second two-dimensional coordinate system after the perspective correction and the perspective correction parameter of any one of the two intersections respectively, and obtains coordinates after the perspective correction and perspective correction parameters between the two intersections, and wherein with regard to the polygonal graphics element in a case where the drawing mode designates drawing by gouraud shading, said adder unit adds sequentially the variation quantity of the color data per unit coordinate in the first two-dimensional coordinate system, which is calculated by said intersection calculating unit, to the color data of any one of the two intersections, and obtains color data of respective coordinates between the two intersections in the first two-dimensional coordinate system.

In this way, regarding the rectangular graphics element, it is possible to easily calculate each coordinate in the second two-dimensional orthogonal coordinate system within the two intersection points by performing the linear interpolation on the basis of the variation quantity of the coordinate in the second two-dimensional orthogonal coordinate system per unit coordinate in the first two-dimensional coordinate system. On the other hand, regarding the polygonal graphics element whose the drawing mode indicates the drawing by the texture mapping, it is possible to easily calculate the coordinates after the perspective correction and the perspective correction parameters within the two intersection points by performing the linear interpolation on the basis of the variation quantity of the coordinate after the perspective correction in the second two-dimensional orthogonal coordinate system and the variation quantity of the perspective correction parameter per unit coordinate in the first two-dimensional coordinate system. Also, regarding the polygonal graphics element whose the drawing mode indicates the drawing by the gouraud shading, it is possible to easily calculate each color data within the two intersection points by performing the linear interpolation on the basis of the variation quantity of the color data per unit coordinate in the first two-dimensional coordinate system.

In the above image generating device, said image generating unit performs drawing processing in units of lines constituting the screen in predetermined line order, wherein said first data converting unit transposes contents of the vertex fields in such a manner that order of coordinates of vertices included in the first fields is coincident with order of appearance of the vertices according to the predetermined line order, and wherein said second data converting unit stores data in the respective vertex fields in such a manner that order of coordinates of vertices of the rectangular graphics element is coincident with order of appearance of the vertices according to the predetermined line order.

In accordance with this configuration, regarding either of the polygonal graphics element and the rectangular graphics element, the contents in the data of the predetermined format are arranged in the appearance order of the vertices, and thereby it is possible to be simple drawing processing in a subsequent stage.

In the above image generating device, said image generating unit comprising: an intersection calculating unit (corresponding to the slicer 118) operable to receive the data of said predetermined format, wherein said intersection calculating unit calculates coordinates of two intersections of a line to be drawn on the screen and sides of the graphics element on the basis of the coordinates of the vertices stored in the first fields, and obtains a difference between the coordinates of the two intersections as first data, calculates parameters of the two intersections on the basis of the parameters of the vertices stored in the second fields, and obtains a difference between the parameters of the two intersections as second data, and divides the second data by the first data to obtain a variation quantity of the parameter per unit coordinate in the first two-dimensional coordinate system.

In accordance with this configuration, since the variation quantity of the parameter per unit coordinate in the first two-dimensional coordinate system is sent to a subsequent stage, the subsequent stage can easily calculate each parameter within the two intersection points by performing the linear interpolation.

In this image generating device, said image generating unit further comprising: an adder unit (corresponding to the pixel stepper 120) operable to sequentially add the variation quantity of the parameter per unit coordinate in the first two-dimensional coordinate system, which is calculated by said intersection calculating unit, to the parameter of any one of the two intersections to obtain parameters of respective coordinates between the two intersections in the first two-dimensional coordinate system.

In this way, it is possible to easily calculate each parameter within the two intersection points by performing the linear interpolation on the basis of the variation quantity of the parameter per unit coordinate in the first two-dimensional coordinate system.

The above image generating device further comprising: a merge sorting unit (corresponding to the merge sorter 106) operable to determine priority levels for drawing the polygonal graphics elements and the rectangular graphics elements in drawing processing in accordance with a predetermined rule, wherein the first display information is previously stored in a first array in the descending order of the priority levels for drawing, wherein the second display information is previously stored in a second array in the descending order of the priority level for drawing, wherein said merge sorting unit compares the priority levels for drawing between the first display information and the second display information, wherein in a case where the priority level for drawing of the first display information is higher than the priority level for drawing of the second display information, said merge sorting unit reads out the first display information from the first array, wherein in a case where the priority level for drawing of the second display information is higher than the priority level for drawing of the first display information, said merge sorting unit reads out the second display information from the second array, and wherein said merge sorting unit outputs the first display information as a single data string when the first display information is read out, and outputs the second display information as said single data string when the second display information is read out.

In accordance with this configuration, all the display information pieces are sorted in the priority order for drawing regardless of the first display information and the second display information followed by outputting them as the same unified data strings, so that the subsequent function blocks can be shared with the polygonal graphics element and the rectangular graphics element as much as possible, and thereby it is possible to further suppress the hardware scale.

In this image generating device, in a case where drawing processing is performed in accordance with predetermined line order and an appearance vertex coordinate stands for a coordinate of a vertex which appears earliest in the predetermined line order among coordinates in the first two-dimensional coordinate system of a plurality of vertices of the graphics element in a drawing process according to the predetermined line order, the predetermined rule is defined in such a manner that the priority level for drawing of the graphics element whose the appearance vertex coordinate appears earlier in the predetermined line order is higher.

In accordance with this configuration, since the merge sort is performed in accordance with the predetermined rule where the priority level for drawing the graphics element whose the appearance vertex coordinate appears earlier is higher, the drawing processing is just performed in the output order to the first display information and the second display information each of which is outputted as the unified data string. As a result, a high capacity buffer for storing one or more frames of image data (such as a frame buffer) is not necessarily implemented, but it is possible to display the image which consists of the combination of many polygonal graphics elements and rectangular graphics elements even if only a smaller capacity buffer (such as a line buffer, or a pixel buffer for drawing pixels short of one line) is implemented.

In this image generating device, said merge sorting unit compares display depth information included in the first display information and display depth information included in the second display information when the appearance vertex coordinates are same as each other, and determines that the graphics element to be drawn in a deeper position has the higher priority level for drawing.

In accordance with this configuration, the priority order for drawing is determined in order of the display depths in the line to be drawn when the appearance vertex coordinates of the polygonal graphics element and the rectangular graphics element are equal. Accordingly, the graphics element to be drawn in a deeper position is drawn first in the line to be drawn (drawing in order of the display depths). As a result, the translucent composition process can be appropriately performed.

In this image generating device, said merge sorting unit determines the priority level for drawing after replacing the appearance vertex coordinate by a coordinate corresponding to a line to be drawn first when said appearance vertex coordinate is located before the line to be drawn first.

In accordance with this configuration, in the case where both the appearance vertex coordinates of the polygonal graphics element and the rectangular graphics element are located before the line to be drawn at the beginning (i.e., the top line on the screen), since it is assumed that they have the same coordinate, as described above, it is determined on the basis of the display depth information that the graphics element to be drawn in a deeper position has the higher priority level for drawing. Accordingly, the graphics elements are drawn in order of display depths in the top line of the screen. If such process in the top line is not performed, the drawing in order of the display depths in the top line is not always ensured. However, in accordance with this configuration, it is possible to draw in order of the display depths from the top line. The advantageous effect concerning the drawing in order of the display depths is same as the above description.

In this image generating device, in a case of an interlaced display, when the appearance vertex coordinate corresponds to a line not to be drawn in a field to be displayed of an odd field an even field, said merge sorting unit replaces said appearance vertex coordinate by a coordinate corresponding to a line next to said line and deals with it.

In accordance with this configuration, in the case of an interlaced display, since the appearance vertex coordinate corresponding to a line which is not drawn in the field to be displayed and the appearance vertex coordinate corresponding to a line (a line to be draw in the field to be displayed) next to the line are handled as the same coordinates, as described above, it is determined on the basis of the display depths that the graphics element to be drawn in a deeper position has the higher priority level for drawing. Accordingly, the drawing processing in order of display depths is ensured even if the interlaced display is performed. The advantageous effect concerning the drawing in order of the display depths is same as the above description.

In accordance with a second aspect of the present invention, a texture mapping device operable to map a texture to a polygonal graphics element, wherein: the texture is divided into a plurality of pieces, at least the one piece is rotated and moved in a first two-dimensional texel space where the texture is arranged in such a manner that the texture is mapped to the graphics element, and all the pieces are arranged in a second two-dimensional texel space where the texture is arranged in such a manner that the texture is stored in a memory.

said texture mapping device comprising: a reading unit operable to read out the pieces from a two-dimensional array where all the pieces arranged in the second two-dimensional space are stored; a combining unit operable to combine the pieces as read out; and a mapping unit operable to map the texture obtained by combining the pieces to the polygonal graphics element.

In accordance with this configuration, the texture is not stored in the memory in the same manner as when it is mapped to the graphics element but is divided into the plurality of the pieces and is stored in the memory after the rotation and movement of at least the one piece. As a result, even if the texture which is mapped to the polygon such as a triangle other than a quadrangle is stored in the memory, it is possible to reduce the useless storage space where the texture is not stored and store efficiently, and thereby the capacity of the memory where the texture pattern data is stored can be reduced.

In other words, of the texel data pieces constituting the texture pattern data, the texel data pieces in the area where the texture is arranged include a substantial content (information which indicates color directly or indirectly), while the texel data pieces in the area where the texture is not arranged do not include the substantial content and therefore they are useless. It is possible to suppress necessary memory capacity by reducing the useless texel data pieces as much as possible.

The texture pattern data in this case does not only mean the texel data pieces in the area where the texture is arranged but also includes the texel data pieces in the area other than it. For example, the texture pattern data means the texel data pieces in the quadrangular area including the triangular texture.

In this texture mapping device, the polygonal graphics element is a triangular graphics element, and wherein the texture is a triangular texture.

Especially, if the triangular texture to be mapped to the triangular graphics element is stored in the two-dimensional array as it is, an approximately half of the texel data pieces of the array is wasted. It is possible to reduce the useless texel data pieces considerably by dividing the triangular texture to be mapped to the triangular graphics element into the plurality of the pieces to store them.

In this texture mapping device, the texture is divided into the two pieces, the one piece thereof is rotated and moved, and the two pieces are stored in the two-dimensional array.

In accordance with this configuration, it is possible to reduce the useless texel data pieces considerably by dividing the triangular texture to be mapped to the triangular graphics element into the two pieces to store them.

In this texture mapping device, the triangular texture is a right-angled triangular texture which has a side parallel to a first coordinate axis of the second two-dimensional texel space and a side parallel to a second coordinate axis orthogonal to the first coordinate axis, wherein the right-angled triangular texture is divided into the two pieces by a line parallel to any one of the first coordinate axis and the second coordinate axis, and wherein the one piece is rotated by an angle of 180 degrees and moved, and the two pieces are stored in the two-dimensional array.

In accordance with this configuration, it is possible to reduce data amount necessary for designating the coordinates of the vertex of the triangle in the first two-dimensional texel space by conforming two sides forming a right angle to one coordinate axis and the other coordinate axis in the first two-dimensional texel space respectively, and assigning the vertex of the right angle to the origin of the first two-dimensional texel space because of the right triangular texture.

In the above texture mapping device, a first storing format and a second storing format are provided as formats for storing the texture in the two-dimensional array, wherein the texture is composed of a plurality of texels, wherein in the first storing format, all the pieces are stored in the two-dimensional array in such a manner that one block of the texels is stored in one word of the memory, and the one block consists of the first predetermined number of texels which are one-dimensionally aligned and are parallel to any one of a first coordinate axis in the second two-dimensional texel space and a second coordinate axis orthogonal to the first coordinate axis, and wherein in the second storing format, the all pieces are stored in the two-dimensional array in such a manner that one block of the texels is stored in one word of the memory, and the one block consists of the second predetermined number of texels which are two-dimensionally arranged in the second two-dimensional texel space.

In this case, it is assumed that the polygonal graphics element (e.g., the polygon) represents a shape of each surface of a three-dimensional solid projected to a two-dimensional space. In this way, even if the graphics element is the graphics element for representing the three-dimensional solid, it may be used as the two-dimensional graphics element which is plane parallel to the screen (similar to the sprite).

While the screen is constituted of a plurality of horizontal lines which are arranged parallel to one another, when the graphics element for representing the three-dimensional solid is used as the two-dimensional graphics element, it is possible to reduce memory capacity necessary for temporally storing the texel data by acquiring the texel data in units of horizontal lines.

Since the one-dimensionally aligned texel data pieces are stored in one word of the memory in the first storage format, it is possible to reduce the frequency of accessing the memory when the texel data is acquired in units of horizontal lines.

On the other hand, in the case where the three-dimensional solid is represented by the polygonal graphics element, when the pixels on the horizontal line of the screen are mapped to the first two-dimensional texel space, they are not always mapped to the horizontal line in the first two-dimensional texel space.

As just described, even if the pixels are not mapped to the horizontal line in the first two-dimensional texel space, it is possible to reduce the frequency of accessing the memory when the texel data pieces are acquired in the second storage format. Because, since the two-dimensionally arranged texel data pieces are stored in one word of the memory in the second storage format, possibility that the texel data piece located at coordinates of the pixel as mapped is present in the texel data pieces already acquired from the memory is high.

In the above texture mapping device, in a case where repeating mapping of the texture is performed, the texture is stored in the two-dimensional array without the division, the rotation and the movement, said reading unit reads out the texture from the two-dimensional array, said combining unit does not perform a process of combining, and said mapping unit maps the texture read out by said reading unit to the polygonal graphics element.

In accordance with this configuration, since the texture is stored in the two-dimensional array without the division, the rotation and the movement, it is suitable for storing the texture pattern data into the memory when the texture is repeatedly mapped in the horizontal direction and/or in the vertical direction. In addition, the same texture pattern data can be used because of the repeating mapping, and thereby it is possible to reduce memory capacity.

In accordance with a third aspect of the present invention, an image processing device operable to perform bi-liner filtering, wherein: a texture is divided into a plurality of pieces, at least the one piece is rotated by an angle of 180 degrees and moved in a first two-dimensional texel space where the texture is arranged in such a manner that the texture is mapped to a polygonal graphics element, and all the pieces are arranged in a second two-dimensional texel space where the texture is arranged in such a manner that the texture is stored in a memory, and all the pieces are stored in a two-dimensional array in such a manner that a texel for the bi-liner filtering is arranged so as to be adjacent to the piece in the second two-dimensional texel space.

said image processing device comprising: a coordinate calculating unit operable to calculate coordinates (S, T) in the second two-dimensional texel space corresponding to coordinates in the first two-dimensional texel space where a pixel included in the graphics element is mapped; a reading unit operable to read out four texels located at the coordinates (S, T), coordinates (S+1, T), coordinates (S, T+1), and coordinates (S+1, T+1) in the second two-dimensional texel space in a case where the coordinates (S, T) corresponding to the pixel as mapped is included in the piece stored in the two-dimensional array without the rotation by an angle of 180 degrees and the movement, and read out four texels located at the coordinates (S, T), coordinates (S−1, T), coordinates (S, T−1), and coordinates (S−1, T−1) in the second two-dimensional texel space in a case where the coordinates (S, T) corresponding to the pixel as mapped is included in the piece stored in the two-dimensional array with the rotation by an angle of 180 degrees and the movement; and a bi-liner filtering unit operable to perform the bi-liner filtering of the pixel as mapped using the four texels read out by the reading unit.

In accordance with this configuration, when the bi-liner filtering is performed, even if the coordinates (S, T) corresponding to the pixel as mapped is included in the piece which is rotated by an angle of 180 degrees, moved, and then stored in the two-dimensional array, four texels are acquired reflecting them. In addition, the texels for the bi-liner filtering are stored so as to be adjacent to pieces between the pieces to which the divided storing has been applied.

As a result, even if the divided storing of the texture is performed, it is possible to implement the bi-liner filtering process without problems.

In accordance with a fourth aspect of the present invention, an image processing device operable to perform a process of drawing respective pixels constituting a triangular graphics element by mapping a texture to the graphics element, wherein: a first coordinate system stands for a two-dimensional orthogonal coordinate system where the pixel is drawn, and coordinates (X, Y) stand for coordinates in the first coordinate system; a second coordinate system stands for a two-dimensional orthogonal coordinate system where respective texels constituting the texture are arranged in such a manner that the respective texels are mapped to the graphics element, and coordinates (U, V) stand for coordinates in the second coordinate system; a third coordinate system stands for a two-dimensional orthogonal coordinate system where the respective texels are arranged in such a manner that the respective texels are stored in a memory, and coordinates (S, T) stand for coordinates in the third coordinate system; and a V coordinate threshold value is determined on the basis of a V coordinate of the texel which has a maximum V coordinate among the texels.

said image processing device comprising: a coordinate calculating unit operable to map the coordinates (X, Y) of the pixel in the first coordinate system to the second coordinate system to obtain the coordinates (U, V) of the pixel; a coordinate converting unit operable to assign the coordinates (U, V) of the pixel to the coordinates (S, T) in the third coordinate system when the V coordinate of the pixel is less than or equal to the V coordinate threshold value, and rotate by an angle of 180 degrees and move the coordinates (U, V) of the pixel to convert it into the coordinates (S, T) of the pixel in the third coordinate system when the V coordinate of the pixel exceeds the V coordinate threshold value; and a reading unit operable to read out texel data from the memory based on the coordinates (S, T) of the pixel.

In accordance with this configuration, in the case where the texture is divided into two pieces with the boundary of the V coordinate threshold value, and the piece whose the V coordinate is larger is rotated by the angle of 180 degrees, moved, and then stored, the appropriate texel data can be read from the storage source.

In this image processing device, in a case where repeating mapping of the texture is performed, irrespective of whether or not the V coordinate of the pixel is less than or equal to the V coordinate threshold value, said coordinate converting unit assigns a value obtained by replacing upper M bits (“M” is one or a larger integer) of the U coordinate by “0” to the S coordinate of the pixel, assigns a value obtained by replacing upper N bits (“N” is one or a larger integer) of the V coordinate by “0” to the T coordinate of the pixel, and converts the coordinates (U, V) of the respective pixels in the second coordinate system into the coordinates (S, T) of the respective pixels in the third coordinate system.

In accordance with this configuration, the repeating mapping of the texture can be easily implemented using the same texture pattern data by masking (setting to bits 0) the upper M bits and/or the upper N bits. As a result, it is possible to reduce the memory capacity.

In accordance with a fifth aspect of the present invention, a texture storing method comprising the steps of: dividing a texture to be mapped to a polygonal graphics element into a plurality of pieces; and storing all the pieces arranged in a second two-dimensional texel space where the texture is arranged in such a manner that the texture is stored in a memory into a two-dimensional array which is stored in a storage area with smaller memory capacity than memory capacity necessary to store the texture in a two-dimensional array without division, by rotating and moving at least the one piece in a first two-dimensional texel space where the texture is arranged in such a manner that the texture is mapped to the graphics element.

In accordance with a sixth aspect of the present invention, an image generating device operable to generate an image, which is constituted by a plurality of graphics elements, to be displayed on a screen, said image generating device comprising: a data requesting unit operable to issues a request for reading out texture data to be mapped to the graphics element from an external memory; a texture buffer unit operable to temporarily hold the texture data read out from the memory; a texture buffer managing unit operable to allocate an area corresponding to size of the texture data in order to store the texture data to be mapped to the graphics element drawing of which is newly started and deallocate an area where the texture data mapped to the graphics element drawing of which is completed is stored.

In accordance with this configuration, in the case where the texture data is reused, it is possible to prevent useless access to the external memory by temporarily storing the texture data as read out in the texture buffer unit instead of reading out the texture data from the external memory (e.g., the external memory 50) each time. In addition, efficiency in the use of the texture buffer unit is improved by dividing the texture buffer unit into areas with the necessary sizes and performing dynamically allocation and deallocation of the area, and thereby it is possible to suppress an excessive increase of a hardware resource for the texture buffer unit.

In this image generating device, the plurality of the graphic elements are constituted by any combination of polygonal graphics elements to represent a shape of each surface of a three-dimensional solid projected to a two-dimensional space and rectangular graphics elements each of which is parallel to a frame of said screen, and wherein said texture buffer managing unit assigns a size capable of storing only a part of the texture data to a storage area of the texture data to be mapped to the rectangular graphics element and assigns a size capable of storing the entire texture data to a storage area of the texture data to be mapped to the polygonal graphics element.

In accordance with this configuration, in the case where the drawing of the graphic element is sequentially performed in units of the horizontal lines, it is possible to read out the texture data to be mapped to the rectangular graphics element (e.g., the sprite) from the external memory in units of horizontal lines in accordance with the progress of the drawing processing, and thereby it is possible to suppress size of the area to be allocated on the texture buffer unit. On the other hand, regarding the texture data to be mapped to the polygonal graphics element (e.g., the polygon), since it is difficult to predict in advance which part of the texture data is required, the area with size capable of storing the entire texture data is allocated on the texture buffer unit.

In this image generating device, said data requesting unit requests the texture data to be mapped in units of parts of the texture data according to progress of drawing when requesting the texture data to be mapped to the rectangular graphics element, and requests collectively the entirety of the texture data to be mapped when requesting the texture data to be mapped to the polygonal graphics element.

In the above an image generating device, said texture buffer managing unit manages said texture buffer unit by a plurality of structure instances which manages respective areas of said texture buffer unit.

In this way, the process for allocating and deallocating the area is simple by managing each area of the texture buffer unit using the structure instances.

In this image generating device, the plurality of the structure instances are classified into a plurality of groups in accordance with sizes of areas which they manage, and the structure instances in the group are annularly linked.

In accordance with this configuration, it is possible to easily retrieve each area of the texture buffer unit as well as the structure instance.

This image generating device further comprising: a structure initializing unit operable to set all the structure instances to initial values.

In this way, it is possible to prevent the fragmentation of the area of the texture buffer unit by setting all the structure instances to initial values. It is possible to realize means for preventing the fragmentation by a smaller circuit scale than a general garbage collection while shortening processing time. Also, problems concerning the drawing process do not occur at all by initializing the entirety of the texture buffer unit each time the drawing of one video frame or one field is completed because of the process for drawing the graphic element.

This image generating device further comprising: a control register operable to set a time interval when said structure initializing unit accesses the structure instance to set the structure instance to the initial value, wherein said control register is accessible from outside.

In this way, since the control register is accessible from outside, it is possible to set freely the time interval when the structure initializing unit accesses, and thereby the initializing process can be performed without causing degradation of the entire performance of the system. Incidentally, for example, in the case where the structure array is allocated on the shared memory, if access from the structure initializing unit is continuously performed, latency of the access the shared memory from other function units increases and thereby the entire performance of the system may decrease.

In the above image generating device, said texture buffer unit is configurable with an optional size and/or an optional location on a shared memory which is shared by said image generating device and an external function unit.

In this way, by enabling the optional setting with regard to the both of the size and location of the texture buffer unit on the shared memory, in the case where the necessary texture buffer area is small, the other function unit can use a surplus area.

### BRIEF DESCRIPTION OF THE DRAWINGS

The novel features of the invention are set forth in the appended claims. The invention itself, however, as well as other features and advantages thereof, will be best understood by reading the detailed description of specific embodiments in conjunction with the accompanying drawings.

FIG. 1 is a block diagram showing the internal structure of a multimedia processor 1 in accordance with an embodiment of the present invention.

FIG. 2 is a block diagram showing the internal structure of the RPU 9 of FIG. 1.

FIG. 3 is a view for showing the constitution of the polygon structure in the texture mapping mode.

FIG. 4 is a view for showing the constitution of the texture attribute structure.

FIG. 5 is a view for showing the constitution of the polygon structure in the gouraud shading mode.

FIG. 6(a) is a view for showing the constitution of the sprite structure when scissoring is disabled. FIG. 6(b) is a view for showing the constitution of the sprite structure when scissoring is enabled.

FIG. 7 is an explanatory view for showing an input/output signal relative to the merge sorter 106 of FIG. 2.

FIG. 8 is an explanatory view for showing an input/output signal relative to the vertex expander 116 of FIG. 2.

FIG. 9 is an explanatory view for showing the calculating process of vertex parameters of the sprite.

FIG. 10 is an explanatory view for showing an input/output signal relative to the vertex sorter 114 of FIG. 2.

FIG. 11 is an explanatory view for showing the calculating process of vertex parameters of the polygon.

FIG. 12 is an explanatory view for showing the sort process of vertices of the polygon.

FIG. 13 is a view for showing the configuration of the polygon/sprite shared data Cl.

FIG. 14 is an explanatory view for showing the process of the polygon in the gouraud shading mode by means of the slicer 118 of FIG. 2.

FIG. 15 is an explanatory view for showing the process of the polygon in the texture mapping mode by means of the slicer 118 of FIG. 2.

FIG. 16 is an explanatory view for showing the process of the sprite by means of the slicer 118 of FIG. 2.

FIG. 17 is an explanatory view for showing the bi-liner filtering by means of the bi-liner filter 130 of FIG. 2.

FIG. 18(a) is a view for showing an example of the texture arranged in the ST space when the repeating mapping is performed. FIG. 18(b) is a view for showing an example of the textures arranged in the UV space, which are mapped to the polygon, when the repeating mapping is performed. FIG. 18(c) is a view for showing an example of the drawing of the polygon in the XY space to which the texture is repeatedly mapped.

FIG. 19(a) is a view for showing an example of the texture arranged in the ST space, which is mapped to the polygon, when the member “MAP” of the polygon structure is “0”. FIG. 19(b) is a view for showing an example of the texture arranged in the ST space, which is mapped to the polygon, when the member “MAP” of the polygon structure is “1”.

FIG. 20 is a view for showing an example of the texture arranged in the ST space, which is mapped to the sprite.

FIG. 21(a) is an explanatory view for showing the texel block stored in one memory word when the member “MAP” of the polygon structure is “0”. FIG. 21(b) is an explanatory view for showing the texel block stored in one memory word when the member “MAP” of the polygon structure is “1”. FIG. 21(c) is an explanatory view for showing the storage state of the texel block into one memory word.

FIG. 22 is a block diagram showing the internal structure of the texel mapper 124 of FIG. 2.

FIG. 23 is a block diagram showing the internal structure of the texel address calculating unit 40 of FIG. 22.

FIG. 24 is an explanatory view for showing the bi-liner filtering when the texture pattern data is divided and stored.

FIG. 25(a) is a view for showing the configuration of the boss MCB structure. FIG. 25(b) is a view for showing the configuration of the general MCB structure.

FIG. 26 is an explanatory view for showing the sizes of the texture buffer areas managed by the boss MCB structure instances [0] to [7].

FIG. 27 is an explanatory view for showing the initial values of the boss MCB structure instances [0] to [7].

FIG. 28 is an explanatory view for showing the initial values of the general MCB structure instances [8] to [127].

FIG. 29 is a tabulated view for showing the RPU control registers relative to the memory manager 140 of FIG. 2.

FIG. 30 is a flow chart for showing a part of the sequence for allocating the texture buffer area.

FIG. 31 is a flow chart for showing another part of the sequence for allocating the texture buffer area.

FIG. 32 is a flow chart for showing the sequence for deallocating the texture buffer area.

FIG. 33 is a view for showing the structure of the chain of the boss MCB structure instance, and a concept in the case that the general MCB structure instance is newly inserted into the chain of the boss MCB structure instance.

### BEST MODE FOR CARRYING OUT THE INVENTION

In what follows, several embodiments of the present invention will be explained in conjunction with the accompanying drawings. Meanwhile, like references indicate the same or functionally similar elements throughout the respective drawings, and therefore redundant explanation is not repeated. Also, when it is necessary to specify a particular bit or bits of a signal, [a] or [a:b] is suffixed to the name of the signal. While [a] stands for the a-th bit of the signal, [a:b] stands for the a-th to b-th bits of the signal. While a prefixed “0b” is used to designate a binary number, a prefixed “0x” is used to designate a hexadecimal number. In the following equations, the symbol “*” stands for multiplication.

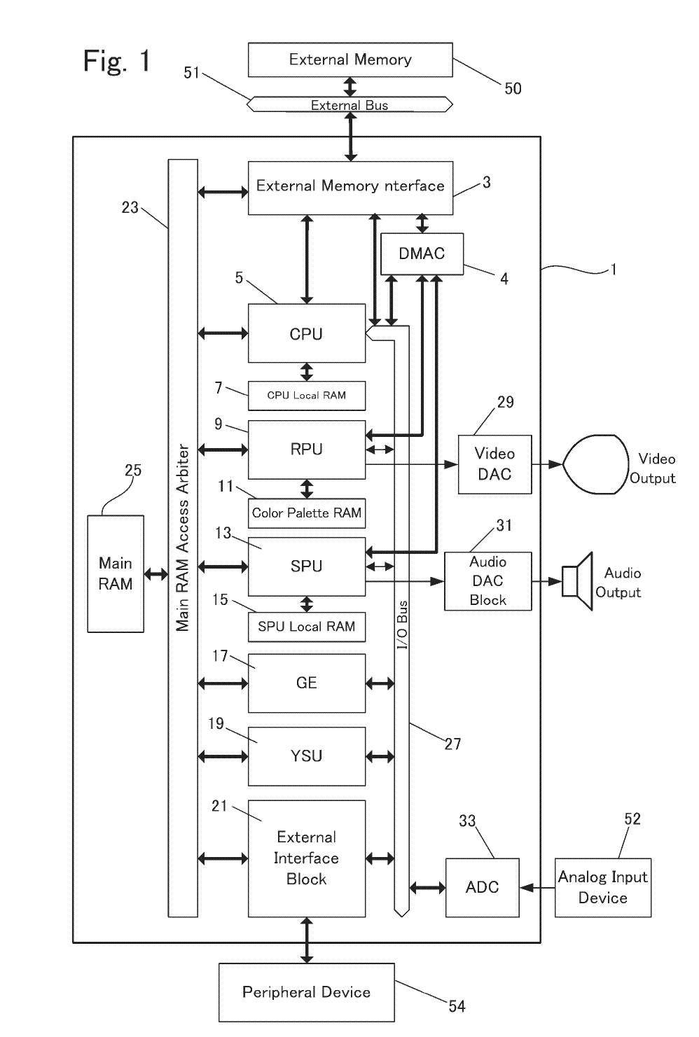

FIG. 1 is a block diagram showing the internal structure of a multimedia processor 1 in accordance with the embodiment of the present invention. As shown in FIG. 1, this multimedia processor 1 comprises an external memory interface 3, a DMAC (direct memory access controller) 4, a central processing unit (referred to as the “CPU” in the following description) 5, a CPU local RAM 7, a rendering processing unit (referred to as the “RPU” in the following description) 9, a color palette RAM 11, a sound processing unit (referred to as the “SPU” in the following description) 13, an SPU local RAM 15, a geometry engine (referred to as the “GE” in the following description) 17, a Y sorting unit (referred to as the YSU in the following description) 19, an external interface block 21, a main RAM access arbiter 23, a main RAM 25, an I/O bus 27, a video DAC (digital to analog converter) 29, an audio DAC block 31 and an A/D converter (referred to as the “ADC” in the following description) 33. The main RAM 25 and the external memory 50 are generally referred to as the “memory MEM” in the case where they need not be distinguished.

The CPU 5 performs various operations and controls the overall system in accordance with a program stored in the memory MEM. Also, the CPU 5 can issue a request, to the DMAC 4, for transferring a program and data and, alternatively, can fetch program codes directly from the external memory 50 and access data stored in the external memory 50 through the external memory interface 3 and the external bus 51 but without intervention of the DMAC 4.

The I/O bus 27 is a bus for system control and used by the CPU 5 as a bus master for accessing the control registers of the respective function units (the external memory interface 3, the DMAC 4, the RPU 9, the SPU 13, the GE 17, the YSU 19, the external interface block 21 and the ADC 33) as bus slaves and the local RAMs 7, 11 and 15. In this way, these function units are controlled by the CPU 5 through the I/O bus 27.

The CPU local RAM 7 is a RAM dedicated to the CPU 5, and used to provide a stack area in which data is saved when a sub-routine call or an interrupt handler is invoked and provide a storage area of variables which is used only by the CPU 5.

The RPU 9, which is one of the characteristic features of the present invention, serves to generate three-dimensional images each of which is composed of polygons and sprites on a real time base. More specifically speaking, the RPU 9 reads the respective structure instances of the polygon structure array and sprite structure array, which are sorted by the YSU 19, from the main RAM 25, and generates an image for each horizontal line in synchronization with scanning the screen (display screen) by performing predetermined processes. The image as generated is converted into a data stream indicative of a composite video signal wave, and output to the video DAC 29. Also, the RPU 9 is provided with the function of issuing a DMA transfer request to the DMAC 4 for receiving the texture pattern data of polygons and sprites.

The texture pattern data is two-dimensional pixel array data to be arranged on a polygon or a sprite, and each pixel data item is part of the information for designating an entry of the color palette RAM 11. In what follows, the pixels of texture pattern data are generally referred to as “texels” in order to distinguish them from “pixels” which are used to represent picture elements of an image displayed on the screen. Therefore, the texture pattern data is an aggregate of the texel data.

The polygon structure array is a structure array of polygons each of which is a polygonal graphic element, and the sprite structure array is a structure array of sprites which are rectangular graphic elements respectively in parallel with the screen. Each element of the polygon structure array is called a “polygon structure instance”, and each element of the sprite structure array is called a “sprite structure instance”. Nevertheless they are generally referred to simply as the “structure instance” in the case where they need not be distinguished.

The respective polygon structure instances stored in the polygon structure array are associated with polygons in a one-to-one correspondence, and each polygon structure instance consists of the display information of the corresponding polygon (containing the vertex coordinates in the screen, information about the texture pattern to be used in a texture mapping mode, and the color data (RGB color components) to be used in a gouraud shading mode). The respective sprite structure instances stored in the sprite structure array are associated with sprites in a one-to-one correspondence, and each sprite structure instance consists of the display information of the corresponding sprite (containing the coordinates in the screen, and information about the texture pattern to be used).

The video DAC 29 is a digital/analog conversion unit which is used to generate an analog video signal. The video DAC 29 converts a data stream which is input from the RPU 9 into an analog composite video signal, and outputs it to a television monitor and the like (not shown in the figure) through a video signal output terminal (not shown in the figure).

The color palette RAM 11 is used to provide a color palette of 512 colors, i.e., 512 entries in the case of the present embodiment. The RPU 9 converts the texture pattern data into color data (RGB color components) by referring to the color palette RAM 11 on the basis of a texel data item included in the texture pattern data as part of an index which points to an entry of the color palette.

The SPU 13 generates PCM (pulse code modulation) wave data (referred to simply as the “wave data” in the following description), amplitude data, and main volume data. More specifically speaking, the SPU 13 generates wave data for 64 channels at a maximum, and time division multiplexes the wave data, and in addition to this, generates envelope data for 64 channels at a maximum, multiplies the envelope data by channel volume data, and time division multiplexes the amplitude data. Then, the SPU 13 outputs the main volume data, the wave data which is time division multiplexed, and the amplitude data which is time division multiplexed to the audio DAC block 31.

In addition, the SPU 13 is provided with the function of issuing a DMA transfer request to the DMAC 4 for receiving the wave data and the envelope data.

The audio DAC block 31 converts the wave data, amplitude data, and main volume data as input from the SPU 13 into analog signals respectively, and analog multiplies the analog signals together to generate analog audio signals. These analog audio signals are output to audio input terminals (not shown in the figure) of a television monitor (not shown in the figure) and the like through audio signal output terminals (not shown in the figure).

The SPU local RAM 15 stores parameters (for example, the storage addresses and pitch information of the wave data and envelope data) which are used when the SPU 13 performs wave playback and envelope generation.

The GE 17 performs geometry operations for displaying three-dimensional images. Specifically, the GE 17 executes arithmetic operations such as matrix multiplications, vector affine transformations, vector orthogonal transformations, perspective projection transformations, the calculations of vertex brightnesses/polygon brightnesses (vector inner products), and polygon back face culling processes (vector cross products).

The YSU 19 serves to sort the respective structure instances of the polygon structure array and the respective structure instances of the sprite structure array, which are stored in the main RAM 25, in accordance with sort rules 1 to 4.

In what follows, the sort rules 1 to 4 to be performed by the YSU 19 will be explained, but the coordinate system to be used will be explained in advance. The two-dimensional coordinate system which is used for actually displaying an image on a display device such as a television monitor (not shown in the figure) is referred to as the screen coordinate system. In the case of the present embodiment, the screen coordinate system is represented by a two-dimensional pixel array of horizontal 2048 pixels×vertical 1024 pixels. While the origin of the coordinate system is located at the upper left corner, the positive X-axis is extending in the horizontal rightward direction, and the positive Y-axis is extending in the vertical downward direction. However, the area which is actually displayed is not the entire space of the screen coordinate system but is part thereof. This display area is referred to as the screen. The Y-coordinate to be used in the sort rules 1 to 4 is a value of the screen coordinate system.

The sort rule 1 is a rule in which the respective polygon structure instances are sorted in ascending order of the minimum Y-coordinates. The minimum Y-coordinate is the smallest one of the Y-coordinates of the three vertices of the polygon. The sort rule 2 is a rule in which when there are polygons having the same minimum Y-coordinate, the respective polygon structure instances are sorted in descending order of the depth values.

However, with regard to a plurality of polygons which include pixels at the top line of the screen but have different minimum Y-coordinates from each other, the YSU 19 sorts the respective polygon structure instances in accordance with the sort rule 2, rather than the sort rule 1, on the assumption that they have the same Y-coordinate. In other words, in the case where there is a plurality of polygons which includes pixels at the top line of the screen, these polygon structure instance are sorted in descending order of the depth values on the assumption that they have the same Y-coordinate. This is the sort rule 3.

The above sort rules 1 to 3 are applied also to the case where interlaced scanning is performed. However, the sort operation for displaying an odd field is performed in accordance with the sort rule 2 on the assumption that the minimum Y-coordinate of the polygon which is displayed on an odd line and/or the minimum Y-coordinate of the polygon which is displayed on the even line followed by the odd line are equal. However, the above is not applicable to the top odd line. This is because there is no even line followed by the top odd line. On the other hand, the sort operation for displaying an even field is performed in accordance with the sort rule 2 on the assumption that the minimum Y-coordinate of the polygon which is displayed on an even line and/or the minimum Y-coordinate of the polygon which is displayed on the odd line followed by the even line are equal. This is the sort rule 4.

Sort rules 1 to 4 applicable to sprites are same as the sort rules 1 to 4 applicable to polygons respectively. In this case, the minimum Y-coordinate of a sprite is the minimum Y-coordinate among the Y-coordinates of the four vertices of the sprite.

The external memory interface 3 serves to read data from the external memory 50 and write data to the external memory 50, respectively through the external bus 51. In this case, the external memory interface 3 arbitrates external bus use request purposes (causes of requests for accessing the external bus 51) issued from the CPU 5 and the DMAC 4 in accordance with an EBI priority level table, which is not shown in the figure, in order to select one of the external bus use request purposes. Then, accessing the external bus 51 is permitted for the external bus use request purpose as selected. The EBI priority level table is a table for determining the priority levels of various kinds of external bus use request purposes issued from the CPU 5 and the external bus use request purpose issued from the DMAC 4.

The DMAC 4 serves to perform DMA transfer between the main RAM 25 and the external memory 50 connected to the external bus 51. In this case, the DMAC 4 arbitrates DMA transfer request purposes (causes of requests for DMA transfer) issued from the CPU 5, the RPU 9 and the SPU 13 in accordance with a DMA priority level table, which is not shown in the figure, in order to select one of the DMA transfer request purposes. Then, a DMA transfer request is issued to the external memory interface 3. The DMA priority level table is a table for determining the priority levels of DMA transfer request purposes issued from the CPU 5, the RPU 9 and the SPU 13.

The external interface block 21 is an interface with peripheral devices 54 and includes programmable digital input/output ports providing 24 channels. The respective 24 channels of the I/O port are used to connect with one or a plurality of a mouse interface function of 4 channels, a light gun interface function of 4 channels, a general purpose timer/counter function of 2 channels, an asynchronous serial interface function of one channel, and a general purpose parallel/serial conversion port function of one channel.

The ADC 33 is connected to analog input ports of 4 channels and serves to convert analog signals, which are input from an analog input device 52 through the analog input ports, into digital signals. For example, an analog signal such as a microphone voice signal is sampled and converted into digital data.

The main RAM access arbiter 23 arbitrates access requests issued from the function units (the CPU 5, the RPU 9, the GE 17, the YSU 19, the DMAC 4 and the external interface block 21 (the general purpose parallel/serial conversion port)) for accessing the main RAM 25, and grants access permission to one of the function units.

The main RAM 25 is used by the CPU 5 as a work area, a variable storing area, a virtual memory management area and so forth. Furthermore, the main RAM 25 is also used as a storage area for storing data to be transferred to another function unit by the CPU 5, a storage area for storing data which is DMA transferred from the external memory 50 by the RPU 9 and SPU 13, and a storage area for storing input data and output data of the GE 17 and YSU 19.

The external bus 51 is a bus for accessing the external memory 50. It is accessed through the external memory interface 3 from the CPU 5 and the DMAC 4.

The address bus of the external bus 51 consists of 30 bits, and is connectable with the external memory 50, whose capacity can be up to a maximum of 1 Giga bytes (=8 Giga bits). The data bus of the bus 51 consists of 16 bits, and is connectable with the external memory 50, whose data bus width is 8 bits or 16 bits. External memories having different data bus widths can be connected at the same time, and there is provided the capability of automatically switching the data bus width in accordance with the external memory to be accessed.

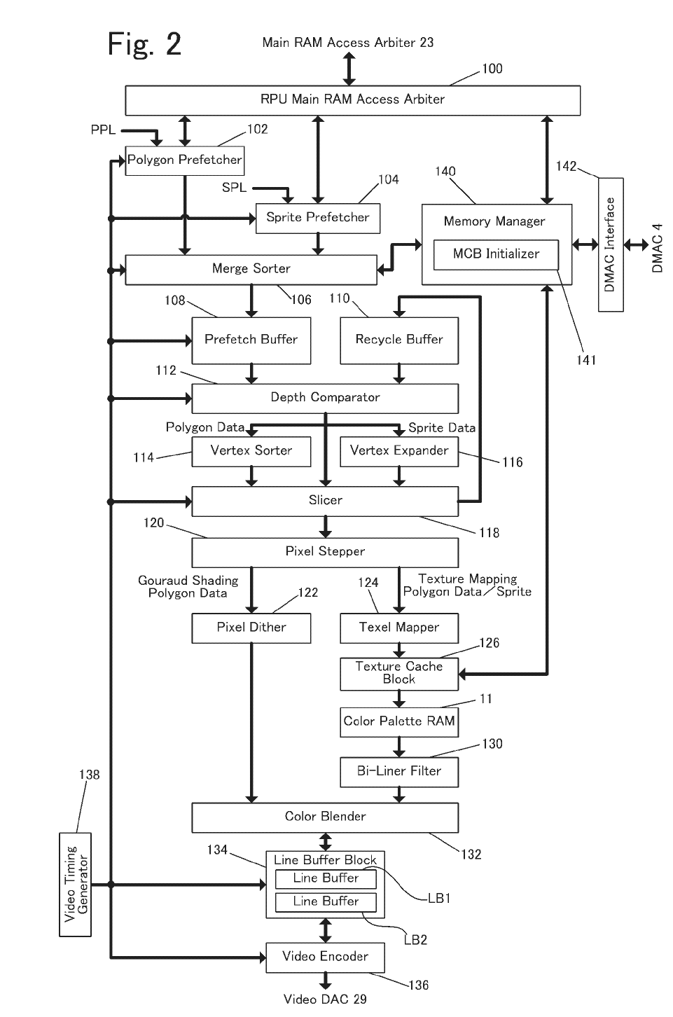

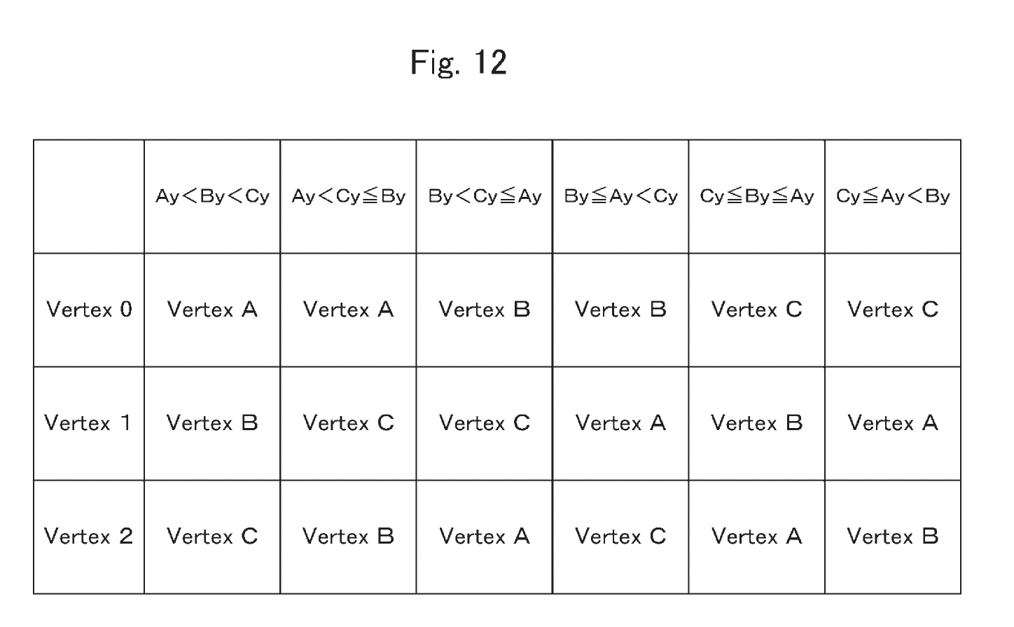

FIG. 2 is a block diagram showing the internal configuration of the RPU 9 of FIG. 1. As shown in FIG. 2, the RPU 9 includes an RPU main RAM access arbiter 100, a polygon prefetcher 102, a sprite prefetcher 104, a merge sorter 106, a prefetch buffer 108, a recycle buffer 110, a depth comparator 112, a vertex sorter 114, a vertex expander 116, a slicer 118, a pixel stepper 120, a pixel dither 122, a texel mapper 124, a texture cache block 126, a bi-liner filter 130, a color blender 132, a line buffer block 134, a video encoder 136, a video timing generator 138, a memory manager 140 and a DMAC interface 142. The line buffer block 134 includes line buffers LB1 and LB2 each of which corresponds to one horizontal line of the screen. The memory manager 140 includes a MCB initializer 141. Meanwhile, in FIG. 12, the color palette RAM 11 is illustrated in the RPU 9 for the sake of clarity in explanation.

The RPU main RAM access arbiter 100 arbitrates requests for accessing the main RAM 25 which are issued from the polygon prefetcher 102, the sprite prefetcher 104 and the memory manager 140, and grants permission for the access request to one of them. The access request as permitted is output to the main RAM access arbiter 23, and arbitrated with the access requests issued from the other function units of the multimedia processor 1.

The polygon prefetcher 102 fetches the respective polygon structure instances after sorting by the YSU 19 from the main RAM 25. A pulse PPL is input to the polygon prefetcher 102 from the YSU 19. The YSU 19 outputs the pulse PPL each time the sort operation of a polygon structure instance is fixed one after another. Accordingly, the polygon prefetcher 102 can be notified how many the polygon structure instances have been sorted among all the polygon structure instances of the polygon structure array.

Because of this, the polygon prefetcher 102 can acquire a polygon structure instance, each time the sort operation of a polygon structure instance is fixed one after another, without waiting for the completion of the sort operation of all the polygon structure instances. As a result, during displaying a frame, it is possible to perform the sort operation of the polygon structure instances for this frame. In addition to this, also in the case where a display operation is performed in accordance with interlaced scanning, it is possible to obtain a correct image as the result of drawing even if the sort operation for a field is performed during displaying this field. Meanwhile, the polygon prefetcher 102 can be notified when the frame or the field is switched on the basis of a vertical scanning count signal “VC” output from the video timing generator 138.

The sprite prefetcher 104 fetches the respective sprite structure instances from the main RAM 25 after sorting by the YSU 19. A pulse SPL is input to the sprite prefetcher 104 from the YSU 19. The YSU 19 outputs the pulse SPL each time the sort operation of a sprite structure instance is fixed one after another. Accordingly, the sprite prefetcher 104 can be notified how many the sprite structure instances have been sorted among all the sprite structure instances of the sprite structure array.

Because of this, the sprite prefetcher 104 can acquire a sprite structure instance, each time the sort operation of a sprite structure instance is fixed from one after another, without waiting for the completion of the sort operation of all the sprite structure instances. As a result, during displaying a frame, it is possible to perform the sort operation of the sprite structure instances for this frame. In addition to this, also in the case where a display operation is performed in accordance with interlaced scanning, it is possible to obtain a correct image as the result of drawing even if the sort operation for a field is performed during displaying this field. Meanwhile, the sprite prefetcher 104 can be notified when the frame or the field is switched on the basis of the vertical scanning count signal “VC” output from the video timing generator 138.

By the way, the polygon structure, the texture attribute structure and the sprite structure will be explained in advance of the merge sorter 106. In the present embodiment, it is assumed that a polygon is a triangle.

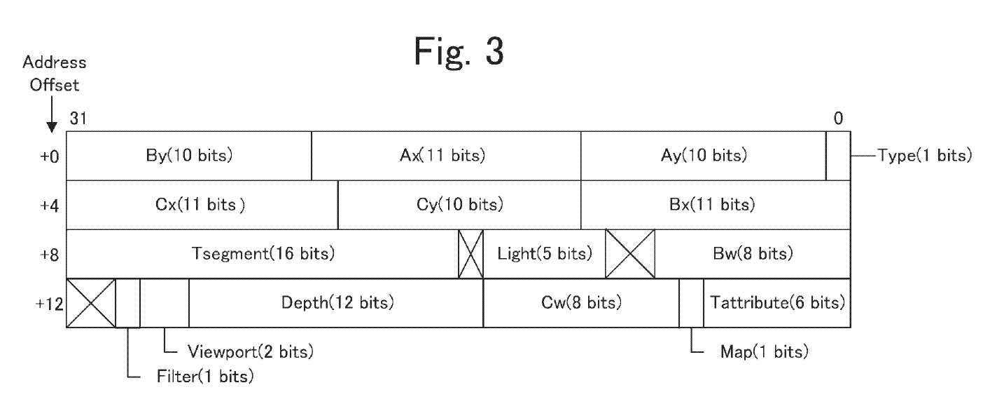

FIG. 3 is a view for showing the constitution of the polygon structure in the texture mapping mode. As shown in FIG. 3, in the case of the present embodiment, this polygon structure consists of 128 bits. The member “Type” of this polygon structure designates the drawing mode of the polygon and is set to “0” if the polygon is to be drawn in the texture mapping mode. The members “Ay”, “Ax”, “By”, “Bx”, “Cy” and “Cx” designate the Y-coordinate of a vertex “A”, the X-coordinate of the vertex “A”, the Y-coordinate of a vertex “B”, the X-coordinate of the vertex “B”, the Y-coordinate of a vertex “C”, and the X-coordinate of the vertex “C” respectively of the polygon. These Y-coordinates and X-coordinates are set in the screen coordinate system.

The members “Bw”, “Cw”, “Light” and “Tsegment” designate the perspective correction parameter of the vertex “B” (=Az/Bz), the perspective correction parameter of the vertex “C” (=Az/Cz), a brightness and the storage location information of texture pattern data respectively of the polygon.

The members “Tattribute”, “Map”, “Filter”, “Depth” and “Viewport” designate the index of the texture attribute structure, the format type of the texture pattern data, the filtering mode indicative of either a bi-liner filtering mode or a nearest neighbour, a depth value, and the information for designating the view port for scissoring respectively.

The bi-liner filtering and the nearest neighbour will be described below. The depth value (which may be referred to also as “display depth information”) is information indicative of which pixel is first drawn when pixels to be drawn overlap each other, and the drawing process is performed earlier (in a deeper position) as this value is larger while the drawing process is performed later (in a more front position) as this value is smaller. The scissoring is the function which does not display the polygon and/or the sprite which are/is located outside the viewport as designated, and cuts the part extending outside the viewport of the polygon and/or the sprite in order not to display the part.

These are the descriptions of the respective members of the polygon structure in the texture mapping mode, and one polygon structure instance is used to define one polygon.

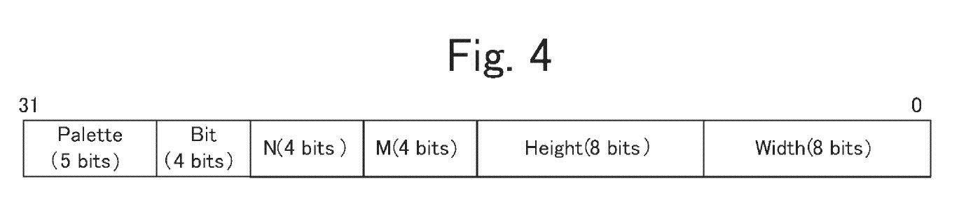

FIG. 4 is a view for showing the constitution of the texture attribute structure. As shown in FIG. 4, in the case of the present embodiment, this texture attribute structure consists of 32 bits. The members “Width”, “Height”, “M”, “N”, “Bit” and “Palette” of this texture attribute structure designate the width of the texture minus “1” (in units of texels), the height of the texture minus “1” (in units of texels), the number of mask bits applicable to the “Width” from the upper bit, the number of mask bits applicable to the “Height” from the upper bit, a color mode (the number of bits minus “1” per pixel), and a pallet block number. While the 512 entries of the color palette are divided into a plurality of blocks in accordance with the color mode as selected, the member “Palette” designates the pallet block to be used.

The instance of the texture attribute structure is not separately provided for each polygon to be drawn, but 64 texture attribute structure instances are shared by all the polygon structure instances in the texture mapping mode and all the sprite structure instances.

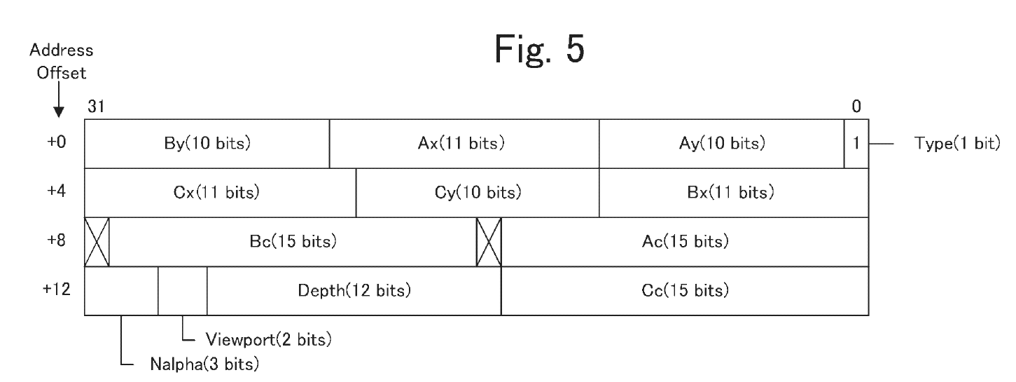

FIG. 5 is a view for showing the constitution of the polygon structure in the gouraud shading mode. As shown in FIG. 5, in the case of the present embodiment, the polygon structure consists of 128 bits. The member “Type” of the polygon structure designates the drawing mode of a polygon, and is set to “1” if the polygon is to be drawn in the gouraud shading mode. The members “Ay”, “Ax”, “By”, “Bx”, “Cy” and “Cx” designate the Y-coordinate of a vertex “A”, the X-coordinate of the vertex “A”, the Y-coordinate of a vertex “B”, the X-coordinate of the vertex “B”, the Y-coordinate of a vertex “C”, and the X-coordinate of the vertex “C” respectively of the polygon. These Y-coordinates and X-coordinates are set in the screen coordinate system.

The members “Ac”, “Bc” and “Cc” designate the color data of the vertex “A” (5 bits for each component of RGB), the color data of the vertex “B” (5 bits for each component of RGB), and the color data of the vertex “C” (5 bits for each component of RGB) respectively of the polygon.

The members “Depth”, “Viewport” and “Nalpha” designate a depth value, the information for designating the view port for scissoring, and (1-α) used in alpha blending. This factor (1-α) designates a degree of transparency in which “000” (in binary notation) designates a transparency of 0%, i.e., a perfect nontransparency, and “111” (in binary notation) designates a transparency of 87.5%.

These are the descriptions of the respective members of the polygon structure in the gouraud shading mode, and one polygon structure instance is used to define one polygon.

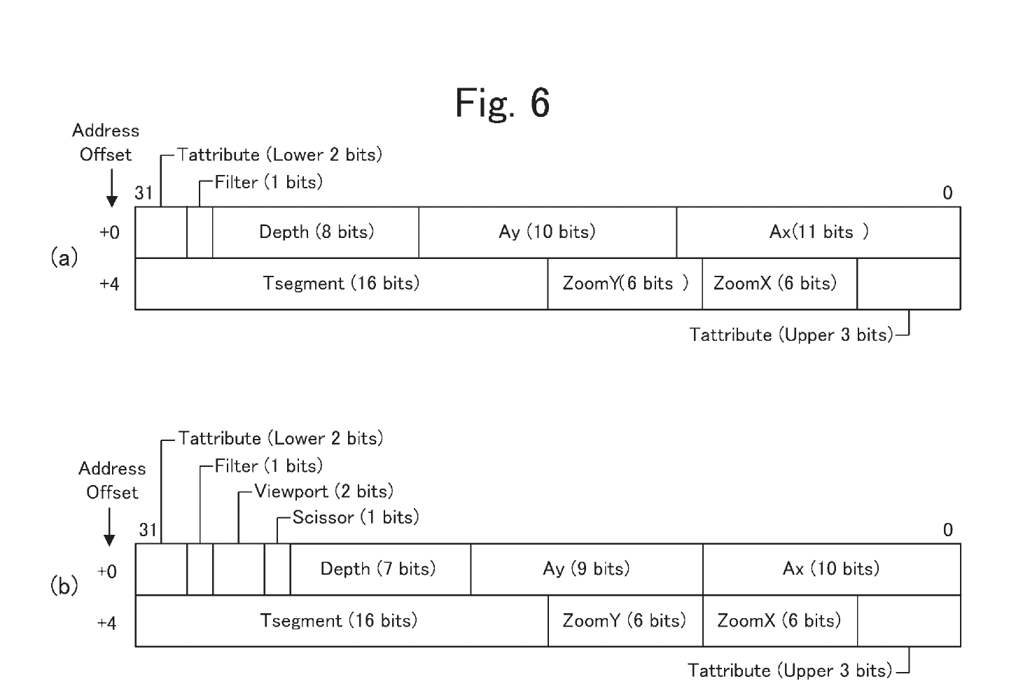

FIG. 6(a) is a view for showing the constitution of the sprite structure when scissoring is disabled; and FIG. 6(b) is a view for showing the constitution of the sprite structure when scissoring is enabled. As shown in FIG. 6(a), in the case of the present embodiment, the sprite structure when scissoring is disabled consists of 64 bits. The members “Ax” and “Ay” of this sprite structure designate the X coordinate and Y-coordinate of the upper left corner of the sprite respectively. These X coordinate and Y-coordinate are set in the screen coordinate system.

The members “Depth”, “Filter” and “Tattribute” designate a depth value, a filtering mode (the bi-liner filtering mode or the nearest neighbour), and the index of a texture attribute structure respectively. The members “ZoomX”, “ZoomY” and “Tsegment” designate a sprite enlargement ratio (enlargement/reduction ratio) in the X-axis direction, a sprite enlargement ratio (enlargement/reduction ratio) in the Y-axis direction and the storage location information of texture pattern data respectively.

As shown in FIG. 6(b), in the case of the present embodiment, the sprite structure array when scissoring is enabled consists of 64 bits. The members “Ax” and “Ay” of this sprite structure designate the X coordinate and Y-coordinate of the upper left corner of the sprite respectively. These X coordinate and Y-coordinate are set in the screen coordinate system.

The members “Depth”, “Scissor”, “Viewport”, “Filter” and “Tattribute” designate a depth value, a scissoring applicable flag, the information for designating the view port for scissoring, a filtering mode (the bi-liner filtering mode or the nearest neighbour), and the index of a texture attribute structure respectively. The members “ZoomX”, “ZoomY” and “Tsegment” designate a sprite enlargement ratio (enlargement/reduction ratio) in the X-axis direction, a sprite enlargement ratio (enlargement/reduction ratio) in the Y-axis direction and the storage location information of texture pattern data respectively. It is possible to control whether to apply the scissoring for each sprite by change the setting (ON/OFF) of the member “Scissor”.

In the case of the sprite structure when scissoring is enabled, the numbers of bits allocated to the X-coordinate and the Y-coordinate are respectively one bit less than those allocated when scissoring is disabled. When a sprite is arranged in the screen while scissoring is enabled, an offset of 512 pixels and an offset of 256 pixels are added respectively to the X-coordinate and the Y-coordinate by the vertex expander 116 to be described below. In addition to this, while the number of bits allocated to the depth value is also one bit less, one bit of “0” is added as the LSB of the depth value stored in the structure, when scissoring is enabled, by the texel mapper 124 to be described below so that the depth value is handled as an 8-bit value in the same manner as when scissoring is disabled.

These are the descriptions of the respective members of the sprite structure when scissoring is disabled and when scissoring is enabled, and one sprite structure instance is used to define one sprite. The constitution of the texture attribute structure of the sprite is the same as the configuration of the texture attribute structure of the polygon as shown in FIG. 4. The instance of the texture attribute structure is not separately provided for each sprite to be drawn, but 64 texture attribute structure instances are shared by all the polygon structure instances in the texture mapping mode and all the sprite structure instances.

Returning to FIG. 2, the merge sorter 106 receives polygon structure instances together with the associated texture attribute structures, and sprite structure instances together with the associated texture attribute structures respectively from the polygon prefetcher 102 and the sprite prefetcher 104, performs a merge sort operation in accordance with sort rules 1 to 4 to be described below (hereinafter, referred as “merge sort rules 1 to 4”) which are the same as used by the YSU 19 as described above, and outputs the result to the prefetch buffer 108. In this case, note that the respective polygon structure instances and the respective sprite structure instances has been already sorted in the order of the drawing processing based on the sort rules 1 to 4 by the YSU 19. In what follows, the merge sorter 106 will be described in detail.

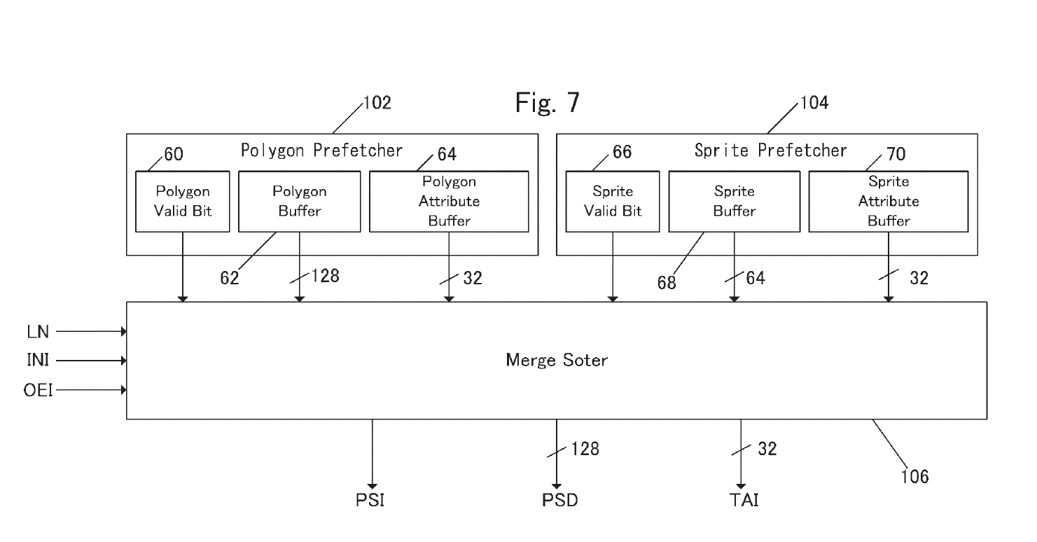

FIG. 7 is an explanatory view for showing an input/output signal relative to the merge sorter 106 of FIG. 2. Referring to FIG. 7, the polygon prefetcher 102 is composed of a polygon valid bit register 60, a polygon buffer 62, and a polygon attribute buffer 64. The sprite prefetcher 104 comprises a sprite valid bit register 66, a sprite buffer 68, and a sprite attribute buffer 70.

The polygon valid bit register 60 stores a polygon valid bit (one bit) which designates either validity (1) or invalidity (0) of the polygon structure instance. The polygon buffer 62 stores the polygon structure instance (128 bits) transmitted from the main RAM 25. The polygon attribute buffer 64 stores the texture attribute structure instance (32 bits) to be used for a polygon, which is transmitted from the main RAM 25.

The sprite valid bit register 66 stores a sprite valid bit (one bit) which designates either validity (1) or invalidity (0) of the sprite structure instance. The sprite buffer 68 stores the sprite structure instance (64 bits) transmitted from the main RAM 25. The sprite attribute buffer 70 stores the texture attribute structure instance (32 bits) to be used for the sprite, which is transmitted from the main RAM 25.

An input/output signal relative to the merge sorter 106 will be described. A display-area-upper-end-line-number signal “LN”, which is outputted from the video timing generator 138, indicates the number of a horizontal line where the RPU 9 starts to draw the polygon and/or the sprite (i.e., the number of a top line of a screen). The value LN is set to a display-area-upper-end-line-control register (not shown in the figure) provided in the RPU 9 by means of the CPU 5.

An interlace/non-interlace identifying signal “INI”, which is outputted from the video timing generator 138, indicates whether the currently drawing processing of the RPU 9 is for the interlaced scanning or for the non-interlaced scanning. The value INI is set to one bit of an RPU control register (not shown in the figure) provided in the RPU 9 by means of the CPU 5.

An odd field/even field identifying signal “OEI”, which is outputted from the video timing generator 138, indicates whether the field under the currently drawing processing is the odd field or the even field.

The merge sorter 106 outputs polygon/sprite data PSD, a texture attribute structure instance TAI, and a polygon/sprite identifying signal “PSI” to the prefetch buffer 108.

The polygon/sprite data PSD (128 bits) is either the polygon structure instance or the sprite structure instance. In the case where the polygon/sprite data PSD is the sprite structure instance, the effective data is aligned to the LSB so that the upper 64 bits are filled with “0”. Also, in the comparison process of the depth values to be described below, since the number of bits differs between the depth value (12 bits) of the polygon structure instance and the depth value (8 bits) of the sprite structure instance, bits “0” are added to the LSB side of the depth value of the sprite structure instance, and thereby the number of bits thereof is equalized with the number of bits (12 bits) of the depth value of the polygon structure instance. However, the depth value which is equalized with 12 bits is not outputted to the subsequent stage.

In the case where the polygon/sprite data PSD is a polygon structure instance, the texture attribute structure instance TAI (32 bits) is a texture attribute structure instance accompanying the polygon structure instance. In the case where the polygon/sprite data PSD is a sprite structure instance, the texture attribute structure instance TAI (32 bits) is a texture attribute structure instance accompanying the sprite structure instance. However, in the case that the polygon/sprite data PSD is a polygon structure instance to be used in the gouraud shading mode, since the texture attribute structure instance is accompanied, the whole bits of the signal “TAI” indicate “0”.

The polygon/sprite identifying signal “PSI” indicates whether the polygon/sprite data PSD is the polygon structure instance or the sprite structure instance.

The operation of the merge sorter 106 will be described. First, the merge sorter 106 checks the polygon valid bit written to the polygon valid bit register 60 and the sprite valid bit written to the sprite valid bit register 66. Then, the merge sorter 106 does not acquire data from the buffers 62 and 64 of the polygon prefetcher 102 and the buffers 68 and 70 of the sprite prefetcher 104 in the case that both values of the polygon valid bit and the sprite valid bit indicate “0 (invalid)”.

In the case that any one of the polygon valid bit and the sprite valid bit indicates “1 (valid)”, the merge sorter 106 acquires data from the ones indicating “1” between the buffers 62 and 64 and buffers 68 and 70, and then outputs the data as the polygon/sprite data PSD and the texture attribute structure instance TAI to the prefetch buffer 108.

In the case that both the values of the polygon valid bit and the sprite valid bit indicate “1 (valid)”, the merge sorter 106 acquires data from either the buffers 62 and 64 of the polygon prefetcher 102 or the buffers 68 and 70 of the sprite prefetcher 104 in accordance with the merge sort rules 1 to 4 to be described next, and then outputs the data as the polygon/sprite data PSD and the texture attribute structure instance TAI to the prefetch buffer 108. The detail of the merge sort rules 1 to 4 is as follows.

First, the case where the interlace/non-interlace identifying signal “INI” supplied from the video timing generator 138 indicates the non-interlace scanning will be described. The merge sorter 106 compares the minimum value among Y-coordinates (Ay, By, and Cy) of the three vertices included in the polygon structure instance to Y-coordinate (Ay) included in the sprite structure instance, and then selects the one (i.e., the one having a smaller Y-coordinate) which appears earlier in the order of the drawing processing between the polygon structure instance and the sprite structure instance (the merge sort rule 1, which corresponds to the sort rule 1 by the YSU 19). The Y-coordinate is a value in the screen coordinate system.

However, in the case that both the values of the Y-coordinates are same as each other, the merge sorter 106 compares the depth value “Depth” included in the polygon structure instance to the depth value “Depth” included in the sprite structure instance, and then selects the one (i.e., the one drawn in a deeper position) having a larger depth value between the polygon structure instance and the sprite structure instance (the merge sort rule 2, which corresponds to the sort rule 2 by the YSU 19). In this case, as described above, the comparison is performed after equalizing the number of bits (8 bits) of the depth value included in the sprite structure instance with the number of bits (12 bits) of the depth value included in the polygon structure instance.

In addition, in the case that the value of the Y-coordinate is smaller than the Y-coordinate corresponding to the display-area-upper-end-line-number signal “LN”, the merge sorter 106 substitutes the value of the Y-coordinate corresponding to the display-area-upper-end-line-number signal “LN” for the value of the Y-coordinate (the merge sort rule 3, which corresponds to the sort rule 3 by the YSU 19), and then performs the merge sort in accordance with the merge sort rules 1 and 2.

Next, the case where the interlace/non-interlace identifying signal “INI” indicates the interlace scanning will be described. The merge sorter 106 determines a field to be displayed on the basis of the odd field/even field identifying signal “OEI”, handles the value of the Y-coordinate corresponding to the horizontal line which is not drawn in the field as the same value as the Y-coordinate corresponding to the next horizontal line (the merge sort rule 4, which corresponds to the sort rule 4 by the YSU 19), and performs the merge sort in accordance with the above merge sort rules 1 to 3.

Returning to FIG. 2, the prefetch buffer 108 is a buffer of an FIFO (first-in-first-out) structure used to store the merge-sorted structure instances (i.e., the polygon/sprite data pieces PSD and the texture attribute structure instances TAI), which are successively read from the merge sorter 106 and successively outputted in the same order as they are read. In other words, the structure instances are stored in the prefetch buffer 108 in the same order as sorted by the merge sorter 106. Then, the structure instances as stored are output in the same order as they are stored in the drawing cycle for displaying the corresponding polygons or sprites. Meanwhile, the prefetch buffer 108 can be notified of the horizontal line which is being drawn on the basis of the vertical scanning count signal “VC” output from the video timing generator 138. In other words, it can know when the drawing cycle is switched. In the case of the present embodiment, for example, the prefetch buffer 108 can share the same physical buffer with the recycle buffer 110, such that the physical buffer can store (128 bits+32 bits)*128 entries inclusive of the entries of the recycle buffer 110. Incidentally, the polygon/sprite identifying signal “PSI” is replaced with the blank bit which is the seventy-ninth bit of the polygon/sprite data PSD.

The recycle buffer 110 is a buffer of an FIFO structure for storing structure instances (i.e., the polygon/sprite data pieces PSD and the texture attribute structure instances TAI) which can be used again in the next drawing cycle (i.e., can be reused). Accordingly, the structure instances stored in the recycle buffer 110 are used also in the next drawing cycle. One drawing cycle corresponds to the drawing period for displaying one horizontal line. In other words, the one drawing cycle corresponds to the period for drawing, on either the line buffer LB1 or LB2, all the data required for displaying one horizontal line corresponding to the line buffer. In the case of the present embodiment, for example, the recycle buffer 110 can share the same physical buffer with the prefetch buffer 108, such that the physical buffer can store (128 bits+32 bits)*128 entries inclusive of the entries of the prefetch buffer 108.

The depth comparator 112 compares the depth value included in the structure instance which is the first entry of the prefetch buffer 108 and the depth value included in the structure instance which is the first entry of the recycle buffer 110, selects the structure instance having a larger depth value (that is, to be displayed in a deeper position), and outputs it to the subsequent stage. In this case, if the structure instance as selected is a polygon structure instance, the depth comparator 112 outputs it to the vertex sorter 114, and if the structure instance as selected is a sprite structure instance, the depth comparator 112 outputs it to the vertex expander 116. Also, the depth comparator 112 outputs the structure instance as selected to the slicer 118. Meanwhile, the depth comparator 112 can be notified of the horizontal line which is being drawn on the basis of the vertical scanning count signal “VC” output from the video timing generator 138. In other words, it can know when the drawing cycle is switched.

Incidentally, in the case where a structure instance selected by the depth comparator 112 can be used again in the next drawing cycle (i.e., it can be used to draw the next horizontal line), the structure instance is outputted and written to the recycle buffer 110 by the slicer 118. However, in the case where a structure instance selected by the depth comparator 112 is not used in the next drawing cycle (i.e., it is not used to draw the next horizontal line), it is not written to the recycle buffer 110.

Accordingly, the structure instances to be used to draw the current line and the structure instances to be used to draw the next line stores in drawing order of the current line and in drawing order of the next line in the recycle buffer 110.

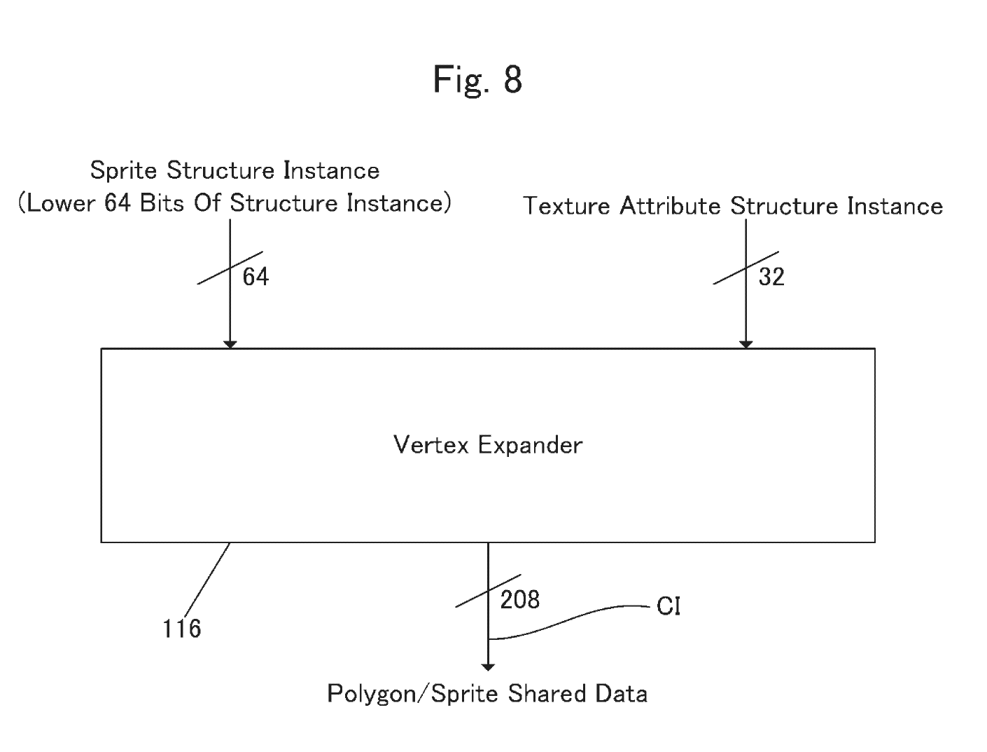

FIG. 8 is an explanatory view for showing an input/output signal relative to the vertex expander 116 of FIG. 2. While size of the polygon/sprite data PSD included in the structure instance outputted from the depth comparator 112 is 128 bits, since the polygon/sprite data PSD inputted to the vertex expander 116 is a sprite structure instance, only lower 64 bits of the 128-bit polygon/sprite data PSD are inputted thereto. Referring to FIG. 8, the vertex expander 116 calculates coordinates of vertices of a sprite (XY coordinates in the screen coordinate system and UV coordinates in the UV coordinate system) on the basis of coordinates (Ax, Ay) of the upper-left vertex of the sprite, the sprite enlargement ratio “ZoomY” in the Y-axis direction, and the sprite enlargement ratio “ZoomX” in the X-axis direction, which are included in the received sprite structure instance, and the value “Width” which indicates the width of the texture pattern minus “1” and the value “Height” which indicates the height of the texture pattern minus “1”, which are included in the texture attribute structure instance accompanying this sprite structure instance, and then outputs them as polygon/sprite shared data Cl to the slicer 118. The screen coordinate system is as described above. The UV coordinate system is a two-dimensional orthogonal coordinate system in which the texture pattern data is arranged. In what follows, a process for calculating parameters (XYUV coordinates) of vertices of a sprite will be described.

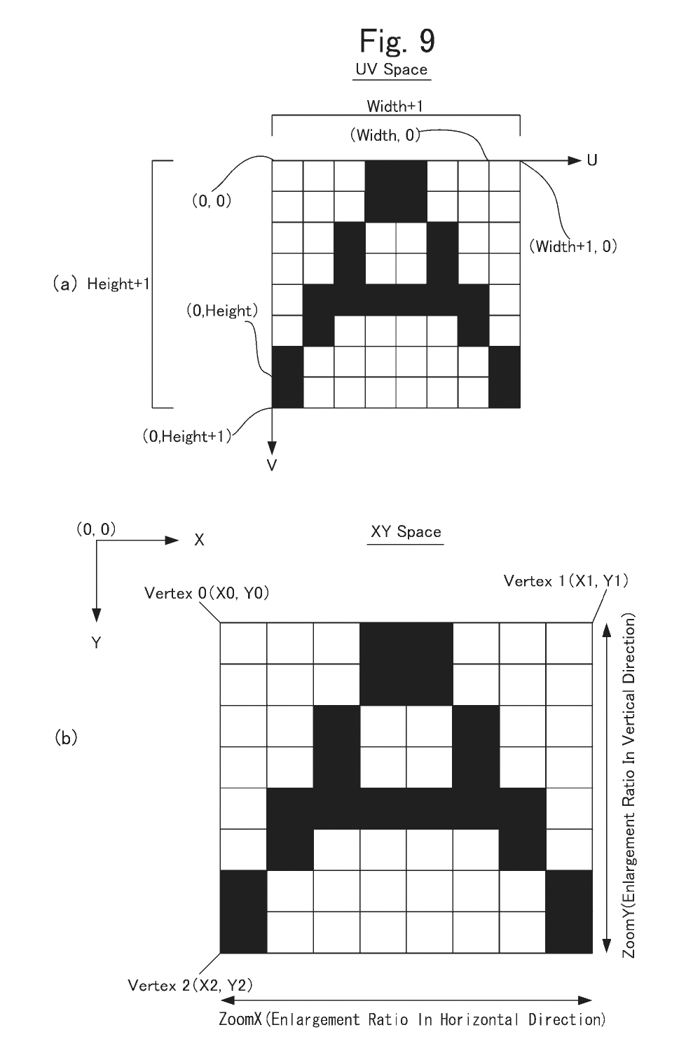

FIG. 9 is an explanatory view for showing the calculating process of vertex parameters of a sprite. An example of the texture pattern data (the letter “A”) of the sprite in the UV space is shown in FIG. 9(a). In this figure, one small rectangle indicates on texel. Also, the UV coordinates of the upper-left corner among the four vertices of the texel represents the position of the texel.

As shown in this figure, if a width (the number of texels in horizontal direction) and a height of the texture are “Width+1” and “Height+1” respectively, the texture pattern data of the sprite is arranged in the UV space in order that UV coordinates of the upper-left vertex, the upper-right vertex and the lower-left vertex of the texture are set to (0, 0), (Width+1, 0), and (0, Height+1) respectively. Incidentally, the values of “Width” and “Height” are values to be stored in the members “Width” and “Height” of the texture attribute structure. Namely, the width of the texture minus “1” and the height of the texture minus “1” are stored in these members.

An example of drawing of a sprite in the XY space is shown in FIG. 9(b). In this figure, one small rectangle consists of an aggregation of pixels and corresponds to one texel of FIG. 9(a). The upper-left vertex, the upper-right vertex and the lower-left vertex of the sprite are handled as a vertex 0, a vertex 1 and a vertex 2 respectively. Namely, respective vertices are handled as the vertex 0, the vertex 1 and the vertex 2 in appearance order when drawing from the earlier one. X$, Y$, UB$ and VR$ (“$” is a suffix attached to a vertex, where $=0, 1 and 2) stand for X-coordinates, Y-coordinates, U-coordinates and V-coordinates of respective vertices 0 to 2, and then the respective values can be obtained as follows.

The vertex 0 is as follows.

X0=Ax

Y0=Ay

UB0=0

VR0=0

Incidentally, “Ax” and “Ay” are values stored in the members “Ax” and “Ay” of the sprite structure instance. In this way, the values of the members “Ax” and “Ay” of the sprite structure instance are X-coordinate and Y-coordinate of the vertex 0 of the sprite.

The vertex 1 is as follows.

X1=Ax+ZoomX*(Width+1)

Y1=Ay

UB1=Width

VR1=0

The vertex 2 is as follows.

X2=Ax

Y2=Ay+ZoomY*(Height+1)

UB2=0

VR2=Height

Incidentally, the XYUV coordinates of the lower-right vertex 3 of the sprite is not calculated here because it can be obtained based on the XYUV coordinates of the other three vertices.

In this case, while the width “Width” and the height “Height” are 8-bit respectively, since each parameter such as UB$ and VR$ ($=0, 1 and 2) is a 16-bit fixed point number which consists of a 10-bit unsigned integer part and a 6-bit fraction, the vertex expander 116 adds 6-bit “0” to the LSB side and 1-bit or 2-bit “0” to MSB side of the result of the operation, and thereby 16-bit fixed point numbers UB$ and VR$ are generated.

The vertex expander 116 outputs the result of the operation, i.e., XYUV coordinates of each vertex 0 to 2 as polygon/sprite shared data Cl to the slicer 118. However, fields WG$ ($=0, 1 and 2) of the polygon/sprite shared data Cl to be described below are always outputted as “0x0040” (=1.0). As described below, the structure (format) of the polygon/sprite shared data Cl outputted by the vertex expander 116 is the same as the structure (format) of the polygon/sprite shared data Cl outputted by the vertex sorter 114.

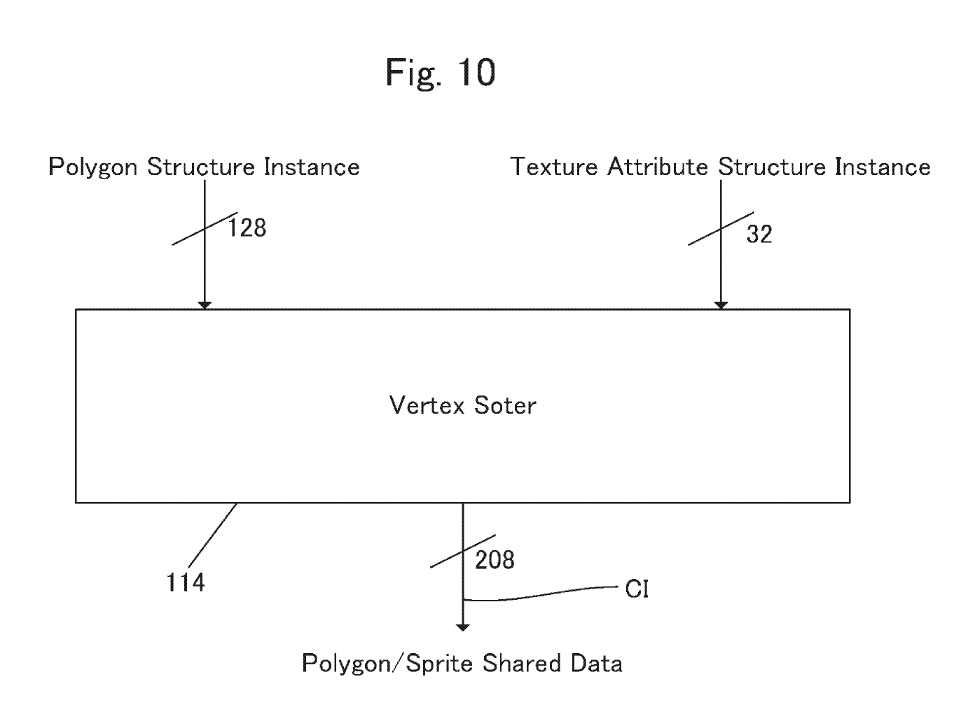

FIG. 10 is an explanatory view for showing an input/output signal relative to the vertex sorter 114 of FIG. 2. Referring to FIG. 10, the vertex sorter 114 acquires and calculates the parameters (XYUV coordinates, perspective correction parameters, and color data) of the respective vertices of the polygon from the received polygon structure instance together with the texture attribute structure associated thereto, rearranges the parameters of the respective vertices in ascending order of the Y-coordinate, and then outputs them as the polygon/sprite shared data Cl to the slicer 118. In what follows, a process for calculating parameters of vertices of a polygon will be described. First, the case where a polygon is an object of the texture mapping process will be described.

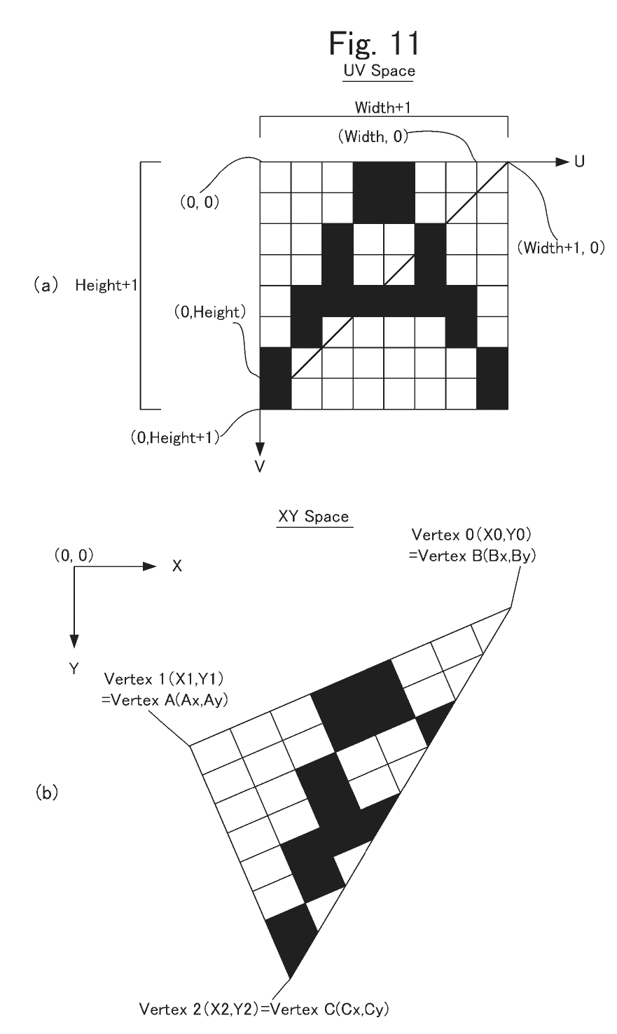

FIG. 11 is an explanatory view for showing the calculating process of vertex parameters of a polygon. An example of the texture pattern data (the letter “A”) of the polygon in the UV space is shown in FIG. 11(a). In this figure, one small rectangle indicates on texel. Also, the UV coordinates of the upper-left corner among the four vertices of the texel represents the position of the texel.

The present embodiment cites a case where a polygon is triangular. With regard to the texture (in this case, it is a quadrangle) to be mapped to the polygon, one vertex is arranged on (0, 0) of the UV coordinates, and the other two vertices are arranged on the U axis and the V axis respectively. Accordingly, if a width (the number of texels in horizontal direction) and a height of a texture are “Width+1” and “Height+1” respectively, the texture pattern data of the polygon is arranged in the UV space in order that UV coordinates of the upper-left vertex, the upper-right vertex and the lower-left vertex of the texture are set to (0, 0), (Width+1, 0), and (0, Height+1) respectively.

Incidentally, the values of “Width” and “Height” are values to be stored in the members “Width” and “Height” of the texture attribute structure. Namely, the width of the texture minus “1” and the height of the texture minus “1” are stored in these members. Incidentally, when the texture data is stored in the memory MEM, a part thereof may be stored so as to be folded back. But the explanation thereof is omitted here.

An example of drawing of a polygon in the XY space is shown in FIG. 11(b). In this figure, one small rectangle consists of an aggregation of pixels and corresponds to one texel of FIG. 11(a). In the same manner, one small triangle consists of an aggregation of pixels and corresponds to one texel of FIG. 11(a).

XY coordinates of three vertices A, B and C of the polygon are represented by (Ax, Ay), (Bx, By) and (Cx, Cy) respectively. The “Ax”, “Ay”, “Bx”, “By”, “Cx” and “Cy” are values stored in the members “Ax”, “Ay”, “Bx”, “By”, “Cx” and “Cy” of the polygon structure instance respectively. In this way, the values of the members “Ax” and “Ay”, the values of the members “Bx” and “By”, and the values of the members “Cx” and “Cy” of the polygon structure instance are X-coordinate and Y-coordinate of the vertex A, X-coordinate and Y-coordinate of the vertex B, and X-coordinate and Y-coordinate of the vertex C of the polygon respectively.

Then, the vertex A of the polygon is associated with UV coordinates (0, 0) of FIG. 11(a), the vertex B is associated with UV coordinates (Width, 0), and the vertex C is associated with UV coordinates (0, Height). Therefore, the vertex sorter 114 calculates the UV coordinates (Au, Av), (Bu, By) and (Cu, Cv) of the vertices A, B and C in the same manner as the sprite.

The vertex A is as follows.

Au=0

Av=0

The vertex B is as follows.

Bu=Width

Bv=0

The vertex C is as follows.

Cu=0

Cv=Height

Then, the vertex sorter 114 applies a perspective correction to the UV coordinates (Au, Av), (Bu, Bv) and (Cu, Cv) of the vertex A, B and C. UV coordinates of the vertices A, B and C after applying the perspective correction thereto are (Au*Aw, Av*Aw), (Bu*Bw, Bv*Bw) and (Cu*Cw, Cv*Cw).

In this case, the “Width” and “Height” are values stored in the members Width and Height of the texture attribute structure instance respectively. Also, the “Bw” and “Cw” are values stored in the members “Bw” and “Cw” of the polygon structure instance respectively. As described below, since the perspective correction parameter “Aw” of the vertex A is constantly “1”, “Aw” is not stored in the polygon structure instance.

Next, the vertex sorter 114 sorts (rearranges) the parameters (XY coordinates, UV coordinates after applying the perspective correction, and the perspective correction parameters) of the three vertices A, B and C in ascending order of the Y-coordinates. The vertices after sorting are handled as the vertices 0, 1 and 2 in ascending order of the Y-coordinates. In the example of FIG. 11(b), the vertex A is the vertex 1, the vertex B is the vertex 0, and the vertex C is the vertex 2. The sorting operation of the vertex sorter 114 will be described in detail.

FIG. 12 is an explanatory view for showing the sort process of vertices of a polygon. In FIG. 12, relation between vertices before sorting and vertices after sorting is indicated. The “A”, “B” and “C” are vertex names assigned to vertices before sorting, and the “0”, “1” and “2” are vertex names assigned to vertices after sorting. Also, the “Ay”, “By” and “Cy” are respectively values stored in the members “Ay”, “By” and “Cy” of the polygon structure instance, and are respectively Y-coordinates of the vertices A, B and C of the polygon before sorting.

The relation among the Y-coordinate Y0 of the vertex 0, the Y-coordinate Y1 of the vertex 1 and the Y-coordinate Y2 of the vertex 2 is Y0≦Y1≦Y2, and is fixed. Then, each of the vertices A, B and C is assigned to one of the vertices 0, 1 and 2 in accordance with relation of magnitude among Y-coordinates Ay, By and Cy of the vertices A, B and C before sorting. For example, in the case where relation of the Y-coordinates among the vertices is By≦Ay≦Cy, the vertex sorter 114 assigns each parameter of the vertex B to the each parameter of the vertex 0, assigns each parameter of the vertex A to the each parameter of the vertex 1, and assigns each parameter of the vertex C to the each parameter of the vertex 2.

This example will be described referring to FIG. 11. In this case, X$, Y$, UB$, VR$ and WG$ (“$” is a suffix attached to a vertex, where $=0, 1 and 2) stand for X-coordinates, Y-coordinates, U-coordinates and V-coordinates of respective vertices 0 to 2, and then the respective values can be obtained as follows.

The vertex 0 is as follows.

X0=Bx

Y0=By

UB0=Bu*Bw

VR0=Bv*Bw

WG0=Bw

The vertex 1 is as follows.

X1=Ax

Y1=Ay

UB1=Au*Aw

VR1=Av*Aw

WG1=Aw

The vertex 2 is as follows.

X2=Cx

Y2=Cy

UB2=Cu*Cw

VR2=Cv*Cw

WG2=Cw

In this case, while the respective values of “Aw”, “Bw” and “Cw” are the 8-bit fixed point numbers each of which consists of a 2-bit unsigned integer part and a 6-bit fraction, since each parameter such as UB$, VR$ and WG$($=0, 1 and 2) is a 16-bit fixed point number which consists of a 10-bit unsigned integer part and a 6-bit fraction, 8 bits “0” are added to the MSB side of each value of “Aw”, “Bw” and “Cw”. Also, since each value of “Au”, “Bu”, “Cu”, “Av”, “Bv” and “Cv” consists of a 8-bit unsigned integer part and a 0-bit fraction, results of multiplications of these values and values of “Aw”, “Bw” and “Cw” each of which consists of a 2-bit unsigned integer part and a 6-bit fraction are 16-bit fixed point numbers each of which consists of a 10-bit unsigned integer part and a 6-bit fraction, and thus a blank bit is not generated.

The vertex sorter 114 outputs results of operations, i.e., the parameters (XY coordinates, UV coordinates after applying the perspective correction, and the perspective correction parameters) of the respective vertices as the polygon/sprite shared data Cl to the slicer 118. As described below, the structure (format) of the polygon/sprite shared data Cl outputted by the vertex sorter 114 is the same as the structure (format) of the polygon/sprite shared data Cl outputted by the vertex expander 116.

Next, the case where a polygon is an object of the gouraud shading will be described. The XY coordinates of three vertices A, B and C of the polygon are represented by (Ax, Ay), (Bx, By) and (Cx, Cy) respectively. The “Ax”, “Ay”, “Bx”, “By”, “Cx” and “Cy” are values stored in the members “Ax”, “Ay”, “Bx”, “By”, “Cx” and “Cy” of the polygon structure instance respectively. In this way, the values of the members “Ax” and “Ay”, the values of the members “Bx” and “By”, and the values of the members “Cx” and “Cy” of the polygon structure instance are X-coordinate and Y-coordinate of the vertex A, X-coordinate and Y-coordinate of the vertex B, and X-coordinate and Y-coordinate of the vertex C of the polygon respectively.

Also, the color data of three vertices A, B and C of the polygon are represented by (Ar, Ag, Ab), (Br, Bg, Bb) and (Cr, Cg, Cb) respectively. The (Ar, Ag, Ab), (Br, Bg, Bb) and (Cr, Cg, Cb) are values stored in the members “Ac”, “Bc” and “Cc” of the polygon structure instance respectively.

Specifics are Ab=Ac [14:10] (a blue component), Ag=Ac [9:5] (a green component), Ar=Ac [4:0] (a red component), Bb=Bc [14:10] (a blue component), Bg=Bc [9:5] (a green component), Br=Bc [4:0] (a red component), Cb=Cc [14:10] (a blue component), Cg=Cc [9:5] (a green component), and Cr=Cc [4:0] (a red component).

In this case, the value of member “Ac”, the value of member “Bc”, and the value of member “Cc” of the polygon structure instance are the color data of the vertex A, the color data of the vertex B, and the color data of the vertex C of the polygon respectively.

The vertex sorter 114 sorts (rearranges) the parameters (XY coordinates and color data) of the vertices A, B and C in ascending order of the Y-coordinates in accordance with the table of FIG. 12. The vertices after sorting are handled as the vertices 0, 1 and 2 in ascending order of the Y-coordinates. This point is same as the texture mapping mode. The example in which relation among Y-coordinates of the vertices is By≦Ay<Cy will be described below.

X$, Y$, UB$, VR$ and WG$ (“$” is a suffix attached to a vertex, where $=0, 1 and 2) stand for X-coordinates, Y-coordinates, B-values (blue components), R-values (red components) and G-values (green components) of respective vertices 0 to 2, and then the respective values can be obtained as follows.

The vertex 0 is as follows.

X0=Bx

Y0=By

UB0=Bb

VR0=Br

WG0=Bg

The vertex 1 is as follows.

X1=Ax

Y1=Ay

UB1=Ab

VR1=Ar

WG1=Ag

The vertex 2 is as follows.

X2=Cx

Y2=Cy

UB2=Cb

VR2=Cr

WG2=Cg

In this case, since each parameter such as UB$, VR$ and WG$($=0, 1 and 2) is a 16-bit value, 6-bit “0” is added to the LSB side of each color component and 5-bit “0” are added to the MSB side of each color component.

The vertex sorter 114 outputs results of operations, i.e., the parameters (XY coordinates and the color data) of the respective vertices 0 to 2 as the polygon/sprite shared data Cl to the slicer 118. As described next, the structure (format) of the polygon/sprite shared data Cl outputted by the vertex sorter 114 is the same as the structure (format) of the polygon/sprite shared data Cl outputted by the vertex expander 116.

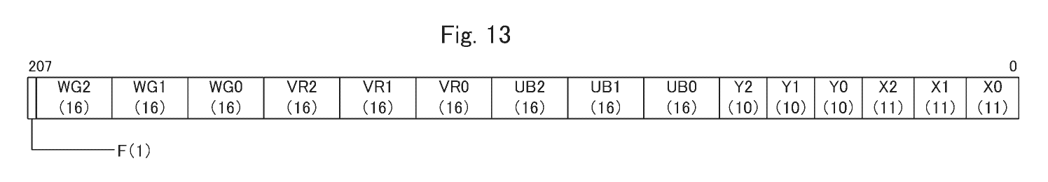

FIG. 13 is a view for showing the configuration of polygon/sprite shared data Cl. Referring to FIG. 13, the polygon/sprite shared data Cl consists of a field “F” (1 bit), “WG$” (16 bits respectively), “VR$” (16 bits respectively), “UB$” (16 bits respectively), “Y$” (10 bits respectively) and “X$” (11 bits respectively) (208 bits in total). $=0, 1, 2, and the respective vertices are distinguished thereby.

The field “F” is a flag field indicating which of a polygon or a sprite is associated with the polygon/sprite shared data Cl. Accordingly, the vertex sorter 114 stores “1” in the field “F” to indicate a polygon. On the other hand, the vertex expander 116 stores “0” in the field “F” to indicate a sprite.

In the case of the polygon/sprite shared data Cl output from the vertex expander 116, the fields VR$, UB$, Y$ and X$ are the V-coordinate, U-coordinate, Y-coordinate and X-coordinate of the vertex $ respectively. In this case, “0x0040” (=1.0) is stored in the field WG$. As described above, the vertices $ are referred to as a vertex 0, a vertex 1 and a vertex 2 from the earliest one in the appearance order.

In the case of the polygon/sprite shared data Cl which is output from the vertex sorter 114 and used in the texture mapping, the fields WG$, VR$, UB$, Y$ and X$ are the perspective correction parameter, V-coordinate as perspective corrected, U-coordinate as perspective corrected, Y-coordinate and X-coordinate of the vertex $ respectively.

In the case of the polygon/sprite shared data Cl which is output from the vertex sorter 114 and used in the gouraud shading, the fields WG$, VR$, UB$, Y$ and X$ are the green component, red component, blue component, Y-coordinate and X-coordinate of the vertex $ respectively.

The slicer 118 of FIG. 12 will be described below. First, the process of a polygon by the slicer 118 in the gouraud shading mode will be described.

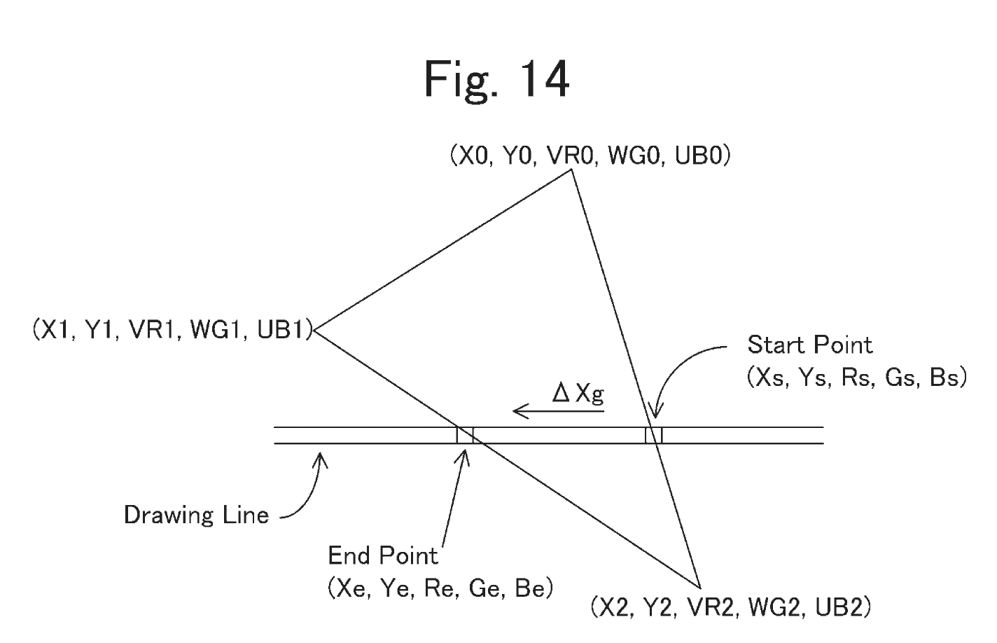

FIG. 14 is an explanatory view for showing the process of a polygon by the slicer 118 of FIG. 2 in the gouraud shading mode. Referring to FIG. 14, the slicer 118 obtains the XY coordinates (Xs, Ys) and (Xe, Ye) of the intersection points between the polygon (triangle) defined by the polygon/sprite shared data Cl as given and the horizontal line to be drawn. When a polygon is processed as discussed here, the intersection point near the side which is not intersected by the horizontal line to be drawn is determined as the end point (Xe, Ye), and the intersection point located remote from this side is determined as the start point (Xs, Ys).

Then, in the range in which the drawing Y-coordinate “Yr” satisfies Y0≦Yr<Y1, the slicer 118 calculates the RGB values (Rs, Gs, Bs) of the intersecting start point by linear interpolation on the basis of the RGB values (VR0, WG0, UB0) of the vertex 0 and the RGB values (VR2, WG2, UB2) of the vertex 2 and calculates the RGB values (Re, Ge, Be) of the intersecting end point by linear interpolation on the basis of the RGB values (VR0, WG0, UB0) of the vertex 0 and the RGB values (VR1, WG1, UB1) of the vertex 1. Also, in the range in which the drawing Y-coordinate “Yr” satisfies Y1≦Yr≦Y2, the slicer 118 calculates the RGB values (Rs, Gs, Bs) of the intersecting start point by linear interpolation on the basis of the RGB values (VR0, WG0, UB0) of the vertex 0 and the RGB values (VR2, WG2, UB2) of the vertex 2 and calculates the RGB values (Re, Ge, Be) of the intersecting end point by linear interpolation on the basis of the RGB values (VR2, WG2, UB2) of the vertex 2 and the RGB values (VR1, WG1, UB1) of the vertex 1.

Then, the slicer 118 calculates ΔR, ΔG, ΔB and ΔXg. In this case, ΔR, ΔG and ΔB are the changes respectively in R, G and B per ΔXg on the horizontal line to be drawn, and ΔXg is the change in the X-coordinate per pixel on the horizontal line to be drawn. ΔXg takes either “+1” or “−1”.

ΔR=(Re−Rs)/(Xe−Xs)

ΔG=(Ge−Gs)/(Xe−Xs)

ΔB=(Be−Bs)/(Xe−Xs)

ΔXg=(Xe−Xs)/|Xe−Xs|

The slicer 118 transmits Xs, Rs, Gs, Bs, Xe, ΔR, ΔG, ΔB and ΔXg as calculated to the pixel stepper 120 together with the structure instance as received from the depth comparator 112. Also, in the case where the polygon/sprite shared data Cl as received from the vertex sorter 114 can be used in the next drawing cycle, the slicer 118 writes the structure instance as received from the depth comparator 112 to the recycle buffer 110. Meanwhile, on the basis of the vertical scanning count signal “VC” from the video timing generator 138 and the vertex coordinates of the polygon, it is possible to know whether or not the polygon/sprite shared data Cl can be used in the next drawing cycle.

Next, the process of a polygon by the slicer 118 in the texture mapping mode will be described.

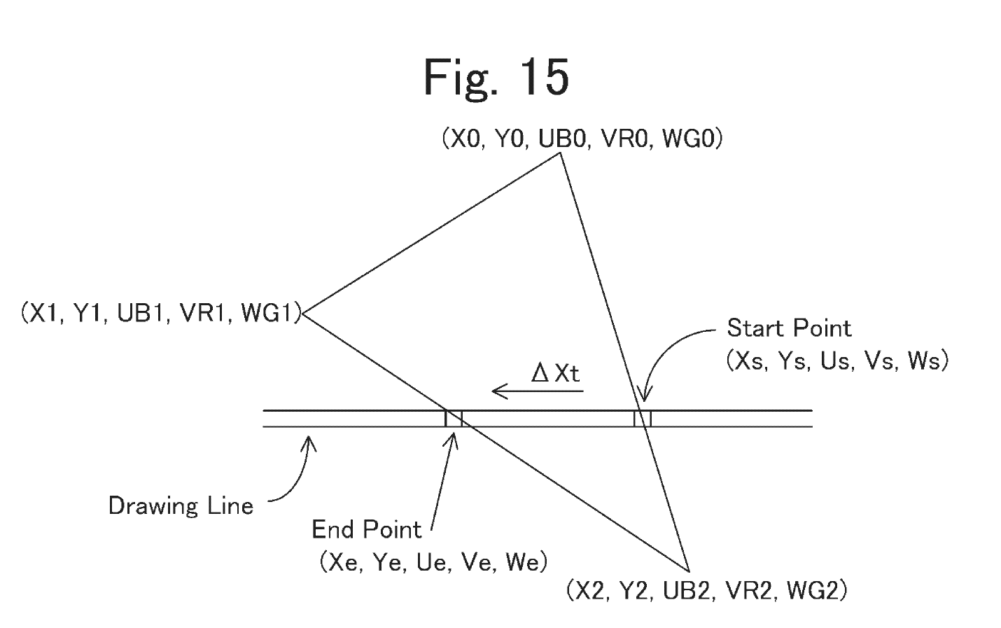

FIG. 15 is an explanatory view for showing the process of a polygon by the slicer 118 of FIG. 2 in the texture mapping mode. Referring to FIG. 15, the slicer 118 obtains the start point (Xs, Ys) and the end point (Xe, Ye) of the intersection points between the polygon (triangle) defined by the polygon/sprite shared data Cl as given and the horizontal line to be drawn. This process is performed in the same manner as in performed for a polygon in the gouraud shading mode.

In what follows, the perspective correct function will be described. In the texture mapping mode in which a three-dimensional image as converted by perspective projection is represented, the image as mapped is sometimes distorted when the texels corresponding to the drawing pixels on the screen are calculated simply by linear interpolation among the respective vertices of a texture in the UV space corresponding to the respective vertices of a polygon. The perspective correct function is provided for removing the distortion, and specifically the following process is performed.

The coordinates of the respective vertices “A”, “B” and “C” of a polygon as mapped onto the UV space are referred to as (Au, Av), (Bu, Bv) and (Cu, Cv). Also, the view coordinates of the respective vertices A, B and C are referred to as (Ax, Ay, Az), (Bx, By, Bz) and (Cx, Cy, Cz). Then, linear interpolation is performed among (Au/Az, Av/Az, 1/Az), (Bu/Bz, Bv/Bz, 1/Bz) and (Cu/Cz, Cv/Cz, 1/Cz) in order to obtain values (u/z, v/z, 1/z), and the coordinates (U, V) of each texel are acquired as (u, v), i.e., a value “u” which is obtained by multiplying u/z and the reciprocal of 1/z and a value “v” which is obtained by multiplying v/z and the reciprocal of 1/z, such that the texture mapping after the perspective projection transformations can be accurately realized. In this description, the view coordinates are coordinates in the view coordinate system. The view coordinate system is a three-dimensional orthogonal coordinate system consisting of three axes XYZ which has its origin at the viewpoint, and the Z-axis is defined to have its positive direction in the viewing direction.

In the case of the present embodiment, in place of 1/Az, 1/Bz and 1/Cz to be assigned to the respective vertices, the values calculated by multiplying the respective values by “Az”, i.e., Az/Az (=Aw), Az/Bz (=Bw) and Az/Cz (=Cw) are assigned to the polygon structure (refer to FIG. 3). However, the parameter “Aw” for the vertex A is always “1” so that it is not set in the polygon structure.

Accordingly, in the case of the present embodiment, linear interpolation is performed among (Au*Aw, Av*Aw, Aw), (Bu*Bw, Bv*Bw, Bw) and (Cu*Cw, Cv*Cw, Cw) in order to obtain values (u*w, v*w, w), and the coordinates (U, V) of each texel are acquired as (u, v), i.e., a value “u” which is obtained by multiplying u*w and 1/w and a value “v” which is obtained by multiplying v*w and 1/w, such that the texture mapping after the perspective projection transformations can be accurately realized.

While keeping this in mind, in the range in which the drawing Y-coordinate “Yr” satisfies Y0≦Yr<Y1, the slicer 118 calculates the values (Us, Vs, Ws) of the intersecting start point by linear interpolation on the basis of the values (UB0, VR0, WG0) of the vertex 0 and the values (UB2, VR2, WG2) of the vertex 2, and calculates the values (Ue, Ve, We) of the intersecting end point by linear interpolation on the basis of the values (UB0, VR0, WG0) of the vertex 0 and the values (UB1, VR1, WG1) of the vertex 1. Also, in the range in which the drawing Y-coordinate “Yr” satisfies Y1≦Yr≦Y2, the slicer 118 calculates the values (Us, Vs, Ws) of the intersecting start point by linear interpolation on the basis of the values (UB0, VR0, WG0) of the vertex 0 and the values (UB2, VR2, WG2) of the vertex 2, and calculates the values (Ue, Ve, We) of the intersecting end point by linear interpolation on the basis of the values (UB2, VR2, WG2) of the vertex 2 and the values (UB1, VR1, WG1) of the vertex 1.

This process will be explained in the exemplary case where the Y-coordinates of the respective vertices satisfies By≦Ay<Cy and where the drawing Y-coordinate “Yr” satisfies Y1≦Yr≦Y2. In this case, the slicer 118 calculates the values (Us, Vs, Ws) of the intersecting start point by linear interpolation on the basis of the values (UB0, VR0, WG0) (=(Bu*Bw, Bv*Bw, Bw)) of the vertex 0 and the values (UB2, VR2, WG2) (=(Cu*Cw, Cv*Cw, Cw)) of the vertex 2, and calculates the values (Ue, Ve, We) of the intersecting end point by linear interpolation on the basis of the values (UB2, VR2, WG2) (=(Cu*Cw, Cv*Cw, Cw)) of the vertex 2 and the values (UB1, VR1, WG1) (=(Au*Aw, Av*Aw, Aw)) of the vertex 1.

Next, the slicer 118 calculates ΔU, ΔV, ΔW and ΔXt. In this case, ΔU, ΔV and ΔW are the changes per ΔXt respectively in the U coordinate (=u*w), the V coordinate (=v*w) and the perspective correction parameter “W” (=w) on the horizontal line to be drawn, and ΔXt is the change in the X-coordinate per pixel on the horizontal line to be drawn. ΔXt takes either “+1” or “−1”.

ΔU=(Ue−Us)/(Xe−Xs)

ΔV=(Ve−Vs)/(Xe−Xs)

ΔW=(We−Ws)/(Xe−Xs)

ΔXt=(Xe−Xs)/|Xe−Xs|

The slicer 118 transmits “Xs”, “Us”, “Vs”, “Ws”, “Xe”, ΔU, ΔV, ΔW and ΔXt as calculated to the pixel stepper 120 together with the structure instance as received from the depth comparator 112. Also, in the case where the polygon/sprite shared data Cl as received from the vertex sorter 114 can be used in the next drawing cycle, the slicer 118 writes the structure instance as received from the depth comparator 112 to the recycle buffer 110. Meanwhile, on the basis of the vertical scanning count signal “VC” from the video timing generator 138 and the vertex coordinates of the polygon, it is possible to know whether or not the polygon/sprite shared data Cl can be used in the next drawing cycle.

Next, the process of a sprite by the slicer 118 will be described below.

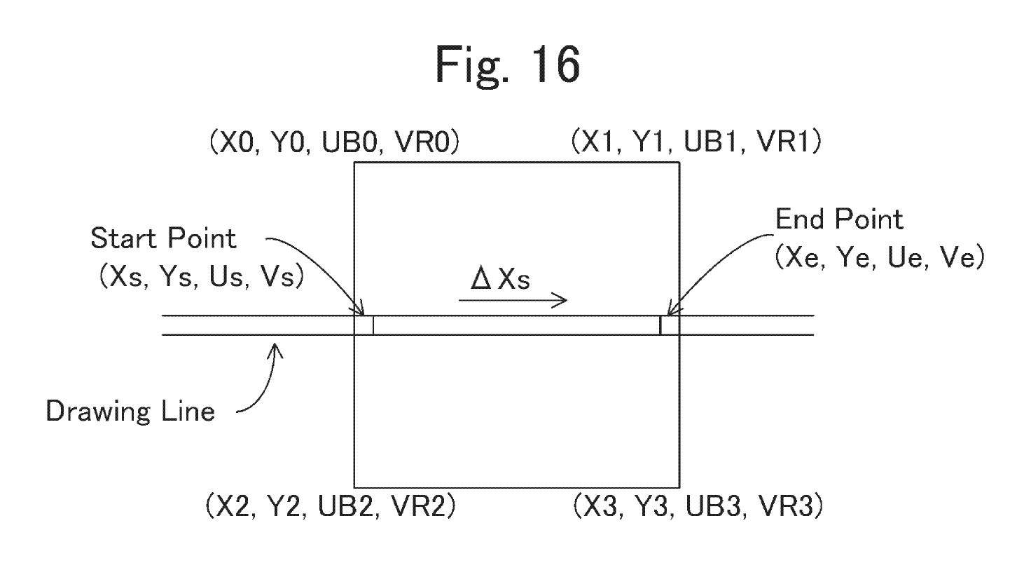

FIG. 16 is an explanatory view for showing the process of a sprite by the slicer 118 of FIG. 2. Referring to FIG. 16, the slicer 118 obtains the intersection points (Xs, Ys) and (Xe, Ye) between the sprite (rectangle) defined by the polygon/sprite shared data Cl as given and the horizontal line to be drawn. When a sprite is processed as discussed here, the intersection point which is drawn first is determined as the start point (Xs, Ys), and the intersection point which is drawn last is determined as the end point (Xe, Ye).

The coordinates of the respective vertices 0, 1, 2 and 3 of a sprite as mapped onto the UV space are referred to as (UB0, VR0), (UB1, VR1), (UB2, VR2), and (UB3, VR3). In this case, although UB3 and VR3 are not input to the slicer 118, these coordinates are calculated in the slicer 118 as described below.

UB3=UB1

VR3=VR2

The slicer 118 calculates the UV values (Us, Vs) of the intersecting start point by linear interpolation on the basis of the values (UB0, VR0) of the vertex 0 and the values (UB2, VR2) of the vertex 2, and calculates the UV values (Ue, Ve) of the intersecting end point by linear interpolation on the basis of the values (UB1, VR1) of the vertex 1 and the values (UB3, VR3) of the vertex 3.

Then, the slicer 118 calculates ΔU and ΔV. In this case, ΔU and ΔV are the changes per ΔXs respectively in the U coordinate and the V coordinate on the horizontal line to be drawn. ΔXs is the change in the X-coordinate per pixel on the horizontal line to be drawn and always takes “1”, so that the calculation is not performed.

ΔU=(Ue−Us)/(Xe−Xs)

ΔV=(Ve−Vs)/(Xe−Xs)

ΔXs=(Xe−Xs)/|Xe−Xs|=1

The slicer 118 transmits “Xs”, “Us”, “Vs”, “Xe”, “ΔU”, “ΔV” and “ΔXs” as calculated to the pixel stepper 120 together with the structure instance as received from the depth comparator 112. Also, in the case where the polygon/sprite shared data Cl as received from the vertex expander 116 can be used in the next drawing cycle, the slicer 118 writes the structure instance as received from the depth comparator 112 to the recycle buffer 110. Meanwhile, on the basis of the vertical scanning count signal “VC” from the video timing generator 138 and the vertex coordinates of the sprite, it is possible to know whether or not the polygon/sprite shared data Cl can be used in the next drawing cycle.

In this case, the slicer 118 can recognize the polygon or sprite on the basis of the field “F” of the polygon/sprite shared data Cl, and recognize the gouraud shading or texture mapping mode on the basis of the member “Type” of the polygon structure instance.

Returning to FIG. 2, when a polygon is processed in the gouraud shading mode, the pixel stepper 120 obtains the drawing X-coordinate and RGB values of the pixel to be drawn on the basis of the parameters (Xs, Rs, Gs, Bs, Xe, ΔR, ΔG, ΔB and ΔXg) as given from the slicer 118, and outputs them to the pixel dither 122 together with the (1-α) value. More specifically speaking, the pixel stepper 120 obtains the red components RX of the respective pixels by successively adding the change ΔR of the red component per pixel to the red component Rs at the intersection start point “Xs” (drawing start point). This process is performed to reach the intersection end point “Xe” (drawing end point). The same process is applied to the green component “GX” and the blue component “BX”. Also, the drawing X-coordinate “Xr” is obtained by successively adding the change ΔXg to the intersection start point “Xs”. Meanwhile, X=0 to |Xe−Xs|, and “X” is an integer.

RX=ΔXg*ΔR*X+Rs

GX=ΔXg*ΔG*X+Gs

BX=ΔXg*ΔB*X+Bs

Xr=ΔXg*X+Xs

The pixel stepper 120 outputs the RGB values (RX, GX, BX) of each pixel as obtained and the drawing X-coordinate “Xr” to the pixel dither 122 together with the (1-α) value and the depth value (Depth).

In addition, when a polygon is processed in the texture mapping mode, the pixel stepper 120 obtains the coordinates (U, V) by mapping the pixels to be drawn onto the UV space on the basis of the parameters (Xs, Us, Vs, Ws, Xe, ΔU, ΔV, ΔW and ΔXt) as given from the slicer 118. More specifically speaking, the pixel stepper 120 obtains the perspective correction parameter “WX” of each pixel by successively adding the change ΔW per pixel of the perspective correction parameter to the perspective correction parameter “Ws” of the intersection start point “Xs” (drawing start point). This process is performed to reach the intersection end point “Xe” (drawing end point). Meanwhile, X=0 to |Xe−Xs|, and “X” is an integer.

WX=ΔXt*ΔW*X+Ws

The pixel stepper 120 successively adds the change ΔU per pixel of the U coordinate to the U coordinate “Us” (=u*w) of the intersection start point “Xs” (drawing start point), and multiplies the result thereof by the reciprocal of “WX” to obtain the U coordinate “UX” of each pixel. This process is performed to reach the intersection end point “Xe” (drawing end point). The same process is applied to the V coordinate VX (=v*w). Also, the drawing X-coordinate “Xr” is obtained by successively adding the change ΔXt to the intersection start point “Xs”. Meanwhile, X=0 to |Xe−Xs|, and “X” is an integer.

UX=(ΔXt*ΔU*X+Us)*(1/WX)

VX=(ΔXt*ΔV*X+Vs)*(1/WX)

Xr=ΔXt*X+Xs

The pixel stepper 120 outputs the UV coordinates (UX, VX) of each pixel as obtained and the drawing X-coordinates “Xr” to the texel mapper 124 together with the structure instances (the polygon structure instance in the texture mapping mode and the texture attribute structure instance) received from the slicer 118.

Furthermore, for drawing a sprite, the pixel stepper 120 obtains the coordinates (U, V) of the pixel to be drawn as mapped onto the UV space from the parameters (Xs, Us, Vs, Xe, ΔU, ΔV and ΔXs) of the sprite given from the slicer 118. More specifically speaking, the pixel stepper 120 obtains the U coordinates UX of the respective pixels by successively adding the change ΔU per pixel of the U coordinate to the U coordinate Us at the intersection start point “Xs” (drawing start point). This process is performed to reach the intersection end point “Xe” (drawing end point). The same process is applied to the V coordinates VX. Also, the drawing X-coordinate “Xr” is obtained by successively adding the change ΔXs, i.e., “1”, to the intersection start point “Xs”. Meanwhile, X=0 to |Xe−Xs|, and “X” is an integer.

UX=ΔXs*ΔU*X+US

VX=ΔXs*ΔV*X+Vs

Xr=X+Xs

The pixel stepper 120 outputs the UV coordinates (UX, VX) of each pixel as obtained and the drawing X-coordinates “Xr” to the texel mapper 124 together with the structure instances (the sprite structure instance and the texture attribute structure instance) received from the slicer 118.

The pixel dither 122 adds noise to the fraction parts of the RGB values given from the pixel stepper 120 to make Mach bands inconspicuous by performing dithering. Meanwhile, the pixel dither 122 outputs the RGB values of the pixels after dithering to the color blender 132 together with the drawing X coordinates Xr, (1-α) values and the depth values.

If the member “Filter” of the texture attribute structure is “0”, the texel mapper 124 calculates and outputs four address sets, each consisting of a word address “WAD” and a bit address “BAD”, to point to four texels in the vicinity of the coordinates (UX, VX). On the other hand, if the member “Filter” of the texture attribute structure is “1”, the texel mapper 124 calculates and outputs one address set of the word address “WAD” and the bit address “BAD” pointing to the texel nearest the coordinates (UX, VX). Also, if the member “Filter” of the texture attribute structure is “0”, the bi-liner filter parameters BFP corresponding to the coefficients of the respective texels in the bi-liner filtering are calculated and output. Furthermore, while the depth values (corresponding to the members “Depth”) of the sprites when scissoring is disabled, the sprites when scissoring is enabled, and the polygons, are given in different formats, they are output after being converted in the same format.

The texture cache block 126 calculates the addresses of the respective texels on the basis of the word addresses “WAD”, bit addresses “BAD”, and the member “Tsegment” of the structure instance as output from the texel mapper 124. When the texel data pointed to by the address as calculated has already been stored in a cache, an index for selecting an entry of the color palette RAM 11 is generated on the basis of the texel data as stored and the member “Palette” of the attribute structure and output to the color palette RAM 11.

On the other hand, when the texel data has not been stored in the cache, the texture cache block 126 outputs an instruction to the memory manager 140 to acquire texel data. The memory manager 140 acquires the necessary texture pattern data from the main RAM 25 or the external memory 50, and stores it in a cache of the texture cache block 126. Also, the memory manager 140 acquires the texture pattern data required in the subsequent stages from the external memory 50 in response to the instruction from the merge sorter 106, and stores it in the main RAM 25.

At this time, for the texture pattern data to be used for polygons in the texture mapping mode, the memory manager 140 acquires the entirety of data as mapped onto one polygon at a time and stores it the main RAM 25, while for the texture pattern data to be used for sprites, the memory manager 140 acquires the data as mapped onto one sprite, one line at a time, and stores it the main RAM 25. This is because, in the case where the group of pixels included in a horizontal line to be drawn is mapped onto the UV space, the group of pixels can be mapped onto any straight line in the UV space when drawing a polygon while the group of pixels can be mapped always onto a line in parallel with the U axis of the UV space when drawing a sprite.

In the case of the present embodiment, the cache of the texture cache block 126 consists of 64 bits×4 entries, and the block replacement algorithm is LRU (least recently used).

The color palette RAM 11 outputs, to the bi-liner filter 130, the RGB values and the (1-α) value for translucent composition stored in the entry which is pointed to by the index generated by concatenating the member “Palette” with the texel data as input from the texture cache block 126, together with the bi-liner filter parameters BFP, the depth values and the drawing X-coordinates Xr.

The bi-liner filter 130 performs bi-liner filtering. In the texture mapping mode, it is the simplest method of calculating the color for drawing a pixel to acquire the color data of a texel located in the texel coordinates nearest the pixel coordinates (UX, VX) mapped onto the UV space, and calculate the color for drawing the pixel on the basis of the color data as acquired. This technique is referred to as the “nearest neighbor”.

However, if the distance between two points in the UV space onto which adjacent pixels are mapped is extremely smaller than the distance corresponding to one texel, that is, if a texture pattern is greatly expanded on the screen after mapping, the boundary between texels conspicuously appears, in the case of the nearest neighbor, resulting in coarse mosaic texture mapping. In order to remove such a shortcoming, the bi-liner filtering is performed.

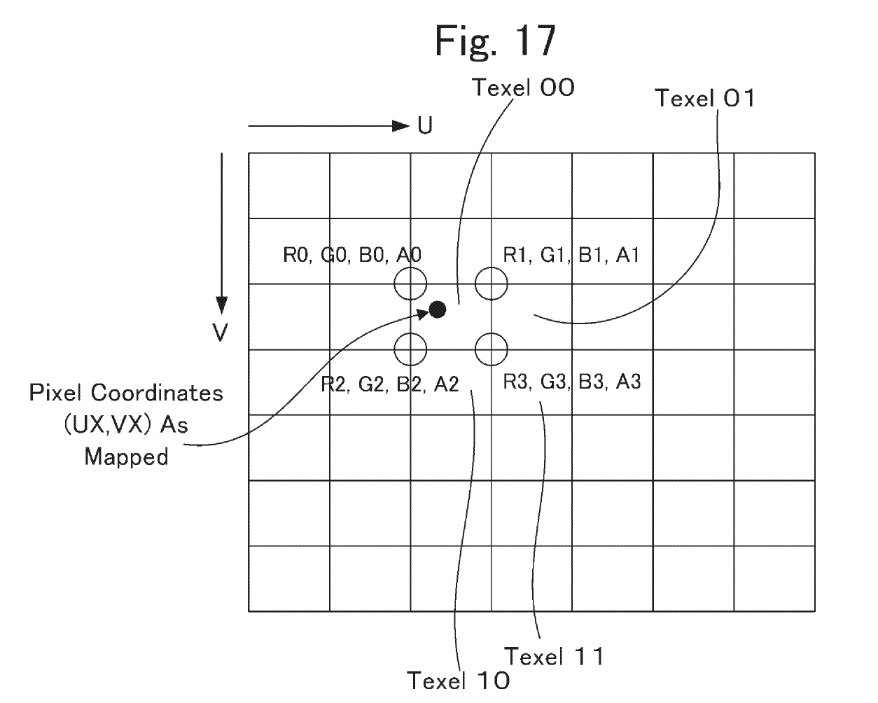

FIG. 17 is an explanatory view for showing the bi-liner filtering by means of the bi-liner filter 130. As shown in FIG. 17, the bi-liner filter 130 calculates the weighted averages of the RGB values and the (1-α) values of the four texels nearest the pixel coordinates (UX, VX) as mapped onto the UV space, and determines a pixel drawing color. By this process, the colors of texels are smoothly adjusted, and the boundary between texels becomes inconspicuous in the mapping result. In particular, the bi-liner filtering is performed by the following equations (the formulae for bi-liner filtering). However, in the following equation, “u” is the fraction part of the U coordinate UX, “v” is the fraction part of the V coordinate VX, “nu” is (1-u), and “nv” is (1-v).

R=R0*nu*nv+R1*u*nv+R2*nu*v+R3*u*v.

G=G0*nu*nv+G1*u*nv+G2*nu*v+G3*u*v.

B=B0*nu*nv+B1*u*nv+B2*nu*v+B3*u*v.

A=A0*nu*nv+A1*u*nv+A2*nu*v+A3*u*v.

The values R0, R1, R2 and R3 are the R values of the above four texels respectively; the values G0, G1, G2 and G3 are the G values of the above four texels respectively; the values B0, B1, B2 and B3 are the B values of the above four texels respectively; and the values A0, A1, A2 and A3 are the (1-α) values of the above four texels respectively.

The bi-liner filter 130 outputs the RGB values and the (1-α) value “A” of the pixel as calculated to the color blender 132 together with the depth value and the drawing X coordinates Xr.

Referring to FIG. 2, the line buffer block 134 will be explained in advance of explaining the color blender 132. The line buffer block 134 includes the line buffers LB1 and LB2, which are used in a double buffering mode in which when one buffer is used for displaying the other buffer is used for drawing, and the purposes of the buffers are alternately switched during use. The line buffer (LB1 or LB2) used for displaying serves to output the RGB values for each pixel to the video encoder 136 in accordance with the horizontal scanning count signal “HC” and the vertical scanning count signal “VC” which are output from the video timing generator.

The color blender 132 performs the translucent composition process. More specific description is as follows. The color blender 132 performs the alpha blending on the basis of the following equations by the use of the RGB values and the (1-α) value of the pixel as given from the pixel dither 122 or the bi-liner filter 130 and the RGB values stored in the location of the pixel to be drawn (the pixel at the drawing X coordinate Xr) in the line buffer (LB1 or LB2) to be drawn, and writes the result of the alpha blending to the same location of the pixel to be drawn in the line buffer (LB1 or LB2).

Rb=Rf*(1-αr)+Rr

Gb=Gf*(1-αr)+Gr

Bb=Bf*(1-αr)+Br

αb=αf*(1-αr)+αr

In the above equations, “1-αr” is the (1-α) value as given from the pixel dither 122 or the bi-liner filter 130. “Rr”, “Gr” and “Br” are the RGB values as given from the pixel dither 122 or the bi-liner filter 130 respectively. “Rf”, “Gf” and “Bf” are the RGB values as acquired from the location of the pixel to be drawn in the line buffer (LB1 or LB2) which is used for drawing. In the case of the typical algorithm of alpha blending, “Rr”, “Gr” and “Br” in the above equation are replaced respectively with Rr*αr, Gr*αr and Br*αr, however, in the case of the present embodiment, the values of “Rr”, “Gr” and “Br” stand for the calculation results of Rr*αr, Gr*αr and Br*αr which are prepared in advance so that the arithmetic circuitry can be simplified.

The video encoder 136 converts the RGB values as input from the line buffer (LB1 or LB2) used for display and the timing information as input from the video timing generator 138 (a composite synchronous signal “SYN”, a composite blanking signal “BLK”, a burst flag signal “BST”, a line alternating signal “LA” and the like) into a data stream VD representing the composite video signal in accordance with a signal “VS”. The signal “VS” is a signal indicative of a television system (NTSC, PAL or the like).

The video timing generator 138 generates the horizontal scanning count signal “HC” and the vertical scanning count signal “VC”, and the timing signals such as the composite synchronous signal “SYN”, the composite blanking signals “BLK”, the burst flag signal “BST”, the line alternating signal “LA” and the like on the basis of clock signals as input. The horizontal scanning count signal “HC” is counted up in every cycle of the system clock, and reset when scanning a horizontal line is completed. Also, the vertical scanning count signal “VC” is counted up each time the scanning of the ½ of horizontal line is completed, and reset after each frame or field is scanned.

By the way, as has been discussed above, in the case of the present embodiment, internal circuits of the RPU 9 can be shared as much as possible with a polygon and a sprite because the vertex sorter 114 and the vertex expander 116 converts the polygon structure and the sprite structure into the polygon/sprite shared data Cl in the same format. Because of this, it is possible to suppress the hardware scale.

Also, in the case where a sprite is drawn, it is not necessary to acquire the entirety of the texture image of the sprite at a time because there is not only the 3D system (drawing polygons) as in the conventional one but also the 2D system (drawing sprites). For example, as described above, it is possible to acquire the texel data in line units in a screen. Accordingly, it is possible to increase the number of the polygons and sprites capable of simultaneously drawing without incurring an increased memory capacity.

As a result, it is possible to generate an image which is formed from any combination of polygons to represent a shape of each surface of a three-dimensional solid projected to a two-dimensional space and sprites each of which is parallel to a frame of a screen, while suppressing the hardware scale, and furthermore it is possible to increase the number of the polygons and sprites capable of simultaneously drawing without incurring an increased memory capacity.

Also, in the present embodiment, since the vertex sorter 114 stores the parameters of the vertices $ in the format according to the drawing mode (the texture mapping mode or the gouraud shading mode) in the fields UB$, VR$ and WG$ ($=0 to 2) of the polygon/sprite shared data Cl, it is possible to draw in the different drawing modes in the 3D system while maintaining the identity of the format of the polygon/sprite shared data Cl.

Furthermore, in the present embodiment, since the coordinates of the three vertices 1 to 3 of the sprite are obtained by calculation, it is not necessary to include all coordinates of the four vertices 0 to 3 in the sprite structure, and thereby it is possible to reduce memory capacity necessary for storing the sprite structure. Needless to say, a part of the coordinates of the three vertices 1 to 3 of the sprite may be obtained by calculation to store the other ones in the sprite structure. Also, since the enlargement/reduction ratio “ZoomX” and/or “ZoomY” of the sprite are/is reflected to the coordinates mapped to the UV space which are calculated by the vertex expander 116, it is not necessary to store image data after enlarging or reducing in the memory MEM in advance even if an enlarged or reduced image of an original image is displayed in a screen, and thereby it is possible to reduce memory capacity necessary for storing image data.

Furthermore, in the present embodiment, the slicer 118 which receives the polygon/sprite shared data Cl can easily determine a type of a graphic element to be drawn by referring to the flag field to execute a process for each type of graphic elements while maintaining the identity of the polygon/sprite shared data Cl.

Furthermore, in the present embodiment, regarding either of a polygon and a sprite, the contents in the polygon/sprite shared data Cl are arranged in the appearance order of the vertices, and thereby it is possible to be simple drawing processing in a subsequent stage.

Furthermore, in the present embodiment, since the slicer 118 transmits the changes (ΔR, ΔG, ΔB, ΔXg, ΔU, ΔV, ΔW, ΔXt and ΔXs) of the respective vertex parameters per unit X-coordinate in the screen coordinate system to the pixel stepper 120, the pixel stepper 120 can easily calculate each parameter (RX, GX, BX, UX, VX and Xr) within the two intersection points between the polygon and the horizontal line to be drawn and each parameter (UX, VX and Xr) within the intersection points between the sprite and the horizontal line to be drawn by performing the linear interpolation.

Furthermore, in the present embodiment, the merge sorter 106 sorts the polygon structure instances and the sprite structure instances in the priority order for drawing in accordance with the merge sort rules 1 to 4 followed by outputting them as the same unified data strings, i.e., the polygon/sprite data PSD, so that the subsequent circuits can be shared with a polygon and a sprite as much as possible, and thereby it is possible to further suppress the hardware scale.

Furthermore, in the present embodiment, the merge sorter 106 compares the appearance vertex coordinate of the polygon (the minimum Y-coordinate among the three vertices) and the appearance vertex coordinate of the sprite (the minimum Y-coordinate among the four vertices) and then performs the merge sort in such a manner that the priority level for drawing of the one which appears earlier in the screen is higher (the merge sort rule 1). Accordingly, the subsequent stage is required only to execute the drawing processing in the output order to the polygon structure instances and the sprite structure instances each of which is outputted as the polygon/sprite data PSD. As a result, a high capacity buffer for storing one or more frames of image data (such as a frame buffer) is not necessarily implemented, but it is possible to display the image which consists of the combination of many polygons and sprites even if only a smaller capacity buffer (such as a line buffer, or a pixel buffer for drawing pixels short of one line) is implemented.

Also, the merge sorter 106 determines the priority order for drawing in descending order of the depth values in the horizontal line to be drawn when the appearance vertex coordinates of the polygon and sprite are equal (the merge sort rule 2). Accordingly, the polygon or sprite to be drawn in a deeper position is drawn first in the horizontal line to be drawn (drawing in order of depth values).

Furthermore, in the case where both the appearance vertex coordinates of the polygon and the sprite are located before the line to be drawn at the beginning, since the merge sorter 106 assumes that they have the same coordinate (the merge sort rule 3), the merge sorter 106 determines based on the depth values that the one to be drawn in a deeper position has the higher priority level for drawing. Accordingly, the polygons and sprites are drawn in order of depth values in the top line of the screen. If such process in the top line is not performed, the drawing in order of the depth values in the top line is not always ensured. However, in accordance with this configuration, it is possible to draw in order of the depth values from the top line.

In addition, in the case of an interlaced display, since the merge sorter 106 handles the appearance vertex coordinate corresponding to a horizontal line which is not drawn in the field to be displayed and the appearance vertex coordinate corresponding to a horizontal line (a horizontal line to be draw in the field to be displayed) next to the horizontal line as the same coordinate (the merge sort rule 4), the merge sorter 106 determines based on the depth values that the one to be drawn in a deeper position has the higher priority level for drawing. Accordingly, the drawing processing in order of depth values is ensured even if the interlaced display is performed.

As has been discussed above, since the drawing processing in order of depth values is ensured by the merge sort rules 2 to 4, the translucent composition process can be appropriately performed. This is because the drawing color of a translucent graphic element depends on the drawing color of the graphic element located behind the translucent graphic element, so that the graphic elements must be drawn from the deeper position.

By the way, next, the repeating mapping of the texture and the method for storing the texture pattern data into the memory MEM (the format type) will be described.

First, the repeating mapping of the texture will be described below. In the case where both or any one of members “M” and “N” of the texture attribute structure indicate (s) the value which is more than or equal to “1”, the texture pattern data is arranged in the UV space in order that it is iterated in the horizontal direction and/or the vertical direction. Accordingly, the texture is iteratively mapped to the polygon or sprite in the XY space.

In what follows, these points will be described referring to examples, but a ST coordinate system will be explained in advance. The ST coordinate system is a two-dimensional orthogonal coordinate system in which the respective texels constituting the texture are arranged in the same manner as when they are stored into the memory MEM. In the case where the divided storing of the texture pattern data as described below is not performed, (S, T) is represented by

(S, T)=(the masked UX as described below, the masked VX as described below). The U-coordinate UX and the V-coordinate VX are values calculated by the pixel stepper 120.

On the other hand, as described above, the UV coordinate system is a two-dimensional orthogonal coordinate system in which the respective texels constituting the texture are arranged in the same manner as when they are mapped to the polygon or the sprite. Namely, the coordinates in the UV coordinate system are U-coordinate UX and V-coordinate VX calculated by the pixel stepper 120, and are defined by U-coordinate UX and V-coordinate VX before masking as described below.

Incidentally, each of the UV space and ST space can be said as a texel space because textures (texels) are arranged in thereto in common.

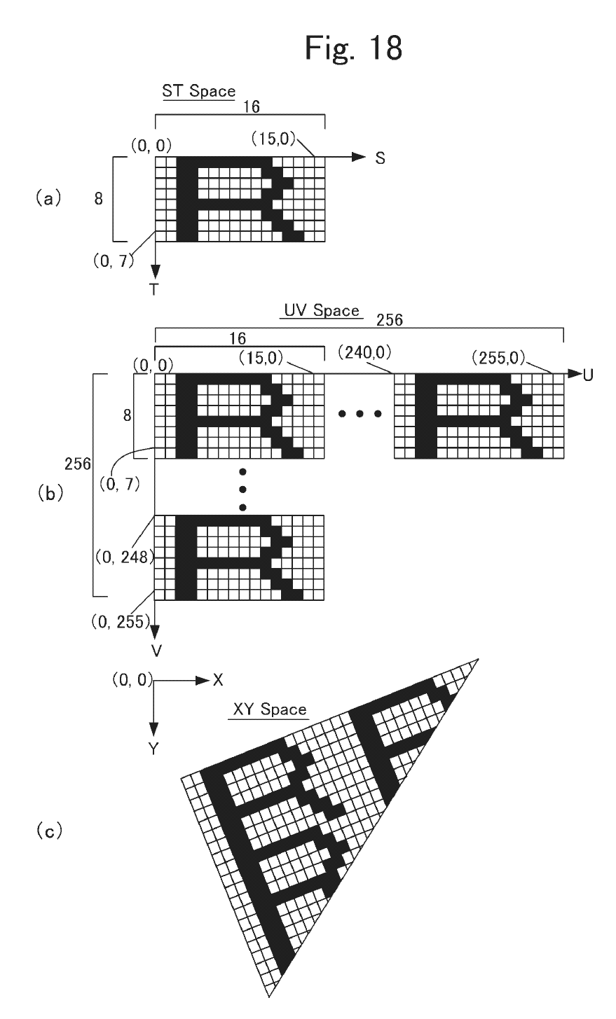

FIG. 18(a) is a view for showing an example of the quadrangular texture arranged in the ST space when the repeating mapping is performed. FIG. 18(b) is a view for showing an example of the textures arranged in the UV space, which are mapped to the polygon, when the repeating mapping is performed. FIG. 18(c) is a view for showing an example the polygon in the XY space to which the texture of FIG. 18(b) is repeatedly mapped.

The FIG. 18(a) to 18(c) cite the case of the member M=4 and the member N=5. The member “M” represents the number of upper bits to be masked of the U-coordinate UX (the upper 8-bit is a integer part and the lower 3-bit is a fraction part) in a 8-bit and the member “N” represents the number of upper bits to be masked of the V-coordinate VX (the upper 8-bit is a integer part and the lower 3-bit is a fraction part) in a 8-bit. The members “Width”, “Height”, “M”, “N”, “Bit” and “Palette” of this texture attribute structure designate the width of the texture minus “1” (in units of texels), the height of the texture minus “1” (in units of texels), the number of mask bits applicable to the “Width” from the upper bit, the number of mask bits applicable to the “Height” from the upper bit, a color mode (the number of bits minus “1” per pixel), and a pallet block number respectively.

An example of the texture pattern data (the letter “R”) of the polygon in the ST space is shown in FIG. 18(a). In this figure, one small rectangle indicates one texel. Also, the ST coordinates of the upper-left corner among the four vertices of a texel represents the position of the texel.

In the case of M=4 and N=5, since the upper 4 bits of the U-coordinate UX and the upper 5 bits of the V-coordinate VX are masked to indicate “0”, the ST space when the texel data is stored in the memory MEM is reduced to the ranges of S=0 to 15 and T=0 to 7. Namely, the texel data is stored only in the ranges of S=0 to 15 and T=0 to 7.

In this way, if the upper 4 bits of the U-coordinate UX and the upper 5 bits of the V-coordinate VX are masked and thereby the ST space is reduced as shown in FIG. 18(a), as shown in FIG. 18(b), the quadrangular texture which consists of 16 texels in the horizontal direction and 8 texels in the vertical direction is repeatedly arranged in the horizontal direction and in the vertical direction in the UV space.

Referring to FIG. 18(c), this example represents the case that the members “Width” and “Height” of the texture attribute structure are “31” and “19” respectively. The state where the texture which consists of 16 texels in the horizontal direction and 8 texels in the vertical direction is repeatedly mapped in the polygon can be understood. In this figure, one small rectangle consists of an aggregation of pixels and corresponds to one texel of FIG. 18(b). Also, one small triangle consists of an aggregation of pixels and corresponds to one texel of FIG. 18(b).

Incidentally, the case where the repeating mapping is applied to the sprite is the same as the case of the polygon and therefore redundant explanation is not repeated.

The method for storing the texture pattern data into the memory MEM (the format type) will be described. First, the texture pattern data to be mapped to the polygon will be described.

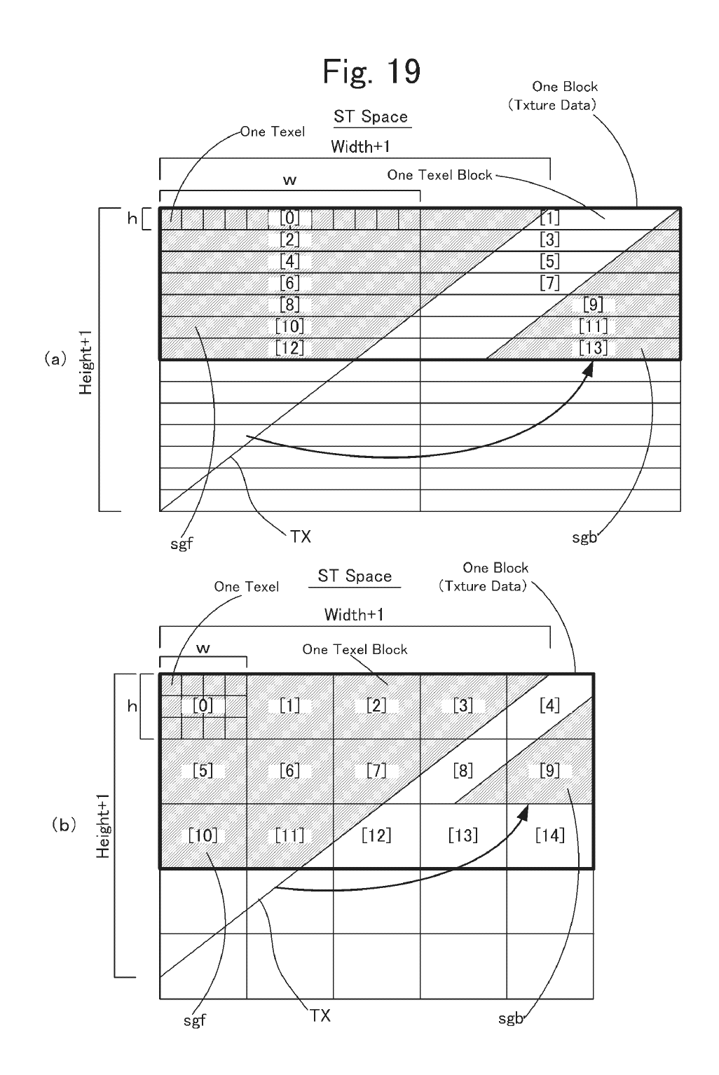

FIG. 19(a) is a view for showing an example of the texture arranged in the ST space, which is mapped to the polygon, when the member “MAP” of the polygon structure is “0”. FIG. 19(b) is a view for showing an example of the texture arranged in the ST space, which is mapped to the polygon, when the member “MAP” of the polygon structure is “1”.

Referring to FIG. 19(a) and FIG. 19(b), one small square represents one texel, the small rectangular which is horizontally long represents the string of texels (hereinafter, referred as “texel block”) to be stored in the one memory word, and the large rectangular which is horizontally long (the rectangular drawn in the heavy line) represents one block of the texture pattern data. Also, in this embodiment, it is assumed that the one memory word is 64 bits.

In these figures, a texture TX is a right triangle. The texture TX is divided into a piece “sgf” and a piece “sfb” by the line parallel to the S axis (U axis). Then, the piece sgf (the hatched area in the left side of the figure) is stored in the ST space (specifically, the two-dimensional array “A”) so as to keep its state in the UV space, and the piece sgb (the hatched area in the right side of the figure) is rotated by an angle of 180 degrees and moved in the UV space for storage into the ST space (specifically, the two-dimensional array “A”). One block (heavy line) of texture pattern data is stored in the memory MEM by such method. Such storage method is referred as “divided storing of texture pattern data”.

However, in the case where the value of the member “Map” and the value of the member “Height” become a specific combination, or in the case where the repeating mapping as described above is performed, the divided storing of the texture pattern data is not performed.

Incidentally, a numeral in the brackets [ ] of the rectangle which represents the texel block indicates a suffix (index) of the array “A” on the assumption that texture pattern data corresponding to one block is the above two-dimensional array “A” and each texel block is each element of the two-dimensional array “A”. Data assigned to each element of the two-dimensional array “A” is stored in the memory MEM in ascending order of the suffixes of the two-dimensional array “A”.

The “w” and “h” in the figure stand for the number of texels in a horizontal direction and the number of the texels in a vertical direction of the texel block respectively. The number “w” of horizontal texels and the number “h” of the vertical texels are determined based on values of the members “Map” and “Bit”. The following Table 1 represents relation between the member “Bit” and the number “w” of horizontal texels and the number “h” of vertical texels (i.e., a size of the texel block) in the case of the member Map=0.

TABLE 1

| | Number w of | Number h of |
|---|---|---|
| Bit | Horizontal Texels | Vertical Texels |
| 0 | 64 | 1 |
| (2-Color Mode) | | |
| 1 | 32 | 1 |
| (4-Color Mode) | | |
| 2 | 21 | 1 |
| (8-Color Mode) | | |
| 3 | 16 | 1 |
| (16-Color Mode) | | |
| 4 | 12 | 1 |
| (32-Color Mode) | | |
| 5 | 10 | 1 |
| (64-Color Mode) | | |
| 6 | 9 | 1 |
| (128-Color Mode) | | |
| 7 | 8 | 1 |
| (256-Color Mode) | | |

As is obvious from the Table 1, FIG. 19(a) illustrates the state of the divided storing of the texture pattern data in the case of Map=0 and Bit=4.

The following Table 2 represents relation between the member “Bit” and the number “w” of horizontal texels and the number “h” of vertical texels (i.e., a size of the texel block) in the case of the member Map=1.

TABLE 2

| | Number w of | Number h of |
|---|---|---|
| Bit | Horizontal Texels | Vertical Texels |
| 0 | 8 | 8 |
| (2-Color Mode) | | |
| 1 | 8 | 4 |
| (4-Color Mode) | | |
| 2 | 7 | 3 |
| (8-Color Mode) | | |
| 3 | 4 | 4 |
| (16-Color Mode) | | |
| 4 | 4 | 3 |
| (32-Color Mode) | | |
| 5 | 5 | 2 |
| (64-Color Mode) | | |
| 6 | 3 | 3 |
| (128-Color Mode) | | |
| 7 | 4 | 2 |
| (256-Color Mode) | | |

As is obvious from the Table 2, FIG. 19(b) illustrates the state of the divided storing of the texture pattern data in the case of Map=1 and Bit=4.

As described above, when the divided storing of the texture pattern data is performed, the piece sgb of the texture TX as divided is replaced by texels of an redundant area for mapping, then is stored in the memory MEM, and thereby it is possible to suppress required memory capacity.

Next, the storing method of the texture pattern data to be mapped to the sprite will be described.

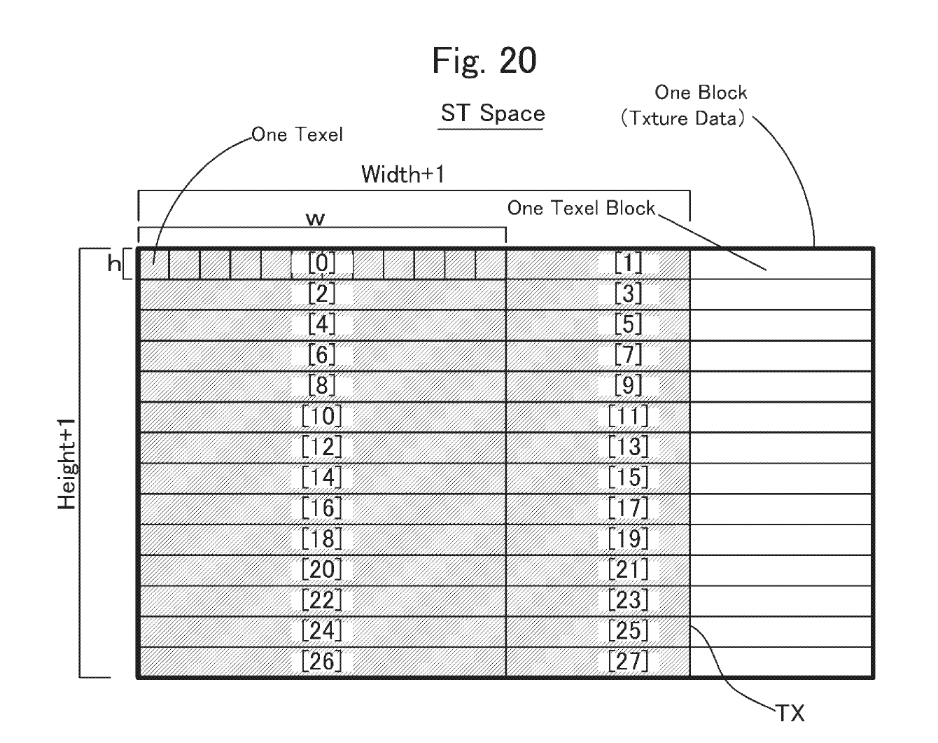

FIG. 20 is a view for showing an example of the texture arranged in the ST space, which is mapped to the sprite. Referring to FIG. 20, one small square represents one texel, the small rectangular which is horizontally long represents the texel block, and the large rectangular which is horizontally long (the rectangular drawn in the heavy line) represents one block of the texture pattern data. Also, in this embodiment, it is assumed that the one memory word is 64 bits.

In this figure, a texture TX is a quadrangle (a hatched part). The texture TX is stored in the ST space (specifically, the two-dimensional array “B”) so as to keep its state in the UV space. One block (heavy line) of texture pattern data is stored in the memory MEM by such method. Thus, the divided storing of the texture pattern data to be mapped to the sprite is not performed.

Incidentally, a numeral in the brackets [ ] of the rectangle which represents the texel block indicates a suffix (index) of the array “B” on the assumption that texture pattern data corresponding to one block is the above two-dimensional array “B” and each texel block is each element of the two-dimensional array “B”. Data assigned to each element of the two-dimensional array “B” is stored in the memory MEM in ascending order of the suffixes of the two-dimensional array “B”.

The “w” and “h” in the figure stand for the number of texels in a horizontal direction and the number of the texels in a vertical direction of the texel block respectively. The number “w” of horizontal texels and the number “h” of the vertical texels are determined based on value of the member “Bit”. The relation between the member “Bit”, and the number “w” of horizontal texels and the number “h” of vertical texels (i.e., a size of the texel block) is the same as Table 1.

Next, the texel block will be described in detail.

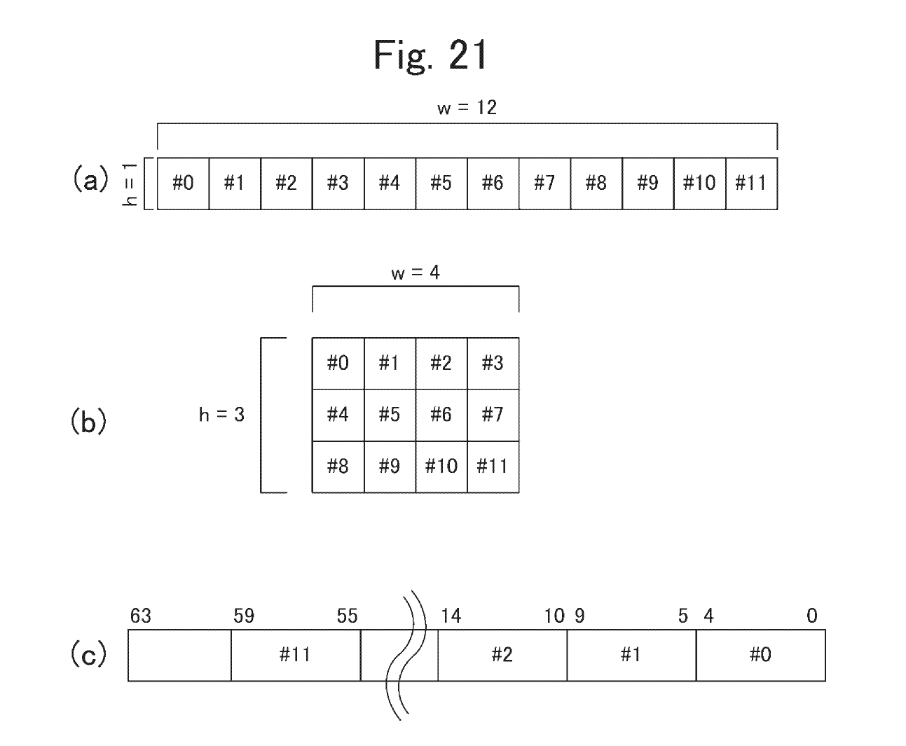

FIG. 21(a) is an explanatory view for showing the texel block on the ST space when the member “MAP” of the polygon structure is “0”. FIG. 21(b) is an explanatory view for showing the texel block on the ST space when the member “MAP” of the polygon structure is “1”. FIG. 21(c) is an explanatory view for showing the storage state of the texel block into one memory word. Incidentally, as described above, constitution of a texel block of a sprite on the ST space is the same as that of the polygon in the case of the member MAP=0.

FIG. 21(a) represents the case of the member MAP=0 and member Bit=4, and the texel block is provided with the head texel #0 at the left end thereof followed by texels #1, #2, . . . , #11 which are arranged adjacent to each other to the right direction.

FIG. 21(b) represents the case of the member MAP=1 and member Bit=4, and the texel block is provided with the head texel #0 at the upper left corner thereof followed by texels #1, #2 and #3 which are arranged adjacent to each other to the right direction, the texel #4 at the left end in one line below after reaching the right end followed by texels #5, #6 and #7 which are arranged adjacent to each other to the right direction, and the texel #8 at the left end in one line below after reaching the right end again followed by texels #9, #10 and #11 which are arranged adjacent to each other to the right direction.

Referring to FIG. 21(c), in the case of the member Bit=4 (corresponding to FIG. 21(a) and FIG. 21 (b)), since data corresponding to one texel consists of 5 bits, the texel #0 is stored in the zeroth bit to the fourth bit of the memory word, subsequently, the texels #1 to #11 are closely stored in the same way. The sixtieth to sixty-third bits of the memory word are blank bits, where the texel data is not stored.

While allowing for the repeating mapping of the texture and the method for storing the texture pattern data into the memory MEM (the format type), the texel mapper 124 will be described in detail.

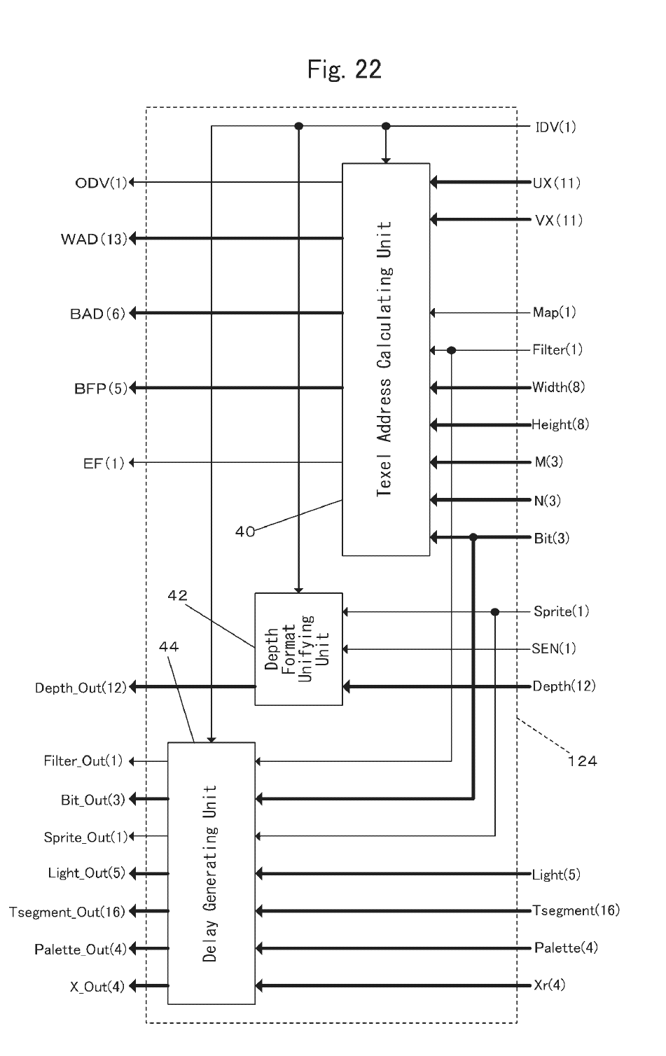

FIG. 22 is a block diagram showing the internal structure of the texel mapper 124 of FIG. 2. In figure, a numeral in the parentheses ( ) appended to a reference character assigned to a name of a signal represents the number of bits of the signal. Referring to FIG. 22, the texel mapper 124 is provided with a texel address calculating unit 40, a depth format unifying unit 42, and a delay generating unit 44.

The texel mapper 124 calculates a storage location on the memory MEM of a texel to be mapped to a drawing pixel (an offset value from the head of the texture pattern data) on the basis of the U-coordinate UX of the texel, the V-coordinate VX of the texel, the sprite structure instance/polygon structure instance, the texture attribute structure instance, and the drawing X coordinate Xr, which are inputted from the pixel stepper 120, and then outputs the result to the texture cache block 162. In what follows, the respective input signals will be described.

An input data valid bit IDV indicates whether or not the input data from the pixel stepper 120 is a valid value. The texel U coordinate UX and the texel V coordinate VX indicates the UV coordinates of the texel to be mapped to the drawing pixel. Each of the texel U coordinate UX and the texel V coordinate VX consists of a 8-bit integer part and a 3-bit fraction part, which are calculated by the pixel stepper 120.

Signals “Map” and “Light” are values of members “Map” and “Light” of the polygon structure respectively. Signals “Filter” and “Tsegment” are respectively values of members “Filter” and “Tsegment” of the polygon structure or the sprite structure. Incidentally, the polygon structure instances transmitted to the texel mapper 124 are all the structure instances of the polygons in the texture mapping mode. Signals “Width”, “Height”, “M”, “N”, “Bit” and “Palette” are respectively values of members “Width”, “Height”, “M”, “N”, “Bit” and “Palette” of the texture attribute structure.

A signal “Sprite”, which is outputted from the pixel stepper 120, indicates whether the input data is for the polygon or for the sprite. A scissoring enable signal “SEN” indicates whether the scissoring process is the enabled state or the disabled state. The value of this signal “SEN” is set in a control register (not shown in the figure) provided in the RPU 9 by CPU 5. A signal “Depth” is a value of the member “Depth” of the polygon structure or the sprite structure. However, the number of bits of the member “Depth” is 12 bits in the polygon structure, 8 bits in the sprite structure when scissoring is disabled, and 7 bits in the sprite structure when scissoring is enabled, which have the different sizes. Accordingly, when the value is less than 12 bits, it is inputted after adding bits “0” to the MSB side.

A signal “Xr” is the drawing X coordinate of the pixel calculated by the pixel stepper 120, and represents the horizontal coordinate in the screen coordinate system (2048*1024 pixels) by unsigned integer. In what follows, the respective output signals will be described.

An output data valid bit ODV indicates whether or not the output data from the texel mapper 124 is a valid value. A memory word address “WAD” indicates the word address of the memory MEM where the texel data is stored. This value “WAD” is an offset address from the head of the texture pattern data. In this case, the address “WAD” is outputted in a format where one word is 64 bits.

A bit address “BAD” indicates a bit position of LSB of texel data in a memory word where the texel data is stored. The bi-liner filter parameter BFP corresponds to the coefficient part for calculating a weighted average of the texel data. An end flag EF indicates an end of data as outputted. Data is outputted in units of one texel in the case where the pixel is drawn by the nearest neighbour (the member Filter=1), and data is outputted in units of four texels in the case where the pixel is drawn by the bi-liner filtering (the member Filter=0). Therefore, the ends of the data as outputted are indicated in the respective cases.

A signal “Depth_Out” is a depth value converted into a unified format of 12 bits. Signals “Filter_Out”, “Bit_Out”, “Sprite_Out”, “Light_Out”, “Tsegment_Out”, “Pallete_Out”, and “X_Out” correspond to input signals “Filter”, “Bit”, “Sprite”, “Light”, “Tsegment”, “Pallete”, and “X” respectively, and the each input signal is outputted to the subsequent stage as the each output signal as it is. However, delay is applied to them so as to synchronize with other output signals.

The texel address calculating unit 40 as described in detail below calculates the storage location on the memory MEM of the texel to be mapped to the drawing pixel. The input data valid bit IDV, the texel U coordinate UX, the texel V coordinate VX, the signal “MAP”, the signal “Filter”, the signal “Width”, the singal “Height”, the singnal “M”, the signanl “N”, and the signal “Bit” are inputted to the texel address calculating unit 40. Also, the texel address calculating unit 40 calculates the output data valid bit ODV, the memory word address “WAD”, the bit address “BAD”, the bi-liner filter parameter BFP, and the end flag EF on the basis of the input signals, and then outputs them to the texture cache block 126.

The depth format unifying unit 42 converts each value of the signals “Depth” with the respective different formats in cases where the structure instance inputted from the pixel stepper 120 is the sprite structure instance when scissoring is disabled, the structure instance inputted from the pixel stepper 120 is the sprite structure instance when scissoring is enabled, and the structure instance inputted from the pixel stepper 120 is the polygon structure instance, into the unified format, and then outputs the converted value as the signal “Depth_Out”.

The delay generating unit 44 delays the signals “Filter”, “Bit”, “Sprite”, “Light”, “Tsegment”, “Palette” and “X” by registers (not shown in the figure), synchronizes them with other output signals “ODV”, “WAD”, “BAD”, “BFP”, “EF” and “Depth_Out”, and then outputs them as the signals “Filter_Out”, “Bit_Out”, “Sprite_Out”, “Light_Out”, “Tsegment_Out”, “Palette_Ou”t and “X_Out” respectively.

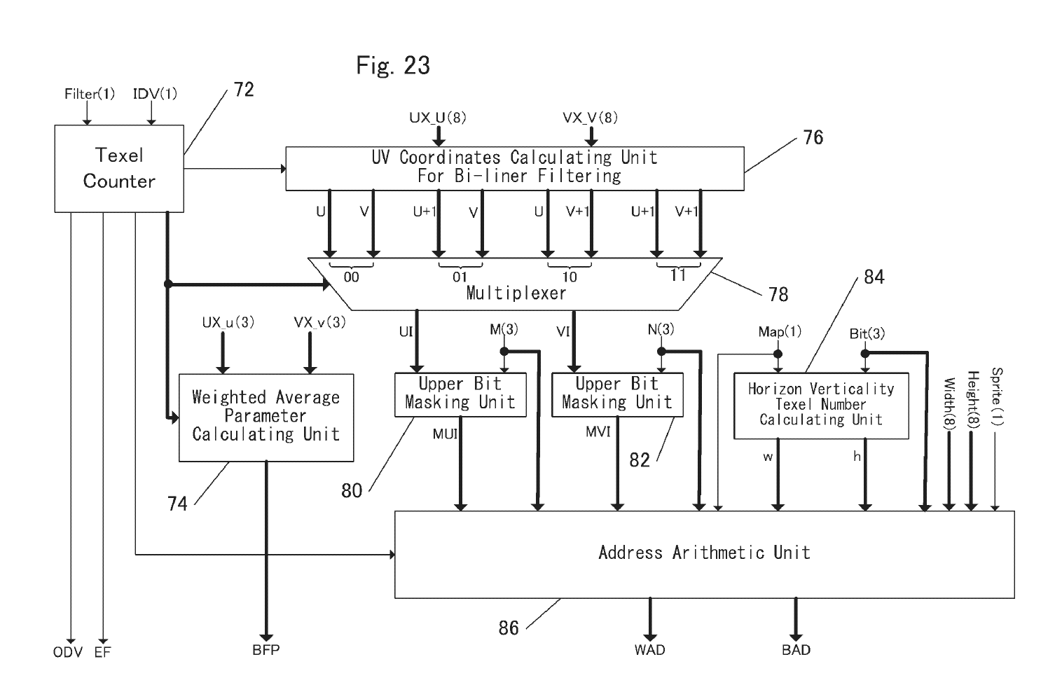

FIG. 23 is a block diagram showing the internal structure of the texel address calculating unit 40 of FIG. 22. In figure, a numeral in the parentheses ( ) appended to a reference character assigned to a name of a signal represents the number of bits of the signal. Referring to FIG. 23, the texel address calculating unit 40 is provided with a texel counter 72, a weighted average parameter calculating unit 74, a UV coordinates calculating unit 76 for the bi-liner filtering, a multiplexer 78, an upper bit masking unit 80 and 82, a horizon verticality texel number calculating unit 84, and an address arithmetic unit 86.

In the case where the input data valid bit IDV indicates “1” (i.e., in the case where the valid data is inputted) while the signal Filter=0 (i.e., while the input pixel is drawn in the bi-liner filtering mode), the texel counter 72 outputs “00”, “01”, “10” and “11” in sequence to the multiplexer 78 and the weighted average parameter calculating unit 74 in order that data corresponding to four texels is outputted from them.

In this case, as shown in FIG. 17, it is assumed that the four texels nearest the pixel coordinates as mapped onto the UV space are a texel 00, a texel 01, a texel 10 and a texel 11 respectively. The “00” outputted from the texel counter 72 indicates the texel 00, the “01” outputted from the texel counter 72 indicates the texel 01, the “10” outputted from the texel counter 72 indicates the texel 10, and the “11” outputted from the texel counter 72 indicates the texel 11.

On the other hand, in the case where the input data valid bit IDV indicates “1” while the signal Filter=1 (i.e., while the input pixel is drawn in the nearest neighbour mode), the texel counter 72 outputs “00” to the multiplexer 78 and the weighted average parameter calculating unit 74 in order that data corresponding to one texel is outputted from them.

Also, the texel counter 72 performs control in order that registers (not shown in the figure) of the UV coordinates calculating unit 76 for the bi-liner filtering and the address arithmetic unit 86 store input values successively.

Furthermore, the texel counter 72 asserts the end flag EF at the timing when data corresponding to the last texel among the four texels is outputted in the case of the signal Filter=0, asserts the end flag EF at the timing when data corresponding to the one texel is outputted in the case of the signal Filter=1, and whereby indicates the completion of outputting the data corresponding to one pixel. Also, the texel counter 72 asserts the output data valid bit ODV while valid data is outputted.

The UV coordinates calculating unit 76 for the bi-liner filtering will be described. The references “U” (referred as UX_U in the figure) and “V” (referred as VX_V in the figure) stand for the integer part of the texel U coordinate UX and the integer part of the texel V coordinate VX respectively.

The UV coordinates calculating unit 76 for the bi-liner filtering outputs the coordinates (U, V) as the integer part of the U coordinate and the integer part of the V coordinate of the texel 00, the coordinates (U+1, V) as the integer part of the U coordinate and the integer part of the V coordinate of the texel 01, the coordinates (U, V+1) as the integer part of the U coordinate and the integer part of the V coordinate of the texel 10, and the coordinates (U+1, V+1) as the integer part of the U coordinate and the integer part of the V coordinate of the texel 11 to the multiplexer 78. This means to generate coordinates for acquiring data of the four texels nearest the mapped pixel, which is required when the bi-liner filtering is performed.

The multiplexer 78 selects the integer parts (U, V) of the U coordinate and V coordinate of the texel 00 when the input signal from the texel counter 72 indicates “00”, the integer parts (U+1, V) of the U coordinate and V coordinate of the texel “01” when the input signal indicates 01, the integer parts (U, V+1) of the U coordinate and V coordinate of the texel 10 when the input signal indicates 10, and the integer parts (U+1, V+1) of the U coordinate and V coordinate of the texel “11” when the input signal indicates 11, and then outputs them as the integer parts (UI, VI) of the U coordinate and V coordinate.

In this case, references “u” (referred as UX_u in the figure), “v” (referred as VX_v in the figure), “nu”, and “nv” stand for the fraction part of the texel U coordinate UX, the fraction part of the texel V coordinate VX, the (1-u), and the (1-v) respectively. Also, references “R0”, “R1”, “R2” and “R3” stand for the R (red) components of the texel 00, texel 01, texel 10 and texel 11 respectively. References “G0”, “G1”, “G2” and “G3” stand for the G (green) components of the texel 00, texel 01, texel 10 and texel 11 respectively. References “B0”, “B1”, “B2” and “B3” stand for the B (blue) components of the texel 00, texel 01, texel 10 and texel 11 respectively. Furthermore, references “A0”, “A1”, “A2” and “A3” stand for the values of (1-α) of the texel 00, texel 01, texel 10 and texel 11 respectively.

Then, the bi-liner filter 130 obtains the red component R, the green component G, the blue component B, and the value of (1-α) of the drawing pixel after bi-liner filtering on the basis of the above formulae for bi-liner filtering.

The coefficient parts nu*nv, u*nv, nu*v, and u*v of each term of formulae for bi-liner filtering are referred as the texel 00 coefficient part, the texel 01 coefficient part, the texel 10 coefficient part, and the texel 11 coefficient part respectively.

The weighted average parameter calculating unit 74 calculates the texel 00 coefficient part, the texel 01 coefficient part, the texel 10 coefficient part, and the texel 11 coefficient part on the basis of the fraction parts (u, v) of the texel U coordinate UX and the texel V coordinate VX as inputted. Then, the texel 00 coefficient part is selected when the input signal from the texel counter indicates “00”, the texel 01 coefficient part is selected when the input signal from the texel counter indicates “01”, the texel 10 coefficient part is selected when the input signal from the texel counter indicates “10”, and the texel 11 coefficient part is selected when the input signal from the texel counter indicates “11”, and then they are outputted as the bi-liner filter parameters BFP.

The upper bit masking unit 80 masks upper bits of the U coordinate integer part UI with “0” in accordance with the value of the signal “M”, and outputs it as the masked U coordinate integer part MUI. For example, if M=3, the upper 3 bits of the U coordinate integer part Ul are masked with “000”. The upper bit masking unit 82 masks upper bits of the V coordinate integer part VI with “0” in accordance with the value of the signal “N”, and outputs it as the masked V coordinate integer part MVI. For example, if N=3, the upper 3 bits of the V coordinate integer part VI is masked with “000”. Incidentally, if M=0, the upper bit masking unit 80 outputs the U coordinate integer part UI without masking as the masked U coordinate integer part MUI as it is. Also, if N=0, the upper bit masking unit 82 outputs the V coordinate integer part VI without masking as the masked V coordinate integer part MVI as it is.

The horizon verticality texel number calculating unit 84 calculates the number w of the horizontal texels and the number h of the vertical texels of the texel block (refer to FIG. 19 and FIG. 20) on the basis of the signal “Map” and signal “Bit”. These are calculated based on the above Table 1 and Table 2.

The address arithmetic unit 86 calculates the texel coordinates in the ST space reflecting the repeating mapping of the texture (refer to FIG. 18) and the divided storing of the texture pattern data (refer to FIG. 19), and then calculates the storage location on the memory MEM on the basis of the texel coordinates as calculated. The detail is as follows.

First, the address arithmetic unit 86 determines whether or not the divided storing of the texture pattern data has been performed. The divided storing of the texture pattern data is not performed if any one of the following Conditions 1 to 3 is satisfied.

### [Condition 1]

The input signal “Sprite” indicates “1”. Namely, it is the case where the input data is related to the sprite.

### [Condition 2]

Both or any one of the input signal “M” and “N” are/is more than or equal to one. Namely, it is the case where the repeating mapping of the texture is performed.

### [Condition 3]

The value of the input signal “Height” does not exceed the number h of the vertical texels of the texel block. Namely, it is the case where the number of texel blocks in the vertical direction is equal to one when the texture pattern data is divided into texel blocks.

In this case, references “U”, “V”, and (S, T) stand for the masked integer part MUI of the U coordinate, the masked integer part MVI of the V coordinate, and the coordinates of the texel stored in the memory MEM (in the ST space) respectively. Then, the address arithmetic unit 86 calculates the coordinates (S, T) of the texel in the ST space based on the following equations when the divided storing of the texture pattern data has been performed. In the following equations, the symbol “/” of operation stands for division which obtains a quotient as an integer by truncating a decimal place of a quotient.

[The case of the signal Map=0]

If V>Height/2,

S=(Width/w+1)*w−U−1, and

T=Height−V.

If V≦Height/2,

S=U, and

T=V.

[The case of the signal Map=1]

If V/h>Height/2h,

S=(Width/w+1)*w−U−1, and

T=(Height/h+1)*h−V−1.

If V/h≦Height/2h,

S=U, and

T=V.

In this case, the “Height/h” is an example of a V coordinate threshold value which is defined on the basis of the V coordinate of the texel having the maximum V coordinate among texels of the texture. In the above equations, if the V coordinate of the pixel is less than or equal to the V coordinate threshold value, the coordinates (U, V) of the pixel are assigned to the coordinates (S, T) of the pixel in the ST coordinate system as they are, and if the V coordinate of the pixel exceeds the V coordinate threshold value, the coordinates (U, V) of the pixel is rotated by an angle of 180 degrees and moved, and thereby is converted into the coordinates (S, T) of the pixel in the ST coordinate system. Accordingly, the appropriate texel data can be read from the memory MEM of the storage source even if the divided string of the texture pattern data is performed.

On the other hand, the address arithmetic unit 86 calculates the coordinates (S, T) of the texel in the ST space based on the following equations when the divided storing of the texture pattern data has not been performed.

S=U

T=V

The address arithmetic unit 86 obtains the address (memory word address) WAD of the memory word including the texel data and the bit position (bit address) BAD in the memory word on the basis of the texel coordinates (S, T). In this case, note that the memory word address obtained by the address arithmetic unit 86 is not the final memory address but an offset address from the head of the texture pattern data. The final memory address is obtained on the basis of the memory word address “WAD” and the signal “Tsegment” by the subsequent texture cache block 126.

The memory word address “WAD” and the bit address “BAD” are calculated base on the following equations. In the following equations, the symbol “/” of operation stands for division which obtains a quotient as an integer by truncating a decimal place of a quotient, and the symbol “%” of operation stands for calculation of remainder of division for obtaining a quotient as an integer.

WAD=(Width/w+1)*(T/h)+(S/w)

BAD=((V % h)*w+S % w)*(Bit+1)

In this case, the value indicated by the bit address “BAD” is the bit position in the memory word where LSB of the texel data is stored. For example, if Bit=6 and BAD=25, it indicates that the texel data is stored in seven bits from the twenty-fifth bit to the thirty-first bit.

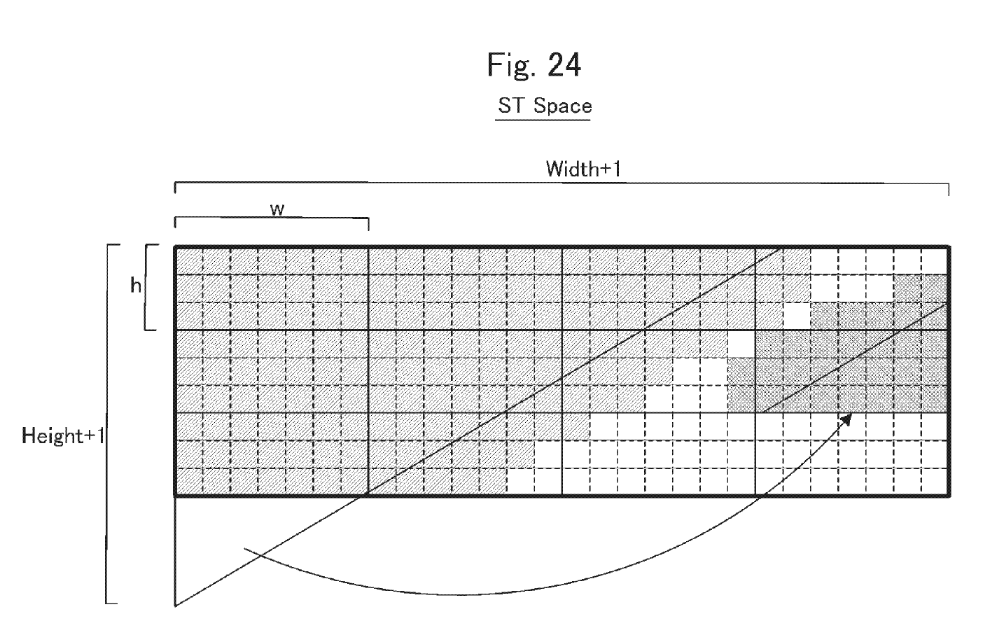

FIG. 24 is an explanatory view for showing the bi-liner filtering when the divided string of the texture pattern data is performed. The example of the texture pattern data of the polygon, which is indicated by the member Filter=0, the member Map=1, the member Bit=2, the member Width=21, and the member Height=12, is illustrated in this figure. Also, a size of the texel block is w=7 and h=3.

In this case, the texture pattern data is divided and stored as shown in the figure (the hatched area). Regarding the part stored in the ST space without the rotation by an angle of 180 degrees and the movement in the UV space (i.e., while keeping the arrangement in the UV space), four texel data pieces located at the coordinates (S, T), the coordinates (S+1, T), the coordinates (S, T+1), and the coordinates (S+1, T+1) are used in the bi-liner filtering process on the assumption that the coordinate (U, V) of the pixel mapped to the UV space corresponds to the coordinates (S, T) in the ST space.

On the other hand, Regarding the part stored in the ST space with the rotation by an angle of 180 degrees and the movement in the UV space by the divided storing, four texel data pieces located at the coordinates (S, T), the coordinates (S−1, T), the coordinates (S, T−1), and the coordinates (S−1, T−1) are used on the assumption that the coordinate (U, V) of the pixel mapped to the UV space corresponds to the coordinates (S, T) in the ST space.

In the case where the divided storing of the texture pattern data is performed, since there is the texel data which corresponds to the blank space between the two triangles as the result of the division, i.e., since the texel data for the bi-liner filtering can be arranged between the two triangles as the result of the division, it is possible to perform the drawing process of the pixels without failure even if the texel data nearest the coordinates (S, T) in the ST space corresponding to the coordinate (U, V) of the pixel mapped to the UV space is used when the bi-liner filtering process is performed.

By the way, as has been discussed above, in the case of the present embodiment, the texture is not stored in the memory MEM (arranged in the ST space) in the same manner as when it is mapped to the polygon but is divided into the two pieces, rotated by an angle of 180 degrees, moved, and then stored in the memory MEM (arranged in the ST space). As a result, even if the texture which is mapped to the polygon such as a triangle other than a quadrangle is stored in the memory MEM, it is possible to reduce the useless storage space where the texture is not stored and store efficiently, and thereby the capacity of the memory MEM where the texture is stored can be reduced.

In other words, of the texel data pieces constituting the texture pattern data, the texel data pieces in the area where the texture is arranged include a substantial content (information which indicates color directly or indirectly), while the texel data pieces in the area where the texture is not arranged do not include the substantial content and therefore they are useless. It is possible to suppress necessary memory capacity by reducing the useless texel data pieces as much as possible.

The texture pattern data in this case does not only mean the texel data pieces in the area where the texture is arranged (the hatched area of the block of FIG. 19 corresponds to it) but also includes the texel data pieces in the area other than it (the area other than the hatched area of the block of FIG. 19 corresponds to it). Namely, the texture pattern data means the texel data pieces in the quadrangular area including the triangular texture (the block of FIG. 19 correspond to it).

Especially, if the triangular texture to be mapped to the triangular polygon is stored in the two-dimensional array as it is, an approximately half of the texel data pieces in the array is wasted. Therefore, the divided storing is more suitable for the case where the polygon is triangular,

Also, in the case of the present embodiment, it is possible to reduce data amount necessary for designating the coordinates of the vertex of the triangle in the UV space by conforming two sides forming a right angle to U axis and V axis in the UV space respectively, and assigning the vertex of the right angle to the origin because of the right triangular texture (see FIG. 19).

Furthermore, in the case of the present embodiment, the polygon to represent a shape of each surface of a three-dimensional solid projected to a two-dimensional space is capable of being used also as the sprite which is plane parallel to the screen. However, the polygon is merely used as if it were the sprite, and therefore it is absolutely the polygon. Thus, the polygon which is used as if it were the sprite is referred as the pseudo sprite.

In the case where the polygon is used as the pseudo sprite, it is possible to reduce memory capacity necessary for temporally storing the texel data by acquiring the texel data in units of lines in the same manner as the original sprite.

In such case, it is possible to reduce the frequency of accessing the memory MEM when the texel data pieces are acquired in units of lines by setting the member “Map” to 0 (the first storage format) (see FIG. 19(a)), and storing one texel block which consists of the one-dimensionally aligned texel data pieces into one word of the memory MEM.

On the other hand, in the case where the polygon is used for the original purpose so as to represent the three-dimensional solid, when the pixels on the horizontal line of the screen are mapped to the UV space, they are not always mapped to the horizontal line in the UV space.

As just described, even if the pixels are not mapped to the horizontal line in the UV space, it is possible to reduce the frequency of accessing the memory MEM when the texel data pieces are acquired. Because possibility that the texel data piece located at UV coordinates of the pixel as mapped is present in the texel data pieces stored already in the texture cache block 126 becomes high (i.e., a cache hit rate increases.) by setting the member “Map” to 1 (the second storage format) (see FIG. 19(b)), and storing one texel block which consists of the two-dimensionally arranged texel data pieces into one word of the memory MEM.

Incidentally, in the case where the polygon is used as the pseudo sprite, there is the following merit. In the case of the original sprite, one sprite is defined by designating only the coordinates of one vertex by the members “Ay” and “Ax”, and designating size thereof by the members “Height”, “Width”, “ZoomY” and “ZoomX” (see FIG. 9). Thus, in the case of the sprite, designation of the size and the coordinates of the vertex thereof is partway restricted. In contrast, the coordinates of each vertex can arbitrarily be designated by the members “Ay”, “Ax”, “By”, “Bx”, “Cy” and “Cx” (see FIG. 3) because the pseudo sprite is the polygon, and therefore it is possible to arbitrarily designate also the size.

Furthermore, in the case of the present embodiment, in the case where the repeating mapping of the texture is performed, the divided storing of the texture pattern data is not performed. Accordingly, it is suitable for storing the texture pattern data into the memory MEM when the rectangular texture is repeatedly mapped in the horizontal direction and/or in the vertical direction. In addition, the same texture pattern data can be used because of the repeating mapping, and thereby it is possible to reduce memory capacity.

Furthermore, in the case of the present embodiment, when the bi-liner filtering is performed, even if the coordinates of the pixel in the ST space is included in the piece which is rotated by an angle of 180 degrees, moved, and then arranged in the ST space, four texels are acquired reflecting them (see FIG. 24). In addition, the texels for the bi-liner filtering are stored so as to be adjacent to pieces between the pieces to which the divided storing is applied (see FIG. 24). As a result, even if the divided storing of the texture pattern data is performed, it is possible to implement the bi-liner filtering process without problems.

Furthermore, in the case of the present embodiment, the repeating mapping of the texture of the different number of the horizontal texels and/or the different number of the vertical texels can be implemented using the same texture pattern data by masking (setting to bits 0) the upper M bits of the U coordinate integer part UI and/or the upper N bits of the V coordinate integer part VI. It is possible to reduce the memory capacity because of usage of the same texture pattern data.

By the way, next, the memory manager 140 will be described in detail. In the case where the texel data to be drawn is not stored in the texture cache block 126, the texture cache block 126 requests the texel data from the memory manager 140.

Then, the memory manager 140 reads the texture pattern data as requested from a texture buffer on the main RAM 25, and outputs it to the texture cache block 126. The texture buffer is an area allocated on the main RAM 25 to temporarily store the texture pattern data.

On the other hand, in the case where the texture pattern data as requested by the merge sorter 106 is not read into the texture buffer on the main RAM 25, the memory manager 140 requests DMA transfer from the DMAC 4 via the DMAC interface 142 and reads the texture pattern data which is stored in the external memory 50 into the texture buffer area as allocated newly.

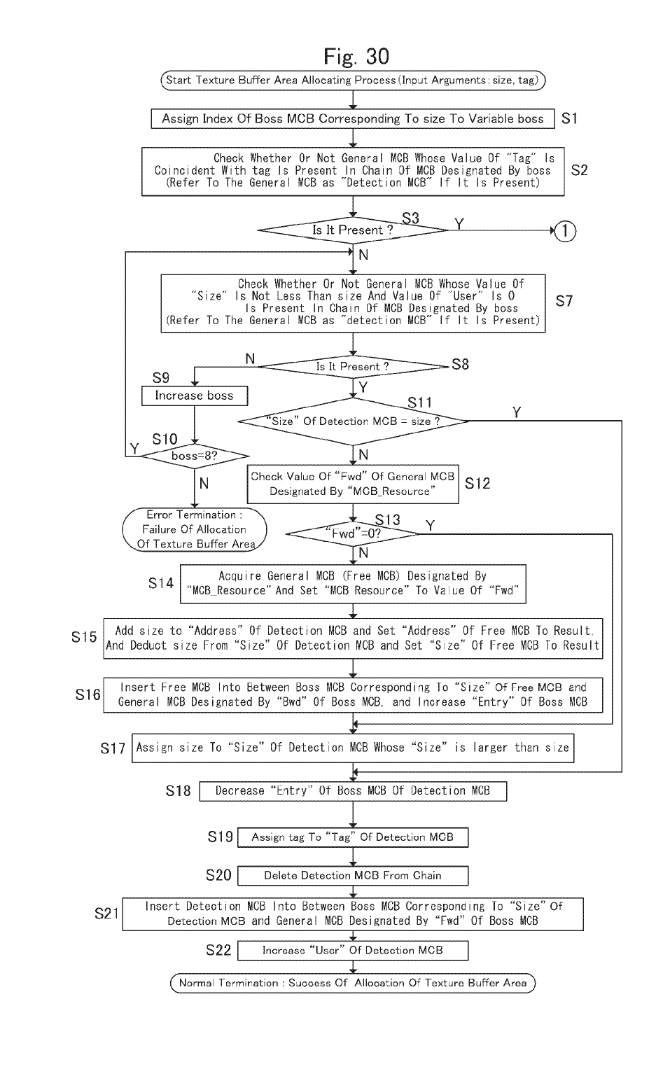

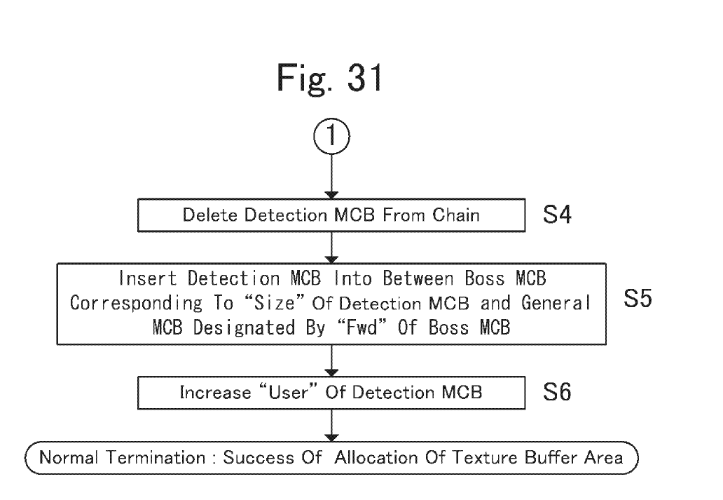

In this case, the memory manager 140 performs the processing for allocating the texture buffer area as shown in FIG. 30 and FIG. 31 as described below in accordance with the value of the member “Tsegment” as outputted from the merge sorter 106 and size information of the entire texture pattern data. In the present embodiment, the function for allocating the texture buffer area is implemented by hard wired logic.

An MCB initializer 141 of the memory manager 140 is an hardware for initializing contents of an MCB (Memory Control Block) structure array as described below. The fragmentation occurs in the texture buffer managed by the memory manager 140 while repeating allocation and deallocation of the area, and therefore it becomes increasingly difficult to allocate the large area. The MCB initializer 141 initializes contents of the MCB structure array and resets the texture buffer to the initial state with the purpose to avoid the occurrence of the fragmentation.

The MCB structure is a structure for managing the texture buffer and forms the MCB structure array which has constantly 128 instances The MCB structure array is arranged on the main RAM 25 and the head address of the MCB structure array is designated by an RPU control register “MCB Array Base Address” as described below. The MCB structure array consists of 8 boss MCB structure instances and 120 general MCB structure instances. Both the structure instances are constituted by 64 bits (=8 bytes). In what follows, the boss MCB structure instance and the general MCB structure instance are generally referred to as the “MCB structure instance” in the case where they need not be distinguished.

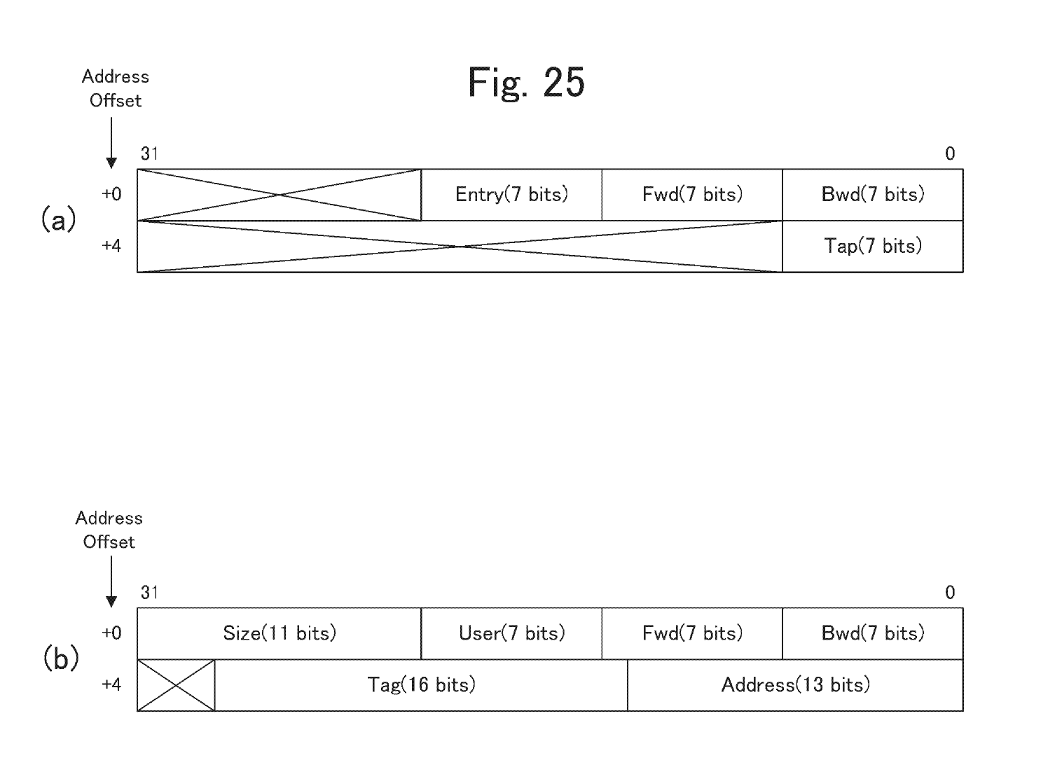

FIG. 25(a) is a view for showing the configuration of the boss MCB structure. FIG. 25(b) is a view for showing the configuration of the general MCB structure. Referring to FIG. 25(a), the boss MCB structure includes members “Bwd”, “Fwd”, “Entry” and “Tap”. Referring to FIG. 25(b), the general MCB structure includes members “Bwd”, “Fwd”, “User”, “Size”, “Address” and “Tag”.

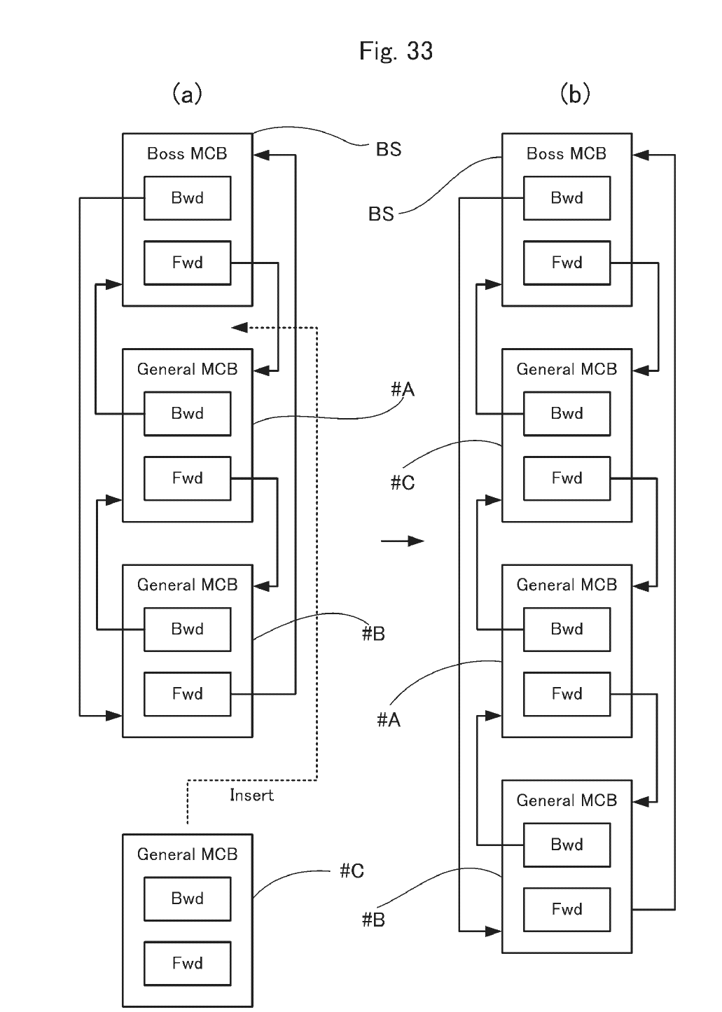

First, the members common to both of them will be described. The member “Bwd” indicates a backward link in a chain (see FIG. 33 as described below) of the boss MCB structure instance. An index (7 bits) which indicates the MCB structure instance is stored in the member “Bwd”. The member “Fwd” indicates a forward link in the chain of the boss MCB structure instance. An index (7 bits) which indicates the MCB structure instance is stored in the member “Fwd”.

Next, the members specific to the boss MCB structure will be described. The member “Entry” indicates the number of the general MCB structure instances which are included in the chain of the boss MCB structure instance. The member “Tap” stores an index (7 bits) which indicates the general MCB structure instance which is included in the chain of the boss MCB structure instance and furthermore deallocated most recently.

Next, the members specific to the general MCB structure will be described. The member “User” indicates the number of the polygon structure instances or the sprite structure instances which shares the texture buffer area managed by the general MCB structure instance. However, since a plurality of sprite structure instances does not share the texture buffer area, the maximum value thereof is “1” when managing the texture buffer area of the sprite structure instance.

The member “Size” indicates size of the texture buffer area managed by the general MCB structure instance. The texture buffer area is managed in units of 8 bytes and actual size (the number of bytes) of the area is obtained by multiplying the value indicated by the member “Size” by “8”. The member “Address” indicates a head address of the texture buffer area managed by the general MCB structure instance. In this case, the third to fifteenth bits (13 bits corresponding to A [15:3]) of the physical address on the main RAM 25 are stored in this member. The member “Tag” stores a value of the member “Tsegment” which indicates the texture pattern data stored in the texture buffer area managed by the general MCB structure instance. The member “Tsegment” is the member of the polygon structure in the texture mapping mode or the sprite structure (see FIG. 3 and FIG. 6).

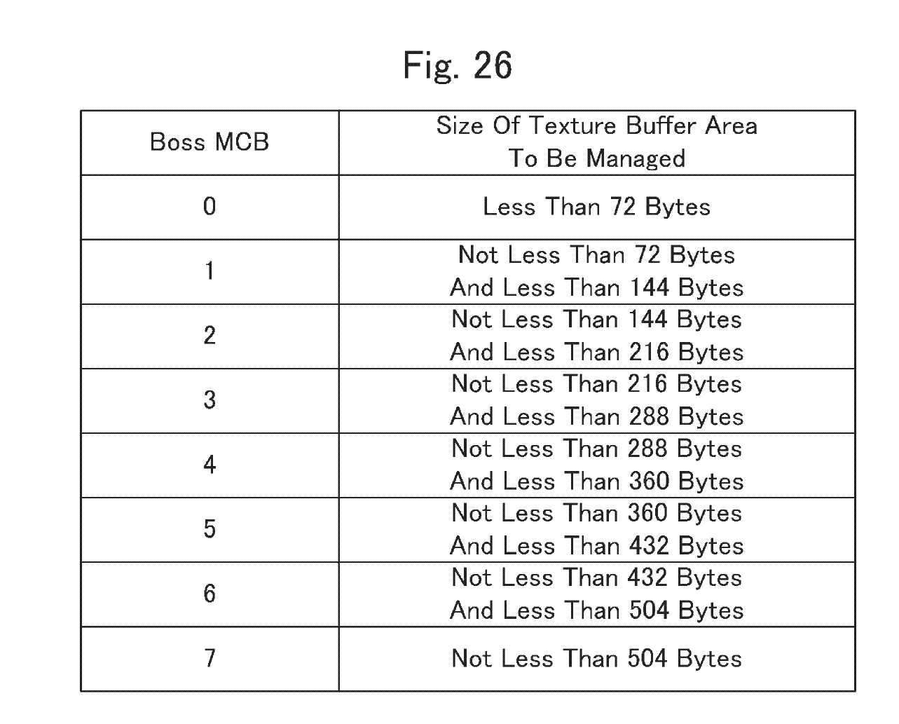

FIG. 26 is an explanatory view for showing the sizes of the texture buffer areas managed by the boss MCB structure instances. As shown in FIG. 26, eight boss MCB structure instances [0] to [7] are respectively the texture buffer areas whose sizes are different from one another. It can be understood by this figure which size of the texture buffer area is managed by which the boss MCB structure instance.

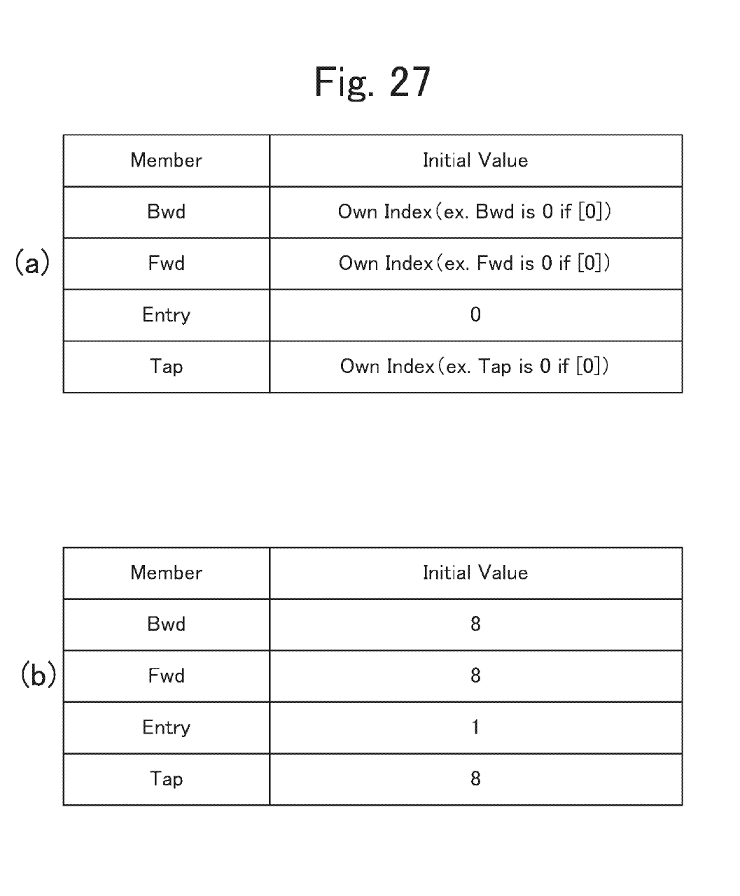

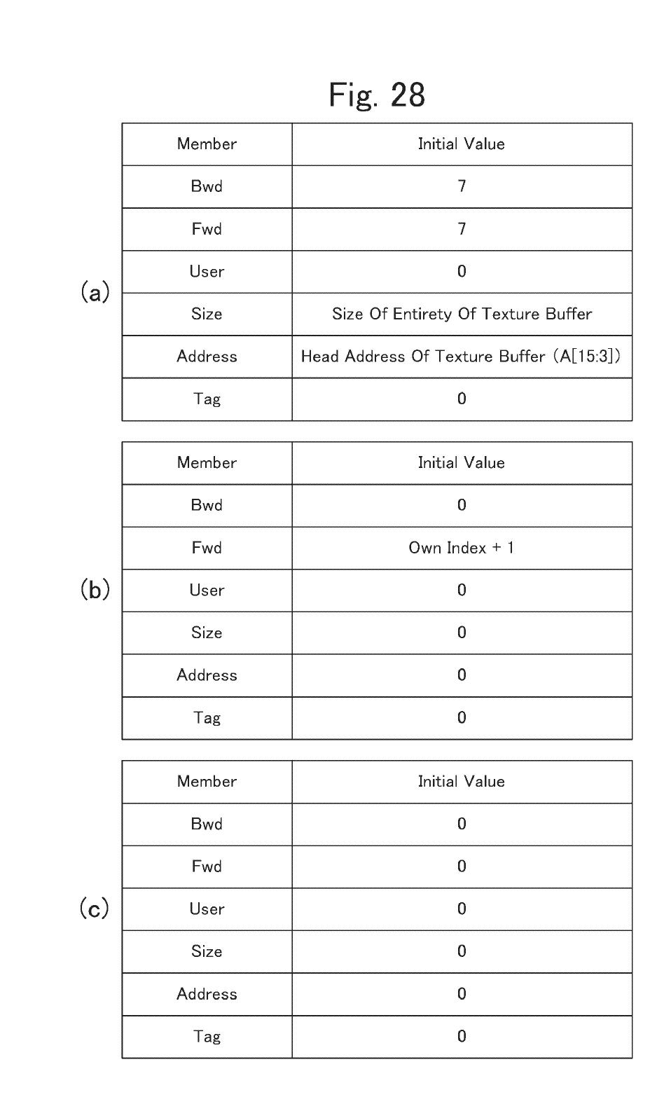

FIG. 27 is an explanatory view for showing the initial values of the boss MCB structure instances [0] to [7]. A numeral in the brackets [ ] is an index of the boss MCB structure instance. FIG. 28 is an explanatory view for showing the initial values of the general MCB structure instances [8] to [127]. Incidentally, a numeral in the brackets [ ] is an index of the general MCB structure instance.

The MCB initializer 141 of FIG. 2 initializes contents of the MCB structure array to the values as shown in FIG. 27 and FIG. 28. The initial values are different for each MCB structure instance.

FIG. 27(a) shows the initial values of the boss MCB structure instances [0] to [6]. There are no texture buffer areas under the management of these boss MCB structure instances in the initial state and the number of other general MCB structure instances forming the each chain is zero. Therefore each of the members “Bwd”, “Fwd” and “Tap” stores the index which designates oneself, and the value of the member “Entry” indicates zero.

FIG. 27(a) shows the initial values of the boss MCB structure instance

[7]. The boss MCB structure instance [7] manages all areas assigned as the texture buffer in the initial state. Actually, it forms the chain together with the general MCB structure instance [8] which manages all the area collectively. Accordingly, the values of the members “Bwd”, “Fwd” and “Tap” all indicate “8” and the value of the member “Entry” indicates “1”.

FIG. 28(a) shows the initial values of the general MCB structure instance [8]. The general MCB structure instance [8] manages all area of the texture buffer in the initial state. Accordingly, the member “Size” indicates a size of the entirety of the texture buffer set to the RPU control register “Texture Buffer Size” and the member “Address” indicates the head address of the texture buffer set to the RPU control register “Texture Buffer Base Add ress”.

In this case, since the size of the texture buffer is set in units of 8 bytes, an actual size of the entirety of the texture buffer is obtained by multiplying the value of the member “Size” by “8”. Also, the value of the member “Address” represents only a total of 13 bits from the third to fifteenth bit (A [15:3]) of the physical address on the main RAM 25.

Since the general MCB structure instance [8] is the only general MCB structure instance which is included in the chain of the boss MCB structure instance [7] in the initial state, both the values of the members “Bwd” and “Fwd” indicate “7”.

Also, in the initial state, since there are no polygons and sprites which share the general MCB structure instance [8], the values of the member “User” and Tag indicate “0”.

FIG. 28(b) shows the initial values of the general MCB structure instances [9] to [126]. The general MCB structure instance [9] and all following general MCB structure instances are set as free general MCB structure instances in the initial state, and therefore are not linked with the chains of the boss MCB structure instances. The free general MCB structure instances in the chain is linked in the manner that the member “Fwd” designates the following general MCB structure instance, and therefore is not a closed ring link like the chain of the boss MCB structure instance. Accordingly, the member “Fwd” of each of the general MCB structure instances [9] to [126] is set to the value which designates “its own index+1”, and the other members “Bwd”, “User”, “Size”, “Address” and “Tag” are all set to “0”.

FIG. 28(c) shows the initial values of the general MCB structure instance [127]. The general MCB structure instance [127] is set as the end of the free general MCB structure instances in the initial state, and therefore is not linked with the chains of the boss MCB structure instances. Accordingly, the member “Fwd” of the general MCB structure instance [127] is set to “0”, and it indicates the end of the chain of the free general MCB structure instances. Also, the other members “Bwd”, “User”, “Size”, “Address” and “Tag” are all set to “0”

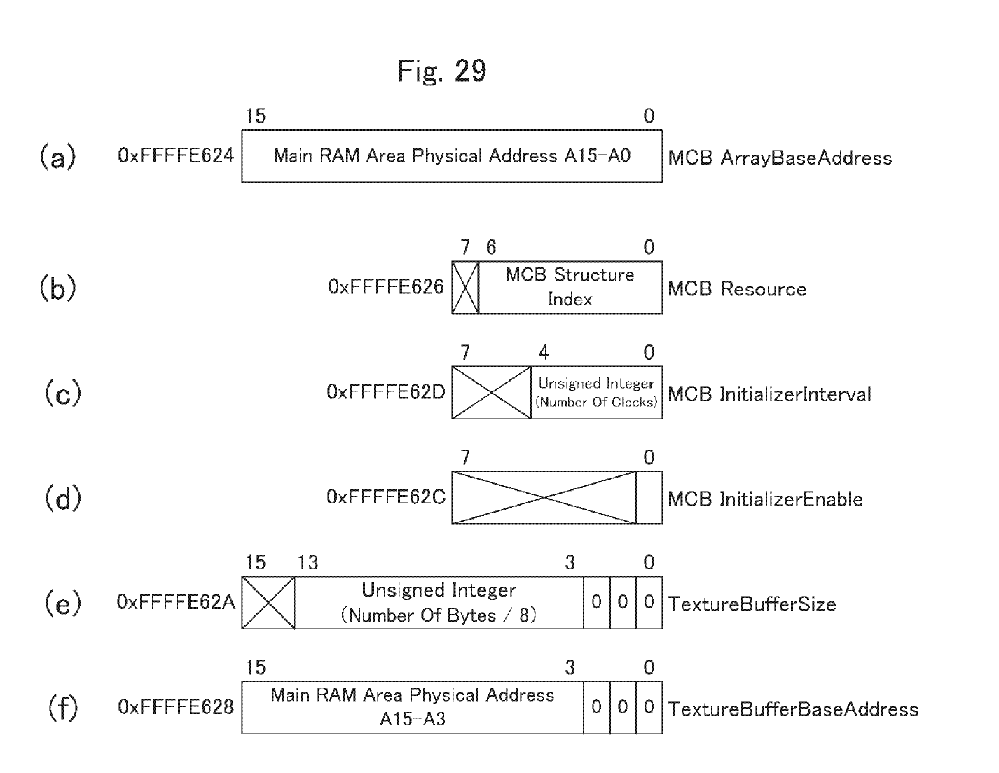

FIG. 29 is a tabulated view for showing the RPU control registers relating to the memory manager 140 of FIG. 2. All the RPU control registers of FIG. 29 are incorporated in the RPU 9.

The RPU control register “MCB Array Base Address” as shown in FIG. 29(a) designates the base address of the MCB structure array used by the memory manager 140 by the physical address on the main RAM 25. While 16 bits in all can be set to this register, the base address of the MCB structure array needs to be set so as to apply the word alignment (the 4-byte alignment) thereto. Incidentally, for example, this register is located in the I/O bus address “0xFFFFE624”.

The RPU control register “MCB Resource” as shown in FIG. 29(b) sets the index which designates the head MCB structure instance of the chain of the free general MCB structure instances at the time of the initial setting. Incidentally, for example, this register is located in the I/O bus address “0xFFFFE626”.

The RPU control register “MCB Initializer Interval” as shown in FIG. 29(c) sets the cycle of the initialization of the MCB structure array to be executed by the MCB initializer 141. This cycle of the initialization is set in units of clock cycles. For example, it is set so as to initialize for each four-clock-cycle. Incidentally, for example, this register is located in the I/O bus address “0xFFFFE62D”.

The RPU control register “MCB Initializer Enable” as shown in FIG. 29(d) controls validity and invalidity of the MCB initializer 141. The MCB initializer 141 is valid if “1” is set to this register and is invalid if “0”. Incidentally, for example, this register is located in the I/O bus address “0xFFFFE62C”.

The RPU control register “Texture Buffer Size” as shown in FIG. 29(e) sets the size of the entirety of the texture buffer. Incidentally, for example, this register is located in the I/O bus address “0xFFFFE62A”.

The RPU control register “Texture Buffer Base Address” as shown in FIG. 29(f) sets the head address of the texture buffer. Incidentally, for example, this register is located in the I/O bus address “0xFFFFE628”.

FIG. 30 and FIG. 31 are a flow chart for showing the sequence for allocating the texture buffer area. Referring to FIG. 30, the memory manager 140 performs the following process using the value of the member “Tsegment” outputted from the merge sorter 106 as an input argument “tag” and the size information of the entirety of the texture pattern data as an input argument “size”.

First, in step S1, the memory manager 140 specifies the boss MCB structure instance corresponding to the input argument “size” (see FIG. 26), and then assigns the index of the boss MCB structure instance as specified to the variable “boss”. In step S2, the memory manager 140 checks whether or not the general MCB structure instance whose value of the member “Tag” is coincident with the input argument “tag” (referred as “detection MCB structure instance” in steps S4 to S6) is present in the chain of the boss MCB structure instance designated by the variable “boss”. Then, the process proceeds to step S4 of FIG. 31 if it is present, conversely the process proceeds to step S7 if it is not present (step S3).

In step S4 of FIG. 31 after determining “Yes” in step S3, the memory manager 140 deletes the detection MCB structure instance from the chain of the boss MCB structure instance as specified in step S1. In step S5, the memory manager 140 inserts the detection MCB structure instance into between the boss MCB structure instance corresponding to the member “Size” of the detection MCB structure instance (see FIG. 26) and the general MCB structure instance currently designated by the member “Fwd” of this boss MCB structure instance. In step S6, the memory manager 140 increases the value of the member “User” of the detection MCB structure instance. In this way, it is successful to allocate the texture buffer area (normal termination). In this case, the memory manager 140 outputs the index, which designates the detection MCB structure instance, as a returned value “mcb” to the texture cache block 126, and outputs a returned value “flag” set to “1”, which indicates that the texture buffer area has already been allocated, to the texture cache block 126.

On the other hand, in step S7 after determining “No” in step S3 of FIG. 30, the memory manager 140 checks whether or not the general MCB structure instance whose value of the member “Size” is more than or equal to the argument “size” and value of the member “User” is equal to “0” (referred as “detection MCB structure instance” in the subsequent steps) is present in the chain of the boss MCB structure instance designated by the variable “boss”. Then, the process proceeds to step S11 if it is present, conversely the process proceeds to step S9 if it is not present (step S8).

In step S9 after determining “No” in step S8, the memory manager 140 increases the variable “boss”. In step S10, the memory manager 140 determines whether or not the variable “boss” is equal to “1”, and then returns to step S7 if “Yes”. On the other hand, since the process has failed to allocate the texture buffer area if “No” (an error termination), the memory manager 140 returns a returned value “mcb” set to the value which indicates that fact to the texture cache block 126.

In step S11 after determining “Yes” in step S8, the memory manager 140 determines whether or not the member “Size” of the detection MCB structure instance is equal to the argument “size”. Then, the process proceeds to step S12 if “No”, conversely the process proceeds to step S18 if “Yes”.

In step S12 after determining “No” in step S11, the memory manager 140 checks the member “Fwd” of the general MCB structure instance designated by the RPU control register “MCB Resource”. The process proceeds to step S17 if the member Fwd=0, conversely the process proceeds to step S14 if the member “Fwd” is a value other than 0 (step S13).

In step S14 after determining “No” in step S13, the memory manager 140 acquires the general MCB structure instance designated by the RPU control register “MCB Resource” (i.e., the free general MCB structure instance), and then sets the RPU control register “MCB Resource” to the value of the member “Fwd” of this free general MCB structure instance. Namely, in step S14, when the detection MCB structure instance whose member “Size” is coincident with the argument “size” is not detected, i.e., the detection MCB structure instance whose value of the member “Size” is larger than the argument “size” is detected, the head general MCB structure instance is acquired from the chain of the free general MCB structure instances.

In step S15, the memory manager 140 adds the argument “size” to the member “Address” of the detection MCB structure instance, and then sets the member “Address” of the free general MCB structure instance to the result, and deducts the argument “size” from the member “Size” of the detection MCB structure instance, and then sets the member “Size” of the free general MCB structure instance to the result. Namely, the process of the step S5 deducts an area with size designated by the argument “size” from an area managed by the detection MCB structure instance to assign the remaining area to the free general MCB structure instances as acquired.

In step S16, the memory manager 140 specifies the boss MCB structure instance corresponding to the member “Size” of the free general MCB structure instance (see FIG. 26), then inserts the free general MCB structure instance into between the boss MCB structure instance as specified and the general MCB structure instance currently designated by the member “Bwd” of this boss MCB structure instance, and further increases the value of the member “Entry” of the boss MCB structure instance as specified. Namely, in step S16, the free general MCB structure instance is newly linked as the backmost general MCB structure instance to the chain of the boss MCB structure instance corresponding to the size of the area assigned in step S15.

In step S17 after step S16 or determining “Yes” in step S13, the memory manager 140 assigns the argument “size” to the member “Size” of the detection MCB structure instance whose member “Size” is larger than the argument “size”. Namely, in step S17, the member “Size” of the detection MCB structure instance is rewritten to the value of the argument “size”.

In step S18 after step S17 or determining “Yes” in step S11, the memory manager 140 decreases the member “Entry” of the boss MCB structure instance of the detection MCB structure instance. In step S19, the memory manager 140 assigns the argument “tag” to the member “Tag” of the detection MCB structure instance. In step S20, the memory manager 140 deletes the detection MCB structure instance from the chain.

In step S21, the memory manager 140 specifies the boss MCB structure instance corresponding to the member “Size” of the detection MCB structure instance (see FIG. 26), and then inserts the detection MCB structure instance into between the boss MCB structure instance as specified and the general MCB structure instance currently designated by the member “Fwd” of this boss MCB structure instance. In step S22, the memory manager 140 increases the value of the member “User” of the detection MCB structure instance.

Namely, in steps S18 to S22, the detection MCB structure instance is deleted from the chain of the boss MCB structure instance to which it is currently linked, and then is newly linked as the foremost general MCB structure instance to the chain of the boss MCB structure instance corresponding to the new member “Size”.

In this way, it is successful to allocate the texture buffer area (normal termination). In this case, the memory manager 140 outputs the index which designates the detection MCB structure instance as a returned value “mcb” to the texture cache block 126, and outputs a returned value “flag” set to “0” which indicates that the texture buffer area has newly been allocated to the texture cache block 126. Also, in this case, the memory manager 140 requests DMA transfer from the DMAC 4 via the DMAC interface 142, and collectively transmits the texture pattern data from the external memory 50 to the texture buffer area as allocated newly. However, it is the case of the polygon, in the case of the sprite, the texture pattern data is sequentially transmitted in accordance with progress of the drawing to the area as allocated.

Incidentally, a supplementary explanation will be made with regard to the step S2. The processing of the step S2 is performed only when the texture buffer area is allocated for use in the polygon, and is not performed for use in the sprite. Accordingly, when the texture buffer area is allocated for use in the sprite, the steps S2 and S3 are skipped and the process proceeds to step S7 certainly.

Because, since the size capable of storing the entire texture pattern data is acquired for use in the polygon, a plurality of polygons can share the one texture buffer area, while, since only the size capable of storing the texture pattern data corresponding to the four horizontal lines is acquired for use in the sprite, a plurality of sprites can not share the one texture buffer area.

The returned value “flag” indicates “1” at the end point (see FIG. 31) of the processing after determining “Yes” in step S3. This fact indicates that it is not necessary to newly request the DMA transfer and read the texture pattern data because the plurality of polygons shares the one texture buffer area (i.e., the texture pattern data has already been read into the texture buffer area).

Next, a supplementary explanation will be made with regard to the steps S7 to S10. The boss MCB structure instances [0] to [7] are classified for each size of texture buffer areas (see FIG. 26), and the boss MCB structure instance manages the texture buffer area with the larger size as the index thereof is larger. Accordingly, the loop to the step S7 through the steps S7 to S10 represents to successively retrieve the chain of the boss MCB structure instance with larger index when the appropriate general MCB structure instance is not present in the chain of the boss MCB structure instance corresponding to the necessary size of the texture buffer area. However, when the appropriate general MCB structure instance is not found although the retrieval reaches the chain of the boss MCB structure instance [7] corresponding to the last boss MCB structure instance, the acquisition of the texture buffer area is failed, and therefore the process is ended as an error. In this case, the inappropriate texture pattern data is mapped to the polygon or the sprite which requests this texture buffer area in the drawing processing.

By the way, if the drawing of the polygon or sprite which uses the texture buffer area as allocated is completed, the memory manager 140 deallocates the texture buffer area as allocated and reuses it so as to store the other texture pattern data. Such processing for deallocating the texture buffer area will be described.

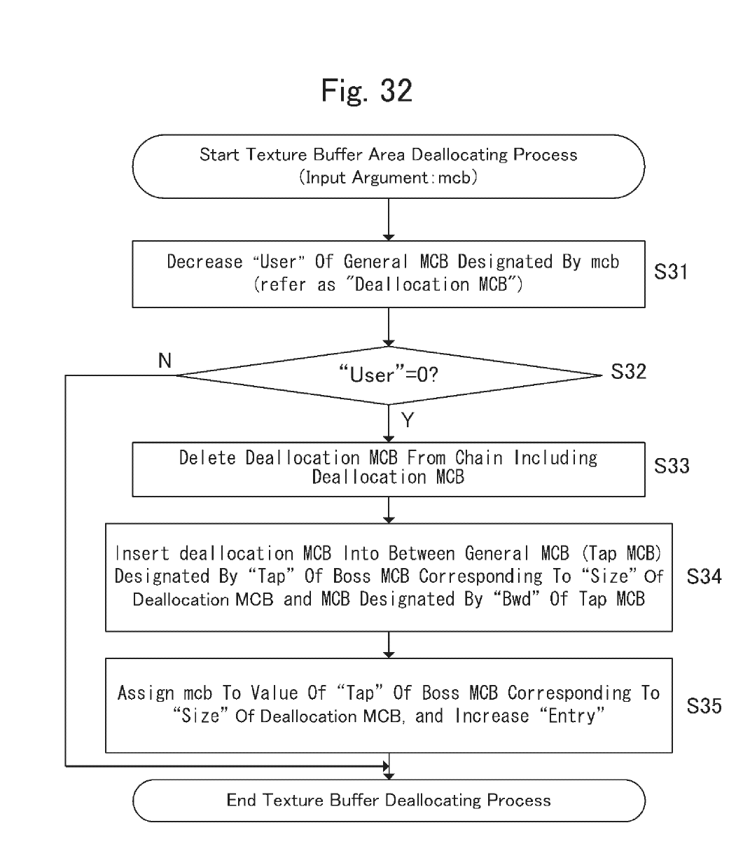

FIG. 32 is a flow chart for showing the processing for deallocating the texture buffer area. The index of the general MCB structure instance which manages the texture buffer area used by the drawing-completion polygon or the drawing-completion sprite is outputted from the texture cache block 126 to the memory manager 140 ahead of the processing for deallocating the texture buffer area. The memory manager 140 performs the processing for deallocating the texture buffer area using this index as the input argument “mcb”.

In step S31, the memory manager 140 decreases the member “User” of the general MCB structure instance designated by the argument “mcb” (referred as “deallocation MCB structure instance” in the subsequent steps). In step S32, the memory manager 140 determines whether or not the value of the member “User” after decreacing is “0”, the process proceeds to step S33 if “Yes”, conversely the processing for deallocating the texture buffer area is ended if “No”.

Namely, in the case where two or more polygons shares the texture buffer, the value of the member “User” of the deallocation MCB structure instance is merely decreased by one, and the deallocation process is actually not performed. The deallocation process is actually performed when the texture buffer area used by one polygon or one sprite (the member “User” before decreacing is equal to “1”) is deallocated.

In step S33 after determining “Yes” in step S32, the memory manager 140 deletes the deallocation MCB structure instance from the chain including the deallocation MCB structure instance. In step S34, the memory manager 140 specifies the boss MCB structure instance corresponding to the member “Size” of the deallocation MCB structure instance (see FIG. 26), and then inserts the deallocation MCB structure instance into between the general MCB structure instance currently designated by the member “Tap” of the boss MCB structure instance as specified (referred as “tap MCB structure instance” in the subsequent steps) and the MCB structure instance designated by the member “Bwd” of the tap MCB structure instance.

In step S35, the memory manager 140 assigns the argument “mcb” to the member “Tap” of the boss MCB structure instance corresponding to the member “Size” of the deallocation MCB structure instance, increases the member “Entry”, and then finishes the processing for deallocating the texture buffer.

FIG. 33 is a view for showing the structure of the chain of the boss MCB structure instance, and a concept in the case that the general MCB structure instance is newly inserted into the chain of the boss MCB structure instance. FIG. 33(a) and FIG. 33(b) illustrate an example of inserting newly the general MCB structure instance #C as the foremost general MCB structure instance into the chain of the boss MCB structure instance BS linked in a closed-ring state like the boss MCB structure instance BS, the general MCB structure instance #A, the general MCB structure instance #B, and the boss MCB structure instance BS. FIG. 33(a) illustrates the state before insertion and FIG. 33(b) illustrates the state after insertion.

In this example, the memory manager 140 rewrites the member “Fwd” of the boss MCB structure instance BS which designates the general MCB structure instance #A so as to designate the general MCB structure instance #C, and rewrites the member “Bwd” of the general MCB structure instance #A which designates the boss MCB structure instance BS so as to designate the general MCB structure instance #C. In addition, the memory manager 140 rewrites the member “Fwd” of the general MCB structure instance #C to be newly inserted into the chain so as to designate the general MCB structure instance #A and rewrites the member “Bwd” so as to designate the boss MCB structure instance BS.

Conversely, in the case where the general MCB structure instance #C is deleted from the chain of the boss MCB structure instance BS as shown in FIG. 33(b), the processing reverse to the processing for inserting is performed.

By the way, as has been discussed above, in the case of the present embodiment, in the case where the texture data is reused, it is possible to prevent useless access to the external memory 50 by temporarily storing the texture data as read out in the texture buffer on the main RAM 25 instead of reading out the texture data from the external memory 50 each time. In addition, efficiency in the use of the texture buffer is improved by dividing the texture buffer on the main RAM 25 into areas with the necessary sizes and performing dynamically allocation and deallocation of the area, and thereby it is possible to suppress an excessive increase of a hardware resource for the texture buffer.

Also, in the present embodiment, it is possible to read out the texture data to be mapped to the sprite from the external memory 50 in units of horizontal lines in accordance with the progress of the drawing processing because the drawing of the graphic element (the polygon and sprite) is sequentially performed in units of the horizontal lines, and thereby it is possible to suppress size of the area to be allocated on the texture buffer. On the other hand, regarding the texture data to be mapped to the polygon, since it is difficult to predict in advance which part of the texture data is required, the area with size capable of storing the entire texture data is allocated on the texture buffer.

Furthermore, in the present embodiment, the process for allocating and deallocating the area is simple by managing each area of the texture buffer using the MCB structure instances.

Furthermore, in the present embodiment, a plurality of the boss MCB structure instances are classified into a plurality of groups in accordance with sizes of areas which they manage, and then the MCB structure instances in the group are annularly linked (see FIG. 26 and FIG. 33). As a result, it is possible to easily retrieve each area of the texture buffer as well as the MCB structure instance.

Furthermore, in the present embodiment, the MCB initializer 141 sets all the MCB structure instances to initial values, and thereby it is possible to prevent the fragmentation of the area of the texture buffer. It is possible to realize means for preventing the fragmentation by a smaller circuit scale than a general garbage collection while shortening processing time. Also, problems concerning the drawing process do not occur at all by initializing the entirety of the texture buffer each time the drawing of one video frame or one field is completed because of the process for drawing the graphic element (the polygon and sprite).

Furthermore, in the present embodiment, the RPU control register “MCB Initializer Interval”, which sets a time interval when the MCB initializer 141 accesses the MCB structure instance to set the MCB structure instance to the initial value, is implemented. The CPU 5 can freely set the time interval when the MCB initializer 141 accesses the MCB structure instance by accessing this RPU control register, and thereby the initializing process can be performed without causing degradation of the entire performance of the system. Incidentally, in the case where the MCB structure array is allocated on the shared main RAM 25, if access from the MCB initializer 141 is continuously performed, latency of the access the main RAM 25 from other function units increases and thereby the entire performance of the system may decrease.

Furthermore, in the present embodiment, it is possible to allocate the texture buffer with an optional size in an optional location on the main RAM 25 which is shared by the RPU 9 and the other function units. In this way, by enabling the optional setting with regard to the both of the size and location of the texture buffer on the shared main RAM 25, in the case where the necessary texture buffer area is small, the other function unit can use a surplus area.

Meanwhile, the present invention is not limited to the embodiments as described above, but can be applied in a variety of aspects without departing from the spirit thereof, and for example the following modifications may be effected.

(1) In accordance with the above description, since the translucent composition process is performed by the color blender 132, the graphic elements (polygons, sprites) are drawn on each line in descending order of the depth values. However, in the case where the translucent composition process is not performed, it is preferred to perform the drawing process in ascending order of the depth values. This is because, even if all the graphic elements to be drawn on one line are completely not drawn before displaying them, for example, for the reason that the drawing capability is insufficient or that there are too many graphic elements to be drawn on one line, the image as displayed looks not so bad when drawing first the graphic element having a smaller depth value and to be displayed in a more front position as compared with the image when drawing first the graphic element having a larger depth value and to be drawn in a deeper position. Also, by drawing first the graphic element having a smaller depth value, it is possible to increase the processing speed because the graphic element to be drawn in a deeper position need not be drawn in an area where it overlaps the graphic element having already been drawn.

(2) In accordance with the above description, the line buffers LB1 and LB2 capable of storing data corresponding to one line of the screen are provided in the RPU 9 for the drawing process. However, two pixel buffers each of which is capable of storing data corresponding to the number of pixels short of one line can be provided in the RPU 9. Alternatively, it is also possible to provide two buffers each of which is capable of storing data of “K” lines (“K” is two or a larger integer) in the RPU 9.

(3) While a double buffering configuration is employed in the RPU 9 in accordance with the above description, it is possible to employ a single buffering configuration or a multiple buffering configuration making use of three or more buffers.

(4) While the YSU 19 outputs the pulse PPL each time a polygon structure instance is fixed as a sort result in accordance with the above description, it is possible to output the pulse PPL each time a predetermined number of polygon structure instances are fixed as sort results. This is true for the pulse SPL.

(5) While an indirect designation method making use of a color palette is employed for the designation of the display color in accordance with the above description, a direct designation method can be employed.

(6) While the slicer 118 determines whether the input data is for the drawing of the polygon or for the drawing of the sprite by the flag field of the polygon/sprite shared data Cl in accordance with the above description, this determination can be performed by the specified bit (the seventy ninth bit) of the structure instance inputted simultaneously with the polygon/sprite shared data Cl.

(7) While the polygon is triangular in accordance with the above description, the shape thereof is not limited to it. Also, while the sprite is quadrangular, the shape thereof is not limited to it. Furthermore, while the shape of the texture is triangular or quadrangular, the shape of the texture is not limited to it.

(8) While the texture is divided into two pieces and stored in accordance with the above description, the number of divisions is not limited to it. Also, while the texture to be mapped to the polygon is a right triangle, the shape of the texture is not limited to it and can take any shape.

(9) The function for allocating the texture buffer area by the memory manager 140 is implemented by hard wired logic in accordance with the above description. However, it can be implemented also by software process of the CPU 5. In this case, it is advantageous that the above logic is unnecessary and flexibility is given to process. Further, however, it is disadvantageous that execution time slows down and restriction of the programming increases since CPU 5 must respond fast. These disadvantages do not occur in the case of the hard wired logic.

While the present invention has been described in terms of embodiments, it is apparent to those skilled in the art that the invention is not limited to the embodiments as described in the present specification. The present invention can be practiced with modification and alteration within the spirit and scope which are defined by the appended claims.

1. An image generating device operable to generate an image, which is constituted by a plurality of graphics elements, to be displayed on a screen, wherein:
the plurality of the graphic elements is constituted by any combination of polygonal graphics elements to represent a shape of each surface of a three-dimensional solid projected to a two-dimensional space and rectangular graphics elements each of which is parallel to a frame of the screen,
said image generating device comprising:
A first data converting unit operable to convert first display information for generating the polygonal graphics element into data of a predetermined format;
A second data converting unit operable to convert second display information for generating the rectangular graphics element into data of said predetermined format; and
An image generating unit operable to generate the image to be displayed on the screen on the basis of the data of said predetermined format received from said first data converting unit and said second data converting unit.

2. An image generating device as claimed in claim 1 wherein a first two-dimensional orthogonal coordinate system is a two-dimensional coordinate system which is used for displaying the graphics element on the screen,
wherein a second two-dimensional orthogonal coordinate system is a two-dimensional coordinate system where image data to be mapped to the graphics element is arranged,
wherein the data of said predetermined format includes a plurality of vertex fields,
wherein the each vertex field includes a first field and a second field,
wherein said first data converting unit stores coordinates in the first two-dimensional orthogonal coordinate system of a vertex of the polygonal graphics element in the first field and stores a parameter of the vertex of the polygonal graphics element in a format according to a drawing mode in the second field, and
wherein said second data converting unit stores coordinates in the first two-dimensional orthogonal coordinate system of a vertex of the rectangular graphics element in the first field and stores coordinates obtained by mapping the coordinates in the first two-dimensional orthogonal coordinate system of the vertex of the rectangular graphics element to the second two-dimensional orthogonal coordinate system in the second field.

3. An image generating device as claimed in claim 2 wherein said second data converting unit performs calculation based on coordinates in the first two-dimensional orthogonal coordinate system of one vertex of the rectangular graphics element and size information of the graphics element, which are included in the second display information, to obtain coordinates in the first two-dimensional orthogonal coordinate system of a part or all of the other three vertices, and stores the coordinates of the vertex included in the second display information in advance and the coordinates of the vertex as obtained in the first field, and maps the coordinates of the vertex included in the second display information in advance and the coordinates of the vertex as obtained to the second two-dimensional orthogonal coordinate system to obtain coordinates, and stores the coordinates in the second two-dimensional orthogonal coordinate system as obtained in the second field.

4. An image generating device as claimed in claim 2 wherein said second data converting unit performs calculation based on coordinates in the first two-dimensional orthogonal coordinate system of one vertex of the rectangular graphics element, an enlargement/reduction ratio of the graphics element, and size information of the graphics element, which are included in the second display information, to obtain coordinates of a part or all of the other three vertices, and stores the coordinates of the vertex included in the second display information in advance and the coordinates of the vertex as obtained in the first field, and maps the coordinates of the vertex included in the second display information in advance and the coordinates of the vertex as obtained to the second two-dimensional orthogonal coordinate system to obtain coordinates, and stores the coordinates in the second two-dimensional orthogonal coordinate system as obtained in the second field.

5. An image generating device as claimed in claim 2 wherein said first data converting unit acquires coordinates in the first two-dimensional orthogonal coordinate system of a vertex of the polygonal graphics element, which are included in the first display information, to store them in the first field,
wherein in a case where the drawing mode indicates drawing by texture mapping, said first data converting unit acquires information for calculating coordinates in the second two-dimensional orthogonal coordinate system of a vertex of the polygonal graphics element and a perspective correction parameter, which are included in the first display information, to calculate the coordinates of the vertex in the second two-dimensional orthogonal coordinate system, performs perspective correction, and stores coordinates of the vertex after the perspective correction and the perspective correction parameter in the second field, and
wherein in a case where the drawing mode indicates drawing by gouraud shading, said first data converting unit acquires color data of a vertex of the polygonal graphics element, which is included in the first display information, and stores the color data as acquired in the second field.

6. An image generating device as claimed in claim 2 wherein the data of said predetermined format further includes a flag field which indicates whether said data is for use in the polygonal graphics element or for use in the rectangular graphics element,
wherein said first data converting unit stores information which indicates that said data is for use in the polygonal graphics element in the flag field, and
wherein said second data converting unit stores information which indicates that said data is for use in the rectangular graphics element in the flag field.

7. An image generating device as claimed in claim 2 wherein said image generating unit performs drawing processing in units of lines constituting the screen in predetermined line order,
wherein said first data converting unit transposes contents of the vertex fields in such a manner that order of coordinates of vertices included in the first fields is coincident with order of appearance of the vertices according to the predetermined line order, and
wherein said second data converting unit stores data in the respective vertex fields in such a manner that order of coordinates of vertices of the rectangular graphics element is coincident with order of appearance of the vertices according to the predetermined line order.

8. An image generating device as claimed in claim 2 wherein said image generating unit comprising:
an intersection calculating unit operable to receive the data of said predetermined format,
wherein said intersection calculating unit calculates coordinates of two intersections of a line to be drawn on the screen and sides of the graphics element on the basis of the coordinates of the vertices stored in the first fields, and obtains a difference between the coordinates of the two intersections as first data, calculates parameters of the two intersections on the basis of the parameters of the vertices stored in the second fields, and obtains a difference between the parameters of the two intersections as second data, and divides the second data by the first data to obtain a variation quantity of the parameter per unit coordinate in the first two-dimensional coordinate system.

9. An image generating device as claimed in claim 6 wherein said image generating unit comprising:
an intersection calculating unit operable to calculate coordinates of two intersections of a line to be drawn on the screen and sides of the graphics element on the basis of the coordinates of the vertices stored in the first fields, and calculates a difference between the coordinates of the two intersections as first data,
wherein in a case where the flag field included in the data of said predetermined format as received designates the polygonal graphics element, said intersection calculating unit calculates parameters of the two intersections on the basis of the parameters of the vertices stored in the second fields in accordance with the drawing mode, and calculates a difference between the parameters of the two intersections as second data,
wherein in a case where the flag field included in the data of said predetermined format as received designates the rectangular graphics element, said intersection calculating unit calculates coordinates in the second two-dimensional orthogonal coordinate system of the two intersections, as parameters of the two intersections, on the basis of the coordinates of the vertices in the second two-dimensional orthogonal coordinate system included in the second fields, and calculates a difference between the coordinates in the second two-dimensional orthogonal coordinate system of the two intersections, and
said intersection calculating unit divides the second data by the first data to obtain a variation quantity of the parameter per unit coordinate in the first two-dimensional coordinate system.

10. An image generating device as claimed in claim 9 wherein in a case where the flag field included in the data of said predetermined format as received designates the polygonal graphics element and furthermore the drawing mode designates drawing by texture mapping, said intersection calculating unit calculates coordinates after perspective correction and perspective correction parameters of the two intersections on the basis of coordinates of the vertices after the perspective correction and perspective correction parameters stored in the second fields, and calculates respective differences as the second data, and
in a case where the flag field included in the data of said predetermined format as received designates the polygonal graphics element and furthermore the drawing mode designates drawing by gouraud shading, said intersection calculating unit calculates color data of the two intersections on the basis of color data stored in the second fields, and calculates a difference between the color data of the two intersections as the second data.

11. An image generating device as claimed in claim 8 wherein said image generating unit further comprising:
an adder unit operable to sequentially add the variation quantity of the parameter per unit coordinate in the first two-dimensional coordinate system, which is calculated by said intersection calculating unit, to the parameter of any one of the two intersections to obtain parameters of respective coordinates between the two intersections in the first two-dimensional coordinate system.

12. An image generating device as claimed in claim 10 wherein said image generating unit further comprising:
an adder unit operable to sequentially add the variation quantity of the coordinate in the second two-dimensional coordinate system per unit coordinate in the first two-dimensional coordinate system, which is calculated by said intersection calculating unit with regard to the rectangular graphics element, to the coordinate of any one of the two intersections in the second two-dimensional coordinate system to obtain coordinates in the second two-dimensional coordinate system for respective coordinates between the two intersections in the first two-dimensional coordinate system,
wherein with regard to the polygonal graphics element in a case where the drawing mode designates drawing by texture mapping, said adder unit adds sequentially the variation quantity of the coordinate in the second two-dimensional coordinate system after the perspective correction and the variation quantity of the perspective correction parameter per unit coordinate in the first two-dimensional coordinate system to the coordinate in the second two-dimensional coordinate system after the perspective correction and the perspective correction parameter of any one of the two intersections respectively, and obtains coordinates after the perspective correction and perspective correction parameters between the two intersections, and
wherein with regard to the polygonal graphics element in a case where the drawing mode designates drawing by gouraud shading, said adder unit adds sequentially the variation quantity of the color data per unit coordinate in the first two-dimensional coordinate system, which is calculated by said intersection calculating unit, to the color data of any one of the two intersections, and obtains color data of respective coordinates between the two intersections in the first two-dimensional coordinate system.

13. An image generating device as claimed in claim 1, further comprising:
a merge sorting unit operable to determine priority levels for drawing the polygonal graphics elements and the rectangular graphics elements in drawing processing in accordance with a predetermined rule,
wherein the first display information is previously stored in a first array in the descending order of the priority levels for drawing,
wherein the second display information is previously stored in a second array in the descending order of the priority level for drawing,
wherein said merge sorting unit compares the priority levels for drawing between the first display information and the second display information,
wherein in a case where the priority level for drawing of the first display information is higher than the priority level for drawing of the second display information, said merge sorting unit reads out the first display information from the first array,
wherein in a case where the priority level for drawing of the second display information is higher than the priority level for drawing of the first display information, said merge sorting unit reads out the second display information from the second array, and
wherein said merge sorting unit outputs the first display information as a single data string when the first display information is read out, and outputs the second display information as said single data string when the second display information is read out.

14. An image generating device as claimed in claim 13 wherein in a case where drawing processing is performed in accordance with predetermined line order and an appearance vertex coordinate stands for a coordinate of a vertex which appears earliest in the predetermined line order among coordinates in the first two-dimensional coordinate system of a plurality of vertices of the graphics element in a drawing process according to the predetermined line order, the predetermined rule is defined in such a manner that the priority level for drawing of the graphics element whose the appearance vertex coordinate appears earlier in the predetermined line order is higher.

15. An image generating device as claimed in claim 14 wherein said merge sorting unit compares display depth information included in the first display information and display depth information included in the second display information when the appearance vertex coordinates are same as each other, and determines that the graphics element to be drawn in a deeper position has the higher priority level for drawing.

16. An image generating device as claimed in claim 15 wherein said merge sorting unit determines the priority level for drawing after replacing the appearance vertex coordinate by a coordinate corresponding to a line to be drawn first when said appearance vertex coordinate is located before the line to be drawn first.

17. An image generating device as claimed in claim 16 wherein in a case of an interlaced display, when the appearance vertex coordinate corresponds to a line not to be drawn in a field to be displayed of an odd field an even field, said merge sorting unit replaces said appearance vertex coordinate by a coordinate corresponding to a line next to said line and deals with it.

18-47. (canceled)
